(19) United States
(12) Patent Application Publication
(10) Pub. No.: US 2017/0141845 A1
(43) Pub. Date: May 18, 2017

(54) INGRESS MITIGATION METHODS AND APPARATUS, AND ASSOCIATED INGRESS-MITIGATED CABLE COMMUNICATION SYSTEMS, HAVING COLLOCATED SUBSCRIBER SERVICE DROP CABLES AND/OR OTHER COLLOCATED SUBSCRIBER SERVICE EQUIPMENT

(71) Applicant: CertusView Technologies, LLC, Palm Beach Gardens, FL (US)

(72) Inventors: Ronald Totten, Strafford, NH (US); Lamar West, Maysville, GA (US)

(21) Appl. No.: 15/416,441

(22) Filed: Jan. 26, 2017

Related U.S. Application Data
(63) Continuation of application No. PCT/US2015/042514, filed on Jul. 28, 2015.
(60) Provisional application No. 62/029,685, filed on Jul. 28, 2014.

(51) Int. Cl. H04B 10/077; H04B 10/27; H04B 10/2575

(52) U.S. Cl. CPC H04B 10/0773; H04B 10/25751; H04B 10/0771; H04B 10/27

(57) ABSTRACT

Ingress detection and mitigation in the context higher-density subscriber environments (e.g., urban environments) that generally involve multi-occupant structures and collocation, to some degree, of various cable system components, and particularly subscriber-related system components (e.g., collocated subscriber service drop cables and/or other collocated subscriber service equipment). In one example, suspect taps coupled to multiple collocated subscriber service drop cables associated with a multi-occupant structure are analyzed according to particular measurement protocols to reliably and accurately facilitate identification and remediation of subscriber-related faults giving rise to ingress.

### CROSS REFERENCE TO RELATED APPLICATIONS

This application is a bypass continuation application of International Application No. PCT/US2015/042514, filed on Jul. 28, 2015 and entitled “Ingress Mitigation Methods and Apparatus, and Associated Ingress-Mitigated Cable Communication Systems, Having Collocated Subscriber Service Drop Cables and/or Other Collocated Subscriber Service Equipment,” which in turn claims a priority benefit to U.S. Provisional Patent Application Ser. No. 62/029,685, filed on Jul. 28, 2014, entitled “Ingress Mitigation Methods and Apparatus, and Associated Ingress-Mitigated Cable Communication Systems, Having Collocated Subscriber Service Drop Cables and/or Other Collocated Subscriber Service Equipment.” The entire contents of the aforementioned applications are herein expressly incorporated by reference in its entirety.

### BACKGROUND

Cable communication systems provide one or more of commercial TV services, Internet data services, and voice services (e.g., “Voice-over-Internet Protocol,” or VoIP) to one or more subscriber premises (or “end users”) in a given geographic area. Generally speaking, a cable communication system refers to the operational (e.g., geographical) footprint of an entertainment and/or information services franchise that provides entertainment and/or information services to a subscriber base spanning one or more towns, a metropolitan area, or a portion thereof. Particular entertainment and/or information services offered by the franchise (e.g., entertainment channel lineup, data packages, etc.) may differ from system to system. Some large cable companies operate several cable communication systems (e.g., in some cases up to hundreds of systems), and are known generally as Multiple System Operators (MSOs).

Cable Communication System Overview

FIG. 1 generally illustrates various elements of a conventional hybrid fiber-coaxial (HFC) cable communication system 160. The cable communication system 160 includes a headend 162 coupled to one or more nodes 164A, 164B, and 164C via one or more physical communication media. The physical communication media typically include fiber optic cable and coaxial cable to convey information (e.g., television programming, Internet data, voice services) between the headend 162 and subscriber premises served by the nodes 164A, 164B and 164C of the cable communication system 160.

In FIG. 1, a first node 164A is illustrated with some detail to show multiple subscriber premises 190 as well as additional elements that similarly may be found in the other nodes 164B and 164C. In general, the headend 162 transmits information to and receives information from a given node via physical communication media (i.e., fiber optic cable and coaxial cable) dedicated to serving the geographic area covered by the node. Although the physical communication media of a given node may pass proximate to several premises, not all premises passed are necessarily subscriber premises 190 (i.e., actual subscribers to the services provided by the cable communication system 160); in some conventional cable communication systems, subscriber premises 190 of a given node may constitute on the order of 50% of the total number of premises passed by the physical communication media serving the node.

Although FIG. 1 illustrates only three subscriber premises 190 in the first node 164A, it should be appreciated that the geographic area covered by a representative node of a conventional cable communication system typically includes anywhere from approximately 100 premises to as many as 1000 premises (not all of which may be subscriber premises 190). Also, while FIG. 1 shows only three nodes 164A, 164B and 164C coupled to the headend 162, it should be appreciated that cable communication systems similar to the system 160 shown in FIG. 1 may include different numbers of nodes (e.g., for some larger cable communication systems, the headend may serve several hundreds of nodes).

Nodes

The first node 164A shown in FIG. 1 is depicted generally as either a “Fiber to the Neighborhood” (FTTN) node (also sometimes referred to as a “Fiber to the Feeder” or FTTF node), or a “Fiber to the Curb” (FTTC) node. In an FTTN/FTTF or FTTC node, fiber optic cable is employed as the physical communication medium to communicate information between the headend 162 and the general geographic area of subscriber premises. Within the area occupied by the subscriber premises, coaxial cable is employed as the physical communication medium between the fiber optic cable and respective subscriber premises 190. A general difference between FTTN/FTTF and FTTC nodes relates to how close the fiber optic cable comes to the premises in the node, and how many premises are passed by the coaxial cable portion of the node; for example, in an FTTC node, the fiber optic cable generally comes closer to the premises in the node than in an FTTN/FTTF node, and the coaxial cable portion of the FTTC node typically passes fewer than 150 premises (whereas the coaxial cable portion of an FTTN/FTTF node passes as many as from 200 to 1000 premises). Unlike cable communication systems employing FTTN/FTTF and FTTC nodes, “Fiber to the Home” (FTTH) systems (also known as “Fiber to the Premises” or FTTP systems) have a primarily fiber optic cable infrastructure (a “passive optical network” or PON) that runs directly and respectively to some smaller number of subscriber premises (e.g., approximately 30 or fewer premises passed).

As shown in FIG. 1, the first node 164A has an infrastructure (also referred to generally herein as a “cable plant”) that includes a first fiber optic cable 163A, a first optical/radio frequency (RF) converter 167, a first RF hardline coaxial cable plant 180, a plurality of first subscriber service drop cables 163C (also known as subscriber service drops), and a plurality of first subscriber premises 190.

More specifically, the first node 164A includes a first fiber optic cable 163A, coupled to the headend 162 of the cable communication system 160 and to a first optical/radio frequency (RF) converter 167 (also sometimes referred to as a “bridge converter”) within the first node 164A. As noted above, depending on the configuration of the node as an FTTN/FTTF node or an FTTC node, the first optical/RF bridge converter 167 may be physically disposed at various geographic locations covered by the first node 164A. The bridge converter 167 generally serves to convert optical signals transmitted by the headend 162 to radio frequency (RF) signals that are received by subscriber premises 190 in the first node; the bridge converter 167 also converts RF signals transmitted by the subscriber premises 190 to optical signals that are received at the headend 162.

The first node 164A also includes a first RF hardline coaxial cable plant 180 (also referred to herein simply as a “hardline cable plant”) coupled to the bridge converter 167. The first hardline cable plant 180 constitutes another portion of the physical communication media over which information is carried, in the form of RF signals (e.g., modulated RF carrier waves), between the optical/RF bridge converter 167 and the subscriber premises 190 of the first node. Additional details of the first hardline cable plant 180 are discussed below in connection with FIG. 2.

As shown in FIG. 1, the first node 164A further includes multiple first subscriber service drop cables 163C, coupled to the first hardline cable plant 180 and respectively associated with subscriber premises 190. Each of the subscriber premises 190 includes one or more end-user modems 165 (also referred to herein as “subscriber modems” or “media terminal adapters”) to demodulate RF signals carrying data and/or voice information and received from the first hardline plant 180 via the premises' corresponding subscriber service drop cable 163C (a different device, commonly known as a “set-top box,” is typically employed at a subscriber premises to demodulate RF signals carrying video information). The subscriber modem(s) 165 also modulate an RF carrier with information (e.g., data and/or voice information) to be transmitted from the subscriber premises 190 to the first hardline cable plant 180. Thus, the first subscriber service drop cables 163C communicatively couple the subscriber modem(s) 165 of the respective subscriber premises 190 to the first hardline cable plant 180.

In the cable communication system 160 of FIG. 1, the first hardline cable plant 180 (as well as the first subscriber service drop cables 163C) carries RF signals that convey downstream information 183 from the headend 162 (as received via the fiber optic cable 163A and the bridge converter 167) to the subscriber premises 190 of the first node 164A. The first hardline cable plant 180 also carries RF signals that convey upstream information 184 from at least some of the subscriber premises 190 of the first node 164A to the bridge converter 167 (which upstream information ultimately is transmitted to the headend 162 via the fiber optic cable 163A). To this end, the RF communication bandwidth supported by the first hardline cable plant 180 typically is divided into a downstream path band 181 in which the downstream information 183 is conveyed, and an upstream path bandwidth 182 in which the upstream information 184 is conveyed. In most conventional cable communication systems in the United States, the upstream path bandwidth 182 includes a first frequency range of from 5 MHz to 42 MHz (in other geographies, the upstream path bandwidth may extend to a higher frequency; for example, in Europe the upstream path bandwidth includes frequencies from 5 MHz to 65 MHz). The downstream path band 181 includes a second frequency range of from 50 MHz to 750 MHz (and in some instances as high as approximately 1 GHz). The downstream information 183 is conveyed by one or more downstream RF signals having a carrier frequency falling within the downstream path band 181, and the upstream information 184 is conveyed by one or more upstream RF signals having a carrier frequency falling within the upstream path bandwidth 182.

As noted above, the nodes 164B and 164C typically cover different geographic areas within the overall operating footprint of the cable communication system 160, but may be configured similarly to the first node 164A with respect to the various infrastructure constituting the node (e.g., each of the nodes 164B and 164C may include a dedicated fiber optic cable, optical/RF bridge converter, hardline plant, subscriber premises, and subscriber service drop cables to subscriber premises).

As also noted above, the overall infrastructure of a given node is referred to generally herein as a “cable plant,” with respective constituent elements of the cable plant including the first fiber optic cable 163A, the first optical/radio frequency (RF) converter 167, the first RF hardline coaxial cable plant 180, the plurality of first subscriber service drop cables 163C, and the plurality of first subscriber premises 190, as illustrated in FIG. 1. These respective elements have corresponding roles and functions within the cable plant (and the cable communication system as a whole); accordingly, it should be appreciated that while “cable plant” may refer to any one or more node infrastructure elements in combination, specific elements of the cable plant are referred to with particularity when describing their corresponding roles and functions in the context of the inventive concepts discussed in subsequent sections of this disclosure. For example, “RF hardline coaxial cable plant” (or “hardline cable plant”) refers specifically to the element 180 as introduced above in connection with FIG. 1, described further below in connection with FIG. 2, and similarly implemented according to various embodiments of inventive concepts discussed in subsequent sections of this disclosure.

In particular, FIG. 2 illustrates additional details of the first hardline cable plant 180 of the first node 164A. FIG. 2 also shows the first optical/RF converter 167 of the first node (to which the first hardline cable plant 180 is coupled), as well as one subscriber premises 190 of the first node (coupled to the first hardline cable plant 180 via a subscriber service drop cable 163C). Although only one subscriber premises 190 is shown in FIG. 2 for purposes of illustration, it should be appreciated that multiple subscriber premises may be coupled to the hardline cable plant 180 (e.g., as shown in FIG. 1). In FIG. 2, the first hardline cable plant 180 is indicated generally with dashed lines so as to distinguish various elements of the hardline cable plant 180 from the optical/RF converter 167 and other elements of the cable communication system generally associated with one or more subscriber premises 190. As noted above, hardline cable plants employed in other nodes of the communication system 160 shown in FIG. 1 generally may include one or more of the various elements shown in FIG. 2 as constituting the first hardline cable plant 180, and may be similarly configured to the first hardline cable plant 180.

As conventional cable communication systems have evolved over the years, so has some nomenclature for various elements of the system and, particularly, the hardline cable plant. Turning again to FIG. 2, a first segment of the hardline coaxial cable 163B in the hardline cable plant 180, between the optical/RF bridge converter 167 and a first amplifier 187 (e.g., in which power supply 186 is connected via connector 193), is sometimes referred to as an “express feeder” (historically, an express feeder was sometimes considered/referred to as part of the “trunk”). An express feeder may run for various distances and generally does not include any distribution taps 188. Conversely, a section of the hardline cable plant including one or more segments of hardline coaxial cable 163B and one or more distribution taps 188 sometimes is referred to merely as a “feeder” (as opposed to an “express feeder”). It should be appreciated that the terminology “trunk,” “express feeder,” and “feeder” are merely referred to above as examples of nomenclature used in the industry for various portions of the cable communication system and hardline cable plant. In exemplary implementations, various elements of the hardline cable plant 180 often are disposed above the ground, e.g., mounted on and/or hung between utility poles, and in some cases elements of the hardline cable plant also or alternatively may be buried underground.

As shown in FIG. 2, the first hardline cable plant 180 includes one or more segments of hardline coaxial cable 163B (one of which segments is coupled to the optical/RF converter 167). The hardline cable plant 180 also may include one or more components generally categorized as an “active” component, a “passive” component, a power supply, a connector, or various hardware (e.g., clamps, hangers, anchors, lashing wire, etc.) employed to secure various components to each other or other supporting infrastructure (e.g., utility poles, underground conduit, etc.). More specifically, with reference to FIG. 2, the hardline cable plant may include: one or more amplifiers 187 (also sometimes referred to as “line extenders”) constituting an active component and requiring power from one or more power supplies 186; one or more passive components, examples of which include distribution taps 188 (also referred to simply as “taps”), directional couplers 189 (also referred to as “splitters” or “combiners”), line terminators 191, and filters/attenuators (not shown explicitly in FIG. 2, although a filter/attenuator may be a constituent component of a tap, splitter/combiner, or a line terminator); one or more connectors or “fittings” 193 for coupling segments of the hardline coaxial cable 163B to various other elements of the hardline cable plant 180 (e.g., pin-type connectors, such as housing terminators, extension fittings, 90-degree fittings, splice connectors, etc., or one or more “splice blocks” 195 that may be employed to interconnect two segments of hardline coaxial cable 163B). FIGS. 3A through 3G illustrates examples of these various elements, which are discussed in greater detail in turn below.

With respect to the hardline coaxial cable 163B used in the hardline cable plant 180, as shown in FIG. 3A the coaxial cable commonly employed in the hardline plant often includes a center solid conductor surrounded by an electrically insulating material and a solid conductor shield to provide for improved electrical characteristics (e.g., lower RF signal loss/leakage) and/or some degree of environmental robustness. Some types of coaxial cables used for the hardline plant 180 include low density foam (LDF) insulation, which has insulating qualities similar to dry air, making it particularly well-suited for outdoor use. The solid conductor shield generally makes the cable somewhat more difficult to bend (hence the terminology “hardline” coaxial cable). In various implementations, 0.75 inch hardline coaxial cable may be employed for “express feeders,” whereas 0.625 inch hardline coaxial cable may be employed for “feeders.” One example of hardline coaxial cable 163B conventionally employed in the hardline plant 180 is given by Commscope PIII 0.625 cable (e.g., see http://www.commscope.com/broadband/eng/product/cable/coaxial/1175378_7804.html). However, it should be appreciated that a variety of hardline coaxial cables may be employed in different hardline plants and/or different portions of the same hardline plant. Additionally, hardline tri-axial cable also is available that includes an additional shield layer to discourage electromagnetic interference, and may in some instances be employed in a hardline plant (for purposes of the present disclosure, any reference to “hardline coaxial cable” should be understood to include hardline tri-axial cable as well). Note that in some instances the coaxial cable 163B used in the feeder or express feeder may include a flexible coaxial cable such as an RG11 cable. Flexible coaxial cable may be used in areas where the cable is passed through restrictive physical environments (e.g., environments with tight bends or small conduits) and where the relatively higher loss of flexible coaxial cable may be tolerated.

As also shown in FIG. 2, the subscriber service drop cable 163C (also known as a “subscriber service drop,” or simply as a “drop”) generally refers to the coaxial cable (and associated termination hardware) between a distribution tap 188 and a subscriber premises 190, wherein the drop provides cable services corresponding to a single subscription. In general, a subscriber service drop 163C includes a length of coaxial cable and two male F-connectors that respectively terminate the coaxial cable; one of the male F-connectors typically is coupled to a female F-connector of a distribution tap 188, and the other of the male F-connectors typically is coupled to a female F-connector of a ground block 198 (in some instances, the coaxial cable portion of the drop may include one or more splices, e.g., an F-barrel and two additional male F-connector terminations, each coupled to a different end of the F-barrel). A subscriber service drop 163C often is constituted by a coaxial cable segment of a different type than the hardline coaxial cable 163B employed in the hardline plant 180 (as generally shorter cable lengths, greater physical flexibility, and less environmental robustness are required for subscriber service drop cables 163C than for the hardline cable plant 180; also whereas hardline coaxial cable is intended to be an essentially permanent component over the life of a cable communication system, subscriber service drop cables are considered as less permanent and may be installed and removed based on service changes relating to new subscribers or cancellation of services by existing subscribers). Some examples of coaxial cable conventionally employed for subscriber service drops 163C are given by RG-6 and RG-59 cables (e.g., see http://www.tonercable.com/assets/images/ProductFiles/1830/PDFFile/TFC %20T10%2059%20Series%20Drop%20Cable.pdf). In other examples, a subscriber service drop 163C may be constituted by a “flooded” cable or a “messenger” (aerial) cable; “flooded” cables may be infused with heavy waterproofing for use in an underground conduit or directly buried in the ground, whereas “messenger” cables may contain some waterproofing as well as a steel messenger wire along the length of the cable (to carry tension involved in an aerial drop from a utility pole). At the subscriber premises 190, the service drop 163C typically is fastened in some manner to the subscriber premises 190 and coupled to a ground block 198, and in turn connects to various components inside the subscriber premises, such as interior cables 192 (each of which typically terminates with connectors 196), one or more splitters/combiners 194, and one or more end user modems 165 (sometimes collectively referred to as “subscriber premises equipment” or “customer premises equipment”).

Referring again to the hardline cable plant 180, as noted above the hardline plant may include one or more power supplies 186 and one or more amplifiers 187 or “line extenders” (also shown in FIG. 3F). An exemplary power supply 186 converts commercially available power (e.g., 120 Volts A.C. rms, 60 Hz) to voltage amplitudes (e.g., 60 VAC, 90 VAC) that may be distributed (e.g., in some cases along with RF signals via the hardline coaxial cable 163B) for providing power to one or more amplifiers 187 or other active components of the hardline cable plant. One or more amplifiers 187 may be employed to boost attenuated RF signals for further propagation or distribution along the hardline cable plant 180 (in one or both of the upstream path bandwidth or the downstream path band). Some types of amplifiers 187 may be bi-directional and provide separate amplification pathways for downstream and upstream RF signals, respectively. It should be appreciated that for purposes of the present discussion, the term “amplifier” is used generally to refer to a device that may amplify a signal; in some examples, an amplifier also may implement a filtering function as well (e.g., selective attenuation/amplification at one or more particular frequencies or over one or more frequency bands) for one or more RF signals propagating along the hardline cable plant 180. In particular, hardline cable plant amplifiers 187 typically include “diplex filters” that allow passage of signals through the amplifier only in the frequency ranges prescribed for the upstream path bandwidth and the downstream path band, respectively.

In conventional implementations of hardline coaxial cable plants, amplifiers may be distributed along the hardline coaxial cable plant of a given node at distances of approximately 1200 feet between amplifiers. One typical characterization of a node is referred to as “cascade,” which is the number of amplifiers in the longest branch of the hardline coaxial cable plant in the node. More specifically, the cascade for a given node often is denoted as “NODE+N,” in which N denotes the number of amplifiers between the RF/optical bridge converter of the node and an endpoint of the longest branch of the hardline coaxial cable plant in the node. With reference to FIG. 2, the illustrated example of the hardline cable plant 180 includes two amplifiers 167; if this illustration represented the entire hardline cable plant in the first node 164A, the cascade for this node would be referred to as “NODE+2.” In many conventional implementations of cable communication systems, typical cascades for hardline coaxial cable plants in respective nodes of the system are five or six (i.e., NODE+5 and NODE+6) (see section 3.1, pages 3-4 of “Architecting the DOCSIS Network to Offer Symmetric 1 Gbps Service Over the Next Two Decades,” Ayham Al-Banna, The NCTA 2012 Spring Technical Forum Proceedings, May 21, 2012, hereafter “Al-Banna,” which publication is hereby incorporated herein by reference in its entirety).

The hardline cable plant of FIG. 2 also may include one or more power splitters/combiners or directional couplers 189 (also shown in FIG. 3E) which generally serve to divide an input RF signal into two or more RF output signals or combine multiple input RF signals into one RF output signal. These devices may divide an RF signal on one feeder section of the hardline cable plant to provide respective RF signals on two different feeder sections of the hardline cable plant; conversely, these devices may combine RF signals from respective different feeders onto a same feeder of the hardline plant.

FIGS. 3H and 3I schematically illustrate a two-way power splitter and a four-way splitter, respectively, that act as power splitters in one direction and power combiners in the opposite direction. More specifically, applying an RF signal to the input of the two-way power splitter in FIG. 3H yields a pair of identical RF signals, each with approximately half the power of the RF signal applied to the input (neglecting loss). Similarly, applying two RF signals to the outputs of the two-way power splitter yields an RF signal at the input equal to the sum of the RF signals applied to the outputs. Multiple two-way power splitters can be concatenated to form a power splitter with more outputs, such as the four-way power splitter shown in FIG. 3I. Like the two-way power splitter, the four-way power splitter transmits RF signals upstream as well as downstream without any significant attenuation.

FIG. 3J schematically illustrates a directional coupler 389, which receives an RF signal at its input and transmit a first portion (e.g., 50-99%) of the power in this RF signal via an output and the remaining portion (e.g., 1-50%) of the power in the RF signal via a coupled port. RF power can also flow from the output to the input with little to no attenuation, but RF power flowing from the coupled port to the input is attenuated significantly (e.g., by about 5 to 10 dB or more). This dependence on the direction of power flow causes the directional coupler to behave like a one-way valve for RF power.

A distribution tap (or simply “tap”) 188 of the hardline cable plant (see FIG. 3G) provides a connection point between the hardline cable plant and a subscriber service drop 163C. In one aspect, a tap functions similarly to a directional coupler in that a small portion of one or more downstream RF signals on the hardline coaxial cable 163B (e.g., in a “feeder” of the hardline plant) is extracted for providing to a subscriber premises 190. In the upstream direction, taps may be configured with different predetermined attenuation values (e.g., 4 dB, 11 dB, 17 dB, 20 dB) for attenuating RF signals originating from a subscriber premises 190 (e.g., signals transmitted by the subscriber modem 165) and intended for propagation along the hardline cable plant 180 toward the headend 162 of the cable communication system 160. Taps 188 may come in various forms, including multi-port taps, which in some implementations comprise one or more directional couplers and one or more power splitters/combiners. Taps typically include threaded connector ports to facilitate coupling to one or more hardline coaxial cable(s) and one or more subscriber service drop cables. In common examples, a port on a tap to which a subscriber service drop 163C is coupled may be constituted by a female F-type connector or jack, and the subscriber service drop 163C includes a coaxial cable terminated with a male F-type connector for coupling to the port of the tap 188. Thus, in one aspect, the female F-type connector(s) of one or more taps 188 of the hardline cable plant 180 serve as a “boundary” between the hardline cable plant and other elements of the cable communication system generally associated with one or more subscriber premises 190. FIG. 3K schematically illustrates a four-way distribution tap 188 based on a directional coupler and a four-way power splitter. The four-way distribution tap 188 shown in FIG. 3K splits RF signals flowing downstream but attenuates RF signals flowing upstream.

Line terminators 191 of the hardline cable plant 180 (see FIG. 3C) electrically terminate RF signals at the end of a feeder to prevent signal interference. Line terminators 191 may include various materials and provide differing levels of shielding from environmental elements.

Various connectors 193 (see FIG. 3B) employed in the hardline cable plant 180, also referred to herein as “fittings,” may join two coaxial cables from separate sheaths, or may join a coaxial cable to one of the elements discussed above (e.g., amplifiers, power supplies, taps, directional couplers, line terminators, etc.). Connectors may be male, female, or sexless; some connectors have female structures with slotted fingers that introduce a small inductance; other connectors involve pin-based structures (e.g., pin-type connectors, such as housing terminators, extension fittings, 90-degree fittings, splice connectors, etc.). One common example of a connector is given by “F” series connectors, which may have ⅜-32 coupling thread or may be push-on. Other types of connectors employed in hardline cable plants include UHF connectors, BNC connectors, and TNC connectors. Various connectors differ in the methods they use for connecting and tightening. A splice block 195 (see FIG. 3D) is a particular type of connector used to join two respective segments of hardline coaxial cable.

With reference again to FIG. 2, an analyzer 110 (e.g., a spectrum analyzer and/or a tuned receiver) may be coupled to a junction between the bridge converter 167 and the hardline cable plant 180 so as to monitor RF signals that are transmitted to and/or received from the first node 164A. The coupling of the analyzer 110 to the junction between the bridge converter 167 and the hardline cable plant 180 is shown in FIG. 2 using dashed lines, so as to indicate that the analyzer 110 is not necessarily included as a constituent element of the first node, but may be optionally employed from time to time as a test instrument to provide information relating to signals propagating to and/or from the first node. As discussed further below in connection with FIGS. 1 and 4, an analyzer similarly may be employed in the headend to monitor various RF signals of interest in the cable communication system.

Headend

With reference again to FIG. 1, the headend 162 of the cable communication system 160 generally serves as a receiving and processing station at which various entertainment program signals (e.g., television and video programming from satellite or land-based sources) are collected for retransmission to the subscriber premises of respective nodes 164A, 164B, and 164C over the downstream path band of each node. The headend 162 also may serve as a connection point to various voice-based services and/or Internet-based services (e.g., data services) that may be provided to the subscriber premises of respective nodes 164A, 164B, and 164C; such voice-based services and/or Internet-based services may employ both the upstream path bandwidth and downstream path band of each node. Accordingly, the headend 162 may include various electronic equipment for receiving entertainment programming signals (e.g., via one or more antennas and/or satellite dishes, tuners/receivers, amplifiers, filters, etc.), processing and/or routing voice-related information, and/or enabling Internet connectivity, as well as various electronic equipment for facilitating transmission of downstream information to, and receiving upstream information from, the respective nodes. Some conventional cable communication systems also include one or more “hubs” (not shown in FIG. 1), which are similar to a headend, but generally smaller in size; in some cable communication systems, a hub may communicate with a larger headend, and in turn provide television/video/voice/Internet-related services only to some subset of nodes (e.g., as few as a dozen nodes) in the cable communication system.

Since each node of the cable communication system 160 functions similarly, some of the salient structural elements and functionality of the headend 162 may be readily understood in the context of a single node (e.g., represented in FIG. 1 by the first node 164A). Accordingly, it should be appreciated that the discussion below regarding certain elements of the headend 162 particularly associated with the first node 164A applies similarly to other elements of the headend that may be associated with and/or coupled to other nodes of the cable communication system 160.

As shown in FIG. 1, the fiber optic cable 163A of the first node 164A is coupled to an optical/RF bridge converter 175 within the headend 162 (also referred to herein as a “headend optical/RF bridge converter”). As also shown in FIG. 1, each of the other nodes 164B and 164C similarly is coupled to a corresponding optical/RF bridge converter of the headend 162. The headend bridge converter 175 functions similarly to the bridge converter 167 of the first node; i.e., the headend bridge converter 175 converts upstream optical signals carried by the fiber optic cable 163A to RF signals 177 within the headend 162. In some implementations, the headend bridge converter 175 is constituted by two distinct devices, e.g., a downstream transmitter to convert RF signals originating in the headend to downstream optical signals, and an upstream receiver to convert upstream optical signals to RF signals in the headend. The headend 162 also may include an RF splitter 173, coupled to the headend bridge converter 175, to provide multiple paths (e.g., via multiple ports of the RF splitter) for the RF signals 177 in the headend that are transmitted to or received from the headend bridge converter 175. As discussed in greater detail below in connection with FIG. 4, the RF splitter 173 provides for various equipment (e.g., demodulators, modulators, controllers, test and monitoring equipment) to be coupled to the RF signals 177 within the headend carrying information to or from the first node 164A; for example, FIG. 1 illustrates an analyzer 110 (e.g., a spectrum analyzer), coupled to the RF splitter 173, that may be employed to monitor RF signals 177 in the headend 162 that are transmitted to and/or received from the first node 164A (as also discussed above in connection with FIG. 2).

The headend 162 shown in FIG. 1 also includes a cable modem termination system (CMTS) 170 that serves as the central controller for the subscriber modems in respective nodes of the cable communication system 160. In general, the CMTS 170 provides a bridge between the cable communication system 160 and an Internet Protocol (IP) network and serves as an arbiter of subscriber time sharing (e.g., of upstream path bandwidth in each node) for data services. In particular, for upstream information transmitted from subscriber modems in a given node to the headend 162 (e.g., the upstream information 184 from the first node 164A), in example implementations the CMTS 170 instructs a given subscriber modem in a given node when to transmit RF signals (e.g., onto a corresponding subscriber service drop and the hardline plant of the given node) and what RF carrier frequency to use in the upstream path bandwidth of the node (e.g., the upstream path bandwidth 182 of the first node 164A). The CMTS 170 then demodulates received upstream RF signals (e.g., the RF signals 177 from the first node 164A) to recover the upstream information carried by the signals, converts at least some of the recovered upstream information to “outgoing” IP data packets 159, and directs the outgoing IP data packets to switching and/or routing equipment (not shown in FIG. 1) for transmission on the Internet, for example. Conversely, the CMTS 170 also receives “incoming” IP data packets 159 from the Internet via the switching and/or routing equipment, modulates RF carrier waves with data contained in the received incoming IP data packets, and transmits these modulated RF carrier waves (e.g. as RF signals 177) to provide at least some of the downstream information (e.g., the downstream information 183 of the first node 164A) to one or more subscriber modems in one or more nodes of the cable communication system.

As also indicated in FIG. 1, in some implementations in which the recovered upstream information includes voice information (e.g., from subscriber premises receiving VoIP services), the CMTS 170 may also direct “outgoing” voice information 157 to a voice switch coupled to a Public Switched Telephone Network (PSTN). The CMTS 170 also may receive “incoming” voice information 157 from the PSTN, and modulate the received incoming voice information onto RF carrier waves to provide a portion of the downstream information.

As illustrated in FIG. 1, the CMTS 170 may include multiple RF ports 169 and 171, in which typically one pair of RF ports 169 and 171 of the CMTS facilitates coupling of a corresponding node of the cable communication system 160 (in some instances via one or more RF splitters 173) to the CMTS 170; in particular, for the first node 164A shown in FIG. 1, downstream RF port 169 provides downstream information from the CMTS to the first node, and upstream RF port 171 provides upstream information to the CMTS from the first node. For each downstream RF port 169, the CMTS further includes one or more modulation tuners 172 coupled to the downstream RF port; similarly, for each upstream RF port 171, the CMTS includes one or more demodulation tuners 174 coupled to the upstream RF port 171. As noted above, the modulation tuner(s) 172 is/are configured to generate one or more modulated RF carrier waves to provide downstream information to subscriber modems of the node coupled to the corresponding RF port 169; conversely, the demodulation tuner(s) 174 is/are configured to demodulate one or more received upstream RF signals carrying upstream information from the subscriber modems of the node coupled to the corresponding RF port 171.

FIG. 4 illustrates further details of a portion of the headend 162 shown in FIG. 1, relating particularly to upstream information received from subscriber modems of the first node 164A via the fiber optic cable 163A, and exemplary arrangements of the CMTS 170. For example, FIG. 4 shows that the RF splitter 173 associated with the first node 164A may include multiple ports to couple upstream RF signals 177 received from the first node to each of the analyzer 110, one RF port 171 of the CMTS 170, a digital account controller 254 (DAC), and other test and/or monitoring equipment 256. The DAC 254 relates primarily to video programming (e.g., managing on-demand video services by receiving programming requests from subscriber premises “set-top boxes” and coordinating delivery of requested programming). As discussed elsewhere herein, the analyzer 110 may be configured to monitor a spectrum of the upstream path bandwidth to measure an overall condition of the upstream path bandwidth (e.g., a presence of noise in the node) and/or provide performance metrics relating to the conveyance of upstream information in the node (e.g., for diagnostic purposes). Other test and/or monitoring equipment 256 may be configured to receive signals from field-deployed monitoring devices (most typically in power supplies in the node) to alert system operators of critical events (e.g., a power outage) or other alarm conditions.

The CMTS 170 itself may be constructed and arranged as a modular apparatus that may be flexibly expanded (or reduced in size) depending in part on the number of nodes/subscribers to be served by the cable communication system 160. For example, the CMTS 170 may have a housing configured as a chassis with multiple slots to accommodate “rack-mountable” modular components, and various RF modulation/demodulation components of the CMTS may be configured as one or more such modular components, commonly referred to as “blades,” which fit into respective slots of the CMTS's chassis. FIG. 4 shows a portion of the CMTS 170 including two such “blades” 252.

As illustrated in FIG. 4, each blade 252 of the CMTS 170 may include multiple upstream RF ports 171 (e.g., four to six ports per blade), as well as one or more downstream ports (not explicitly shown in FIG. 4). Historically, each upstream RF port 171 of a blade 252 was coupled to only one demodulation tuner 174 serving a particular node coupled to the upstream RF port 171; in more recent CMTS configurations, a blade 252 may be configured such that one or more upstream RF ports 171 of the blade may be coupled to multiple demodulation tuners 174 (e.g., FIG. 4 shows two demodulation tuners 174 coupled to one upstream port 171 of the top-most blade 252). In this manner, the upstream information from a given node may be received by the CMTS via multiple RF signals 177 (i.e., one RF signal per demodulation tuner 174 coupled to the blade's upstream RF port 171 corresponding to the given node). The CMTS 170 may include virtually any number of blades 252, based at least in part on the number of nodes included in the cable communication system 160 (and the number of RF ports per blade).

Various implementations of the CMTS 170 constitute examples of a “cable modem system,” which generally refers to one or more modulation tuners and/or demodulation tuners, and associated controllers and other equipment as may be required, to facilitate communication of downstream information to, and/or upstream information from, one or more subscriber premises. As noted above, one or both of the downstream information and upstream information handled by a cable modem system may include a variety of data content, including Internet-related data, voice-related data, and/or audio/video-related data. Other implementations of a cable modem system may include a “Converged Cable Access Platform” (CCAP), which combines some of the functionality of a CMTS discussed above and video content delivery in contemplation of conventional MPEG-based video delivery migrating to Internet Protocol (IP) video transport (e.g., see “CCAP 101: Guide to Understanding the Converged Cable Access Platform,” Motorola whitepaper, February 2012, http://www.motorola.com/staticfiles/Video-Solutions/Products/Video-Infrastructure/Distribution/EDGE-QAM/APEX-3000/_Documents/_StaticFiles/12.02.17-Motorola-CCAP%20101 white%20paper-US-EN.pdf, which whitepaper is hereby incorporated by reference herein in its entirety). For purposes of the discussion below, the CMTS 170 is referred to as a representative example of a “cable modem system;” however, it should be appreciated that the various concepts discussed below generally are applicable to other examples of cable modem systems, such as a CCAP.

FIG. 5 illustrates a portion of an example node corresponding to a suburban residential neighborhood in which respective subscriber premises and corresponding subscriber service drops are geographically separated from each other over some appreciable distance. In this case, a tap 188 connects a hardline coaxial cable 163B to subscriber premises 190a-190d (collectively, subscriber premises 190) via respective ports and subscriber service drop cables 163C-a through 163C-d (collectively, subscriber service drop cables 163C) that are coupled to respective ground blocks 198a-198d. As noted above, the subscriber service drops 163C typically include flexible coaxial cable such as type RG-59, RG-6, and RG-11. The ground blocks 198 bond the shields of the subscriber service drop cables 163C to the grounding system of the wiring in the corresponding subscriber premises 190, and connect the signal conductor to subscriber wiring and/or one or more coaxially coupled devices inside the corresponding subscriber premises.

In this example, each ground block 198 acts as a boundary, or demarcation point, between the subscriber wiring inside the corresponding subscriber premises 190 and remaining elements of the HFC cable communication system 160. In some instances, a system operator (e.g., MSO) of the cable communication system 160 may use such a boundary or demarcation point to differentiate between the subscriber wiring and/or subscriber devices and remaining elements of the system, e.g., for ownership and/or liability purposes. The demarcation point may also represent the extent of the system operator's responsibility for installation and maintenance (e.g., the system operator has no responsibility for installation and maintenance in connection with subscriber wiring and/or subscriber devices).

FIG. 6 provides further details of the subscriber premises 190 shown in FIG. 2 and illustrates additional examples of various subscriber premises equipment. In FIG. 6, the subscriber service drop cable 163C is connected to the subscriber premises at ground block 198, which in turn connects to a four-way splitter/combiner 194a inside the subscriber premises 190 via an interior cable 192. Additional interior cable 192 connects the outputs of the four-way splitter/combiner 194a to an unterminated connector 196, a cable modem 165, a first television 603a, and a two-way splitter/combiner 194b, which is coupled in turn to a second television 603b and a digital video recorder (DVR) 604. As understood by those of skill in the art, the cable modem 165 may provide high-speed internet access, including voice-over-IP (VoIP) access, and may be coupled to wireless router (not shown) for wireless internet access.

Egress and Ingress

With reference again to FIG. 1, a cable communication system is considered theoretically as a “closed” information transmission system, in that transmission of information between the headend 162 and subscriber modems 165 occurs via the physical communication media of optical fiber cable, a hardline cable plant, and subscriber service drop cables (and not over air or “wirelessly”) via prescribed portions of frequency spectrum (i.e., in the U.S., upstream path bandwidth from 5 MHz to 42 MHz; downstream path band from 50 MHz to 750 MHz or higher). In practice, however, cable communication systems generally are not perfectly closed systems, and may be subject to signal leakage both out of and into the system (e.g., through faulty/damaged coaxial cable and/or other cable communication system components). The term “egress” refers to signal leakage out of a cable communication system, and the term “ingress” refers to signal leakage into a cable communication system. A significant operating and maintenance expense for owners/operators of cable communication systems relates to addressing the problems of signal egress and ingress.

More specifically, egress occurs when RF signals travelling in the downstream path band of a cable communication system leak out into the environment. Egress may cause RF interference with devices in the vicinity of the point of egress, and in some cases can result in weaker downstream RF signals ultimately reaching the subscriber modems 165. The Federal Communications Commission (FCC) enforces laws established to regulate egress, noting that egress may cause interference with “safety-of-life” radio services (communications of police, fire, airplane pilots) and thereby endanger the lives of the public by possibly hampering safety personnel's efforts. Accordingly, the FCC has set maximum individual signal leakage levels for cable communication systems. As a further prevention, the FCC requires cable communication system operators to have a periodic on-going program to inspect, locate, and repair egress on their systems.

In light of the potential for catastrophic harm which may be caused by cable communication system egress interfering particularly with aeronautical navigational and communications radio systems, the FCC requires more stringent regulations for cable communication system egress in the aeronautical radio frequency bands (sometimes referred to as the “aviation band,” from approximately 110 MHz to 140 MHz). For example, any egress in the aviation band which produces a field strength of 20 μV/m or greater at a distance of three meters must be repaired in a reasonable period of time. Due to these regulations and government oversight by the FCC, cable communication system operators historically have focused primarily on egress monitoring and mitigation.

Ingress is noise or interference that may occur from an outside signal leaking into the cable communication system infrastructure. The source of the outside signal is commonly referred to as an “ingress source.” Some common ingress sources include broadband noise generated by various manmade sources, such as automobile ignitions, electric motors, neon signs, power-line switching transients, arc welders, power-switching devices such as electronic switches and thermostats, and home electrical appliances (e.g., mixers, can openers, vacuum cleaners, etc.) typically found at subscriber premises. Although some of these ingress sources produce noise events in the 60 Hz to 2 MHz range, their harmonics may show up in the cable communication system upstream path bandwidth from 5 MHz to 42 MHz. “Impulse” noise is generally characterized by a relatively short burst of broadband noise (e.g., 1 to 10 microseconds), and “burst” noise is generally characterized by bursts of broadband noise with durations up to about 100 microseconds. In addition to manmade sources of broadband noise which may contribute to burst or impulse noise, natural sources of burst noise include lightning and electrostatic discharge, which may give rise to noise events from 2 kHz up to 100 MHz.

Other ingress sources include relatively narrowband signals arising from transmission sources that may be proximate to the cable communication system (e.g., transmitting devices such as HAM or CB radios in the vicinity, subscriber premises garage door openers, fire and emergency communication devices, and pagers). In particular, ham radio operators use carrier frequencies at 7 MHz, 10 MHz, 14 MHz, 18 MHz, 21 MHz, 24 MHz and 28 MHz, and citizen band radios use frequencies at approximately 27 MHz, all of which fall within the upstream path bandwidth of the cable communication system.

The foregoing ingress sources often create intermittent and/or seemingly random signals that may leak into the infrastructure of the cable communication system, causing disturbances that may be difficult to locate and/or track over time. Such disturbances may impede normal operation of the cable communication system, and/or render some communication bandwidth significantly compromised or effectively unusable for conveying information. In particular, ingress from these random and/or intermittent sources may undesirably and unpredictably interfere with transmission of upstream information by operative RF signals in the upstream path bandwidth. Yet another ingress source includes “terrestrial” signals present in free space, primarily from short wave radio and radar stations (e.g., short wave radio signals are present from approximately 4.75 MHz to 10 MHz).

It is commonly presumed in the cable communication industry that egress may serve as a proxy for ingress; i.e., where there is an opening/fault in the cable communication system that allows for signal leakage from the system to the outside (egress), such an opening/fault likewise allows for outside signals to enter the cable communication system (ingress). It is also commonly presumed in the cable communication industry that a significant majority of cable communication system faults allowing for signal leakage into and out of the system occur almost entirely in connection with system elements associated with one or more subscriber premises; more specifically, subscriber service drop cables, and particularly subscriber premises equipment, are conventionally deemed to be the greatest source of signal leakage problems.

More specifically, poorly shielded subscriber premises equipment (e.g., defective or inferior quality cables 192; loose, corroded, or improperly installed connectors 193; and improperly terminated splitters 194 as shown in FIG. 2), together with faults associated with the subscriber service drop 163C (e.g., pinched, kinked, and/or inferior quality/poorly shielded cable 163C; loose, corroded, or improperly installed drop connectors to the tap 188; improper/poor splices or connections to the ground block 198), are conventionally deemed to account for 95% or more of ingress in the cable communication system (i.e., 75% inside subscriber premises plus 20% subscriber service drop, as noted above). While the hardline cable plant 180 generally is considered to be significantly better shielded and maintained (e.g., by the cable communication system owner/operator), in contrast the respective subscriber premises 190 typically are the least accessible and least controllable (i.e., they are generally private residences or businesses) and, as such, the least regularly maintained portion of the cable communication system 160 (i.e., there is no regular access by the system owner/operator); hence, subscriber premises and their associated service drops are generally considered in the industry to be the most susceptible to signal leakage problems. Faults in subscriber service drop cables 163C and/or within subscriber premises 190 are considered to readily permit ingress from common ingress sources often found in household devices (e.g., appliances, personal computers, other consumer electronics, etc.) of cable communication system subscribers, as well as other ingress sources (e.g., garage door openers, various transmitting devices such as HAM or CB radios in the vicinity, fire and emergency communication devices, and terrestrial signals).

With respect to conventional ingress mitigation techniques, some approaches involve installing passive filters (e.g., in the taps 188 or within subscriber premises 190) to attenuate ingress originating from subscriber premises, while other approaches involve active systems that monitor communication traffic on the upstream path bandwidth and attenuate all or a portion of this bandwidth during periods of idle traffic. These approaches do not attempt to identify or eliminate ingress sources, but merely attempt to reduce their impact, and are accordingly not completely effective. Some other approaches, discussed in detail below, do attempt to identify subscriber-related faults that allow for ingress, but are generally labor and/or time intensive and largely ineffective. Furthermore, given the conventional presumption that 75% or more of ingress problems are deemed to relate to faults inside subscriber premises, even if ingress sources of this ilk are identified they may not be easily addressed, if at all (e.g., it may be difficult or impossible to gain access to one or more subscriber premises in which faults giving rise to ingress are suspected).

One conventional method for detecting ingress is to sequentially disconnect respective sections of hardline coaxial cable 163B (“feeders”) within the node in which suspected ingress has been reported (e.g., by disconnecting a given feeder branch from the port of a directional coupler 189), and concurrently monitor resulting variations in the noise profile of the upstream path bandwidth as seen from the headend of the network (e.g., using the analyzer 110 shown in FIGS. 1, 2 and 4). This technique is sometimes referred to as a “divide and conquer” process (e.g., akin to an “Ariadne's thread” problem-solving process), and entails a significantly time consuming trial-and-error approach, as there are often multiple hardline coaxial cable feeder branches ultimately serving several subscriber premises, any one or more of which could allow for ingress to enter the network; accordingly, this technique has proven to be inaccurate and inefficient at effectively detecting points of ingress. Additionally, disruptive conventional methods involving disconnecting different feeder cables in the node cause undesirable subscriber interruption of ordinary services, including one or more of entertainment-related services, data and/or voice services, and potentially critical services (i.e. lifeline or 911 services).

Other conventional approaches to ingress mitigation employ low attenuation value switches (termed “wink” switches), installed in different feeder branches of the hardline cable plant, to selectively attenuate noise in the upstream path bandwidth and thereby facilitate localizing potential sources of ingress. Each wink switch has a unique address, and the various switches are sequentially controlled to introduce some amount of attenuation in the corresponding branch. The upstream path bandwidth is monitored at the headend (e.g., via the analyzer 110) while the wink switches are controlled, allowing observation at the headend for any changes in noise level in the upstream path bandwidth that may be attributed to respective corresponding branches. In one aspect, the use of wink switches in this approach constitutes an essentially automated methodology of the approach described immediately above (i.e., “divide and conquer”), but suffers from the same challenges; namely, the feeder branches being selectively attenuated ultimately serve several subscriber premises, any one or more of which could allow for ingress to enter the network. Accordingly, pinpointing potential points of ingress remains elusive.

In yet other conventional approaches, mobile transceivers may be employed in an attempt to detect both egress and ingress. For example, U.S. Pat. No. 5,777,662 (“Zimmerman”), assigned to Comsonics, Inc., discloses an ingress/egress management system for purportedly detecting both ingress and egress in a cable communication system. The system described in Zimmerman includes a mobile transceiver that receives RF egress and records GPS coordinates. The mobile transceiver also transmits a signal that is modulated with GPS coordinates. If there is a significant fault in the cable communication system allowing for ingress in the vicinity of signal transmission, the transmitted signal may be received at the headend of the network by a headend monitoring receiver. Based on transmitted signals that are received at the headend, a computer assigns coordinates to potential flaws within the cable system to generate a simple point map of same so that they may be repaired by a technician. One disadvantage of this system is that the transmitted signal modulated with GPS coordinates must be received at the headend with sufficient strength and quality to permit identification of the location of a potential flaw; in other words, if a potential flaw is not significant enough so as to admit the transmitted signal with sufficient strength, but is nonetheless significant enough to allow some amount of ingress to enter into the system, no information about the location of the potential flaw is received at the headend. Thus, obtaining an accurate and complete profile of potential ingress across a range of signal levels (and across a significant geographic area covered by a cable communication system), arguably is significantly difficult to achieve (if not impossible) using the techniques disclosed in Zimmerman.

It is generally understood that noise levels due to ingress in the upstream path bandwidth may vary as a function of one or more of time, frequency, and geographic location. Conventional ingress detection and mitigation techniques generally have been marginally effective in reducing ingress to some extent in the upper portion of the upstream path bandwidth (e.g., above 20 MHz); however, notable ingress noise levels continue to persist below approximately 20 MHz, with ingress noise at the lower end of this range (e.g., 5 MHz to approximately 18 MHz, and particularly below 16.4 MHz, and more particularly below 10 MHz) being especially significant.

As a result, it is widely accepted in the cable communication industry that only a portion of the upstream path bandwidth of a cable communication system, generally from about 20 MHz to 42 MHz, may be used in some circumstances (e.g., depending in part on the presence of broadband noise and/or narrowband interference, carrier frequency placement of one or more communication channels, carrier wave modulation type used for the channel(s), and channel bandwidth) for transmission of upstream information from subscriber modems to the headend, and that the lower portion of the upstream path bandwidth (e.g., generally from about 5 MHz to about 20 MHz, and particularly below 18 MHz, and more particularly below 16.4 MHz, and more particularly 10 MHz) is effectively unusable due to persistent ingress.

### SUMMARY

U.S. Pat. No. 8,543,003, entitled “INGRESS-MITIGATED CABLE COMMUNICATION SYSTEMS AND METHODS HAVING INCREASED UPSTREAM CAPACITY FOR SUPPORTING VOICE AND/OR DATA SERVICES” and issued on Sep. 24, 2013 (hereafter, “the '003 patent”), which is hereby incorporated by reference herein in its entirety, generally discusses inventive methods, apparatus and systems for detecting and mitigating ingress in HFC cable communication systems. In some example implementations discussed in this patent, both the RF hardline cable plant and respective subscriber premises are considered as possible sources of faults giving rise to appreciable ingress in a given node of a cable communication system. Additionally, in some examples disclosed in this patent, subscriber premises equipment that is communicatively coupled to the RF hardline cable plant in one or more nodes of a cable communication system generally are geographically separated from each other to some appreciable degree (e.g., in a rural area or in a suburban subdivision—see FIG. 5), such that respective subscriber premises are individually discernible as possible sources of faults giving rise to ingress in a given node. For example, each subscriber premises in a given node may have its own dedicated subscriber service drop cable communicatively coupling the subscriber premises to the hardline cable plant in the node, such that there is a one-to-one correspondence between a subscriber premises and a dedicated/physically isolated subscriber service drop. Such a dedicated subscriber service drop in turn generally isolates the subscriber premises equipment at a given subscriber premises from similar equipment at another subscriber premises.

In this context, the '003 patent describes a two-phase methodology for detecting and reducing ingress in a node of a cable communication system wherein: 1) in Phase 1, respective sources of ingress in a given node (arising from faults in one or both of the hardline cable plant and one or more subscriber premises) are comprehensively identified throughout the node; and 2) in Phase 2, a field technician subsequently “homes-in” on a given prospective fault identified in Phase 1 so as to corroborate its status as a fault and make appropriate repair/remediation, thereby reducing ingress in the node.

Collocation and Dense Subscriber Environments

In contrast to cable communication system environments serving subscribers in rural areas or suburban subdivisions (hereafter referred to generally as “low-density subscriber environments”), the Inventors have recognized and appreciated that cable communication system environments involving a relatively higher density of subscribers (e.g., urban environments having multiple dwelling units in which subscribers are domiciled; business, academic or government environments having one or more building complexes occupied by multiple subscribers; etc.) give rise to additional challenges in detecting and mitigating ingress in a given node of a cable communication system. In particular, the Inventors have recognized and appreciated that a common attribute of relatively higher density subscriber environments relates to increased proximity or “collocation” to some extent of system components associated with communicative coupling of respective subscribers to the hardline cable plant in a given node. That is, a high-density subscriber environment tends to have a relatively higher concentration per unit area of cable communication system components that are located in significant proximity to one another (e.g., placed side by side, next to or on top of each other, and/or otherwise arranged within a few meters of each other). Such collocation of system components (and particularly subscriber-related system components) in a relatively higher density subscriber environment in some instances presents particular challenges in Phase 2 of the ingress detection and mitigation methodology described in the '003 patent, in that it may be more difficult in some instances to “home-in” on one or more particular subscriber-related faults that may be present in a given node.

In this disclosure, the terms “collocated cable communication system components” and “collocated cable communication system equipment” refer to both passive components (e.g., coaxial cables, taps, splitters, ground blocks) and active components of a cable communication system that are set or arranged in significant proximity to one another (e.g., placed side by side, next to or on top of one other, and/or otherwise arranged within a few meters of each other, such as within about 5 meters of one another).

The Inventors have recognized and appreciated that in some cable communication system implementations, collocated cable communication system components often are found at (or otherwise proximately associated with) a “multi-occupant structure.” For purposes of the present disclosure, a multi-occupant structure refers to a building or building complex that: i) includes multiple subscriber modems and/or other collocated subscriber service equipment (e.g., distribution taps, ground blocks); and/or ii) includes or is coupled to multiple collocated subscriber service drops. In some examples discussed in greater detail below, a multi-occupant structure itself includes multiple subscriber premises or multiple subscribers (e.g., each with a different subscription to receive various services via a cable communication system, and hence a dedicated subscriber service drop); additionally, it should be appreciated that a multi-occupant structure in some instances may be owned, rented, occupied and/or operated by a single entity (e.g., a company, organization, institution, government entity, or landlord), but nonetheless may include/contain multiple subscriber modems and/or other collocated subscriber service equipment, and/or include or be coupled to multiple collocated subscriber service drops. Examples of multi-occupant structures include, but are not limited to, mixed-use buildings (e.g., commercial/residential buildings); office buildings; shopping malls; medical, academic, government, and military complexes/campuses; and “multi-dwelling units” (MDUs). Examples of MDUs include, but are not limited to, apartment buildings, condominium complexes, multi-family houses (e.g., two- and three-family houses), townhouses, dormitories, hotels, motels, long-term care facilities, resorts, and other structures that include a plurality of separate residential spaces, at least some of which may have respective dedicated subscriptions to receive services provided via a cable communication system.

As noted above, in many instances a multi-occupant structure may be coupled to more than one subscriber service drop 163C, include more than one subscriber service drop 163C, and/or contain connections for more than one subscriber service drop 163C for supporting multiple subscriptions to the services provided via the cable communication system 160. For instance, in an apartment building, each apartment may have a dedicated subscriber service drop 163C, and respective tenants in at least some of the apartments may have his or her own subscription to cable services. Similarly, one or more families in a multi-family house may have a subscription to receive services that are delivered via a dedicated subscriber service drop 163C. Likewise, multiple businesses in a shopping mall may have respective subscriptions to cable services provided via corresponding dedicated subscriber service drops 163C, and multiple departments/employees in a corporate complex may have respective subscriptions provided via corresponding dedicated subscriber service drops. Accordingly, the concept of collocated subscriber service drops in various instantiations of multi-occupant structures is a prevalent theme in some inventive embodiments discussed in greater detail below; in particular, multiple embodiments disclosed herein address various challenges relating to identifying and remediating ingress arising from faults in multi-occupant structures containing or otherwise associated with collocated subscriber service drops.

Non-Limiting Examples of “Multi-Occupant Structures”

FIGS. 7-15 show non-limiting examples of multi-occupant structures connected to at least one tap 188 that is in turn coupled to a hardline coaxial cable 163B in a given node of the example cable communication system 160 discussed above. These examples illustrate the concept of collocated cable communication system components, including collocated subscriber service drops, ground blocks, and other wiring associated with multi-occupant structures. Some examples include multi-dwelling units, such as apartment buildings and duplexes, and other examples include commercial structures. It should be appreciated that these examples are provided primarily for purposes of illustration, and that other configurations of multi-occupant structures not explicitly shown herein may be the subject of (and benefit from) the various inventive ingress mitigation methods, apparatus and systems discussed in greater detail below.

FIG. 7 illustrates an example of a multi-occupant structure constituted by a two-family house, or duplex 700, comprising two subscriber premises 190a and 190b (collectively, subscriber premises 190). Two ports of the tap 188 are coupled to bundled (collocated) subscriber service drop cables 163C-a and 163C-b, which in turn connect to collocated ground blocks 198a and 198b. In this example, the ground blocks 198a and 198b are both affixed to the duplex's outer wall in proximity to one another. The respective outputs of the ground blocks 198a and 198b connect to corresponding subscriber wiring 192a and 192b (e.g., coaxial cable coupled to one or more pieces of subscriber premises equipment). FIG. 7 also shows that, in addition to collocated subscriber service drops, the subscriber wiring 192a and 192b may be collocated at least to some extent (e.g., as the wiring traverses the subscriber premises 190a).

FIG. 8 illustrates an example of a multi-occupant structure constituted by a set 800 of row homes (e.g., quadraplex dwelling units). The row homes 800 include multiple subscriber premises 190a-190d (collectively, subscriber premises 190), each of which shares one or more walls with at least one neighboring unit. In the example shown in FIG. 8, there are four subscriber premises, but there may be more or fewer premises in other examples of row homes. The tap 188 (e.g., a four-way directional tap with four tap ports) is coupled to the proximate ends of corresponding subscriber service drop cables 163C-a through 163C-d (collectively, subscriber service drop cables 163C). Accordingly, in this example the proximate ends of the subscriber service drop cables 163C are considered to be collocated with each other (and with the tap 188). However, the distal ends of the subscriber service drop cables 163C connect to respective non-collocated ground blocks 198a-198d (collectively, ground blocks 198), each of which is located on or near an outer wall of a corresponding subscriber premises 190 (the ground blocks 198b, 198c, and 198d are shown in dashed lines as being located on a rear outer side wall of the corresponding premises). In turn, the ground blocks 198 provide connections to subscriber wiring 192a-192d in each of the subscriber premises constituting the row homes. As may be appreciated from the example in FIG. 8, while the proximate ends of the subscriber drop cables are collocated with each other and with the tap 188, the distal ends of the subscriber drop cables, as well as the respective subscriber wiring, may not be collocated with each other.

FIG. 9 shows another configuration of row homes 900 to illustrate collocated subscriber-related cable system components. As in the example of FIG. 8, the row homes 900 include multiple subscriber premises 190a-190d (collectively, subscriber premises 190) that share walls with adjoining units. Also as in FIG. 8, the tap 188 has four tap ports that are coupled to proximate ends of subscriber service drop cables 163C-a through 163C-d (collectively, subscriber service drop cables 163C). Unlike the example of FIG. 8, however, in FIG. 9 the subscriber service drop cables 163C are connected to collocated ground blocks 198a-198d (collectively, ground blocks 198) mounted or affixed to a wall of the first subscriber premises 190a and in close proximity to each other (in some instances, the ground blocks 198 may be aligned in a row within inches of each other). Thus, the subscriber service drops cables 163C are bundled together, or collocated, from the tap 188 to the collocated ground blocks 198. As in the example of FIG. 7, FIG. 9 also illustrates that respective subscriber wiring 192a-192d (collectively, subscriber wiring 192) may be collocated, at least in part, as the wiring traverses the first three subscriber premises from the collocated ground blocks 198 toward the fourth subscriber premises 190d.

FIG. 10 illustrates an example of a commercial multi-occupant structure 1000, such as a strip mall or office park that includes eight business serving as subscriber premises 190a-190h (collectively, subscriber premises or businesses 190). In this example, the multi-occupant structure 1000 receives cable communication system services via a an 8-way terminating tap 188 or an 8-way splitter 189 (e.g., mounted on an exterior wall proximate to one of the businesses 190a). A bundle of eight collocated subscriber serve drops is coupled to the 8-way tap or 8-way splitter, to provide respective subscriptions of cable service to corresponding businesses of the multi-occupant structure. In some implementations (discussed in greater detail below—see FIGS. 12-15), collocated subscriber service drops for multiple businesses may be disposed together in a conduit or “raceway” within the multi-occupant structure (e.g., a channel or enclosure for housing utility connections or hardware, typically made of plastic, PVC, metal, or any other suitable material); additionally, collocated subscriber service drops may be attached as a wiring bundle to a baseboard, attached as a wiring bundle to the exterior of multiple premises (e.g., in a molded case along the length of a hallway), or routed on any other path along which or through building utilities may be routed. The 8-way terminating tap 188 or 8-way splitter 189 to which the collocated subscriber service drops are connected is in turn coupled to the hardline coaxial cable 163B of the hardline plant via a plant spur 163D, connected between single port tap 188 and ground block 198.

FIG. 11 illustrates another example of a commercial multi-occupant structure 1100, similar to that shown in FIG. 10, including eight businesses that are served by bundled subscriber service drop cables 163C-a through 163C-h (collectively, subscriber service drop cables 163C) all coupled to the tap 188 (which in this example is an eight-port distribution tap, or an “8-way tap”). Unlike the example of FIG. 10, in FIG. 11 the collocated subscriber service drops 163C are external to the multi-occupant structure 1100 and are connected to a single ground block 198, which is in turn coupled to corresponding subscriber wiring 192 for each of the eight businesses. As can be seen in FIG. 11, in some instances the subscriber wiring 192 for multiple businesses also may be bundled or otherwise collocated to at least some extent, as the wiring traverses the structure 1100.

As illustrated in the examples of FIG. 10 and FIG. 11, more dense subscriber environments typically employ splitting or distribution components such as 8-way splitters or 8-way taps. FIG. 11A is a close up view of the 8-way tap 188 of FIG. 11 connected to the eight subscriber service drop cables 163C-a through 163C-h. As can be readily appreciated from FIG. 11A, proximate ends of the subscriber service drop cables 163C-a through 163C-h are collocated with the tap 188. When deployed in connection with a multi-occupant structure or other relatively more dense subscriber environment, the subscriber service drop cables 163C-a through 163C-h often run for some distance together along a common path from the tap 188 to their ultimate destination (e.g., within a raceway or conduit), and hence are collocated to some extent along their length.

FIG. 11B shows respective components of the 8-way tap 188, including a tap back housing 1701 and a tap faceplate 1703. The tap back housing 1701 includes one or more couplers 1702, each of which may include threads or another seizure mechanism for connection to a corresponding coaxial cable (e.g., such as the hardline coaxial cable 163B). The faceplate 1703 often is removable from the back housing, and plugs into and is fastened by screws to the tap back housing 1701. The faceplate includes eight individual female F connectors 1704a-1704h (collectively, female F connectors 1704) that can be connected to respective coaxial cables (e.g., such as respective subscriber service drop cables 163C-a through 163C-h). If one or more of the female F connectors are not used in a particular implementation (i.e., not connected to a corresponding coaxial cable), one or more of the female F connectors 1704a-1704h may either be left unterminated or terminated with a corresponding 75Ω terminator 1707a-1707h, e.g., as shown at the bottom right in FIG. 11B. FIG. 11B also shows that, in one implementation, the 8-way tap 188 may include a bypass bar 1705 for preventing service interruptions to downstream taps if the faceplate 1703 is removed during installation, inspection, or maintenance. In some implementations, the bypass bar 1705 comprises a piece of metal that is pushed out of the electrical path between the connectors 1702 when the faceplate 1703 is positioned securely within the housing 1701. Removing the faceplate 1703 causes the bypass bar 1705 to bend or otherwise reversibly deform (e.g., like a leaf spring) so as to provide an electrical connection (short circuit) between the connectors 1702 when the faceplate 1703 is removed from the housing 1701. In other implementations, the functionality of the bypass bar may be implemented by another circuit element such as an inductor, as discussed below in connection with FIG. 11C.

FIG. 11C is an exemplary circuit diagram for the 8-way tap 188 shown in FIG. 11. In this example, the tap 188 includes an input port 302 (also referred to herein as an upstream port), which is electrically connected to an output port 304 (also referred to herein as a downstream port) via an inductor 330 in parallel with a two-port directional coupler 310. The directional coupler's directional output is coupled to set of concatenated splitters 312 that provide eight tap ports 320, each of which typically includes a corresponding F connector (e.g., the female F connectors 1704a-1704h shown in FIG. 11B). When installed in an RF hardline cable plant, the input port 302 is coupled to a first hardline coaxial cable, the output port 304 is coupled to a second hardline coaxial cable or a 75Ω terminator, and the tap ports 320 are connected to up to eight respective subscriber service drop cables. In operation, the tap 188 receives downstream signals in the downstream path band via the input port 302 and distributes them through the directional coupler 310 to the subscriber service drop cables connected to the tap ports 320 and to the downstream portion of the RF hardline cable plant, if any, via the output port 304 (if the tap 188 is at the end of a portion of the RF hardline cable plant, it may be connected to a 75Ω terminator). The tap 188 also directs upstream signals in the upstream path bandwidth from the subscriber service drop cables connected to the tap ports 320 and the downstream portion of the RF hardline cable plant connect to the output port 304 via the directional coupler 310 and the input port 302. If the tap's faceplate is removed, e.g., for inspection or maintenance, the inductor 330 provides an electrical path between the input port 302 and the output port 304 to avoid disrupting services provided to subscribers connected to the downstream portion of the RF hardline cable plant (if there are such additional taps/subscribers downstream in the node).

Returning now to additional examples of multi-occupant structures for which the inventive concepts disclosed herein may be implemented, FIG. 12 is a plan view of a single-story multi-occupant structure 1200, such as an apartment building or condominium complex, including subscriber premises 190a-190h (collectively, residences 190). The subscriber premises are coupled to the hardline cable plant 163B via an 8-way tap 188 disposed within a utility closet of lockbox 1202 within the multi-occupant structure 1200. The lockbox prevents theft of service and other unauthorized access to the cable communication system equipment and shields the cable communication system equipment from snow, rain, wind, etc. It may hold one or more taps along with portions of the subscriber service drop cables connected to the taps. For instance, an apartment building with 30 apartments may have a lockbox with up to 30 subscriber service drop cables 163C connected to respective ports on three 8-port taps (it is common to find groups of 8-port taps in a single lockbox even if not every port is being used). In some cases, the lockbox 1202 may hold additional equipment as well, including but not limited to active components and passive components. For example (e.g., the case of a building that comprises one or more nodes in the cable communication system), a lockbox may also hold one end of a fiber optic cable, an optical/RF converter, and one end of a hardline coaxial cable, plus any related amplifiers, filters, etc. for converting optical signals to RF signals and vice versa. As shown in FIG. 12, the tap 188 within the utility closet/lockbox is in turn coupled to bundled subscriber service drop cables 163C-a through 163C-h (collectively, subscriber service drop cables 163C). The subscriber service drop cables 163C are routed through a horizontal raceway 1205 within the multi-occupant structure (e.g., in a chase, under a floor, above a drop ceiling, etc.). As the raceway 1205 passes each of the individual residences 190, the respective subscriber service drop cables 163C may branch off toward corresponding subscriber premises 190.

FIG. 13 is a plan view of a single-story multi-occupant structure 1300 whose subscriber premises 190a-190h (collectively, residences 190) are connected to the hardline cable plant via a terminating leg of hardline coaxial cable 163B. The terminating leg of the hardline coaxial cable 163B is the last span of hardline coaxial cable in a particular branch of the hardline cable plant; its end may be terminated with a 75Ω terminator. As shown in FIG. 13, the hardline coaxial cable 163B connects to a ground block 198, which is connected to an optional 2-way indoor amplifier 187 whose output is in turn connected to an 8-way tap 188. As in FIG. 12, the 2-way indoor amplifier 187 and the 8-way tap 188 can be located in a utility closet or lockbox 1202. The eight outputs of the 8-way tap 188 are coupled to collocated subscriber service drop cables 163C-a through 163C-h (collectively, collocated subscriber service drop cables 163C). These subscriber service drop cables 163C are bundled together and traverse a horizontal raceway 1205. As described above with respect to FIG. 12, the bundled subscriber service drop cables 163C pass individual subscriber residences 190, with individual cables fanning out into each residence.

FIG. 14 illustrates a single-story multi-occupant structure 1400, such as an apartment building, condominium complex, hotel, dormitory, office building, or retail complex, that is large enough to support an entire neighborhood node of a cable communications system (note that only eight subscriber premises 190a-190h are shown for purposes of illustration). This multi-occupant structure 1400 is coupled to a hub or headend via one or more optical fibers 163A. The fiber(s) 163A is (are) connected to an optical node 164A, which may include an optical/RF converter, an amplifier, at least part of a hardline cable plant, and/or other cable communication system components, e.g., as described with respect to FIG. 1. The optical node 164A is in turn connected to one or more taps 188 and bundled subscriber service drop cables 163C-a-163C-h (collectively, bundled subscriber service drop cables 163C). The optical node 164A and tap(s) 188 may be located in a utility closet or lockbox 1202. The optical node 164A is typically bonded to the building grounding systems and acts as its own ground block. The individual subscriber service drop cables 163C travel down a horizontal raceway 1205 and fan out to feed the individual subscriber residences 190, e.g., as described above.

FIG. 15 illustrates a multi-story multi-occupant structure 1500 that uses an optical node 164A and a tapped feeder architecture with collocated subscriber service drop cables 163C-a1 through 163C-e6 for a plurality of subscriber premises 190a-1 through 190e-6 (collectively, subscriber premises 190). In this example, the multi-occupant structure 1500 is a five-floor apartment building with six apartments (subscriber premises 190) per floor for a total of thirty subscriber premises 190, each of which is served by a corresponding subscriber service drop 163C-a1 through 163C-e6 (collectively, subscriber service drop cables 163C). Those of skill in the art will readily appreciate that a multi-occupant structure may have more or fewer stories, more or fewer subscriber premises, and/or more or fewer subscriber service drop cables.

In particular, an optical fiber 163A connects the multi-occupant structure 1500 to the headend of an HFC cable communication system (not shown). If desired, multiple optical fibers 163A may be used to accommodate upstream and downstream communication or to further segment the neighborhood node into multiple logical neighborhood nodes. In other implementations, the connection between the HFC cable communication system and the multi-occupant structure 1500 may be a hardline coaxial cable. In such a case the optical node 164A would be replaced with a distribution amplifier or line extender.

The optical node 164A (or line extender/distribution amp) is typically located in a basement or in a utility closet 1502 of the multi-occupant structure 1500. It may alternatively be located in a lockbox or any other structure within the building that houses utility equipment. The optical node 164A may be powered through the HFC cable communication system or by a local connection to the commercial power grid. The output of the node 164A (or line extender/distribution amplifier) is typically one or more hardline or flexible coaxial cables. The example illustrated in FIG. 15 has a single hardline coaxial output 163B-a from the optical node 164A.

In FIG. 15, upstream and downstream RF signals travel in the apartment building 1500 to and from the optical node 164A via multiple segments of hardline coaxial cable 163B-a through 163B-e (collectively, hardline coaxial cables 163B). This hardline coaxial cable 163B enters a vertical riser or plenum 1507, which comprises a vertical shaft or airway that houses utility connections, hardware, etc. In some cases, the vertical riser 1507 may house multiple hardline coaxial cables. Alternatively, the hardline coaxial cable 163B could be attached to the exterior of the building 1500.

At each floor of the apartment building 1500, a corresponding tap 188a-188e (collectively, taps 188) couples RF signals into and out of the hardline coaxial cable 163B. In some cases multiple taps may be required depending on the number of individual dwellings on each floor. For instance, the first hardline coaxial cable 163B-a enters the input to the tap 188a on the first floor of the five-floor building 1500. The output port of the tap 188a is connected to another hardline coaxial cable 163B-b that connects to the input port of the tap 188b on the next floor, and so on. The taps 188 may be located at respective access points (e.g., trapdoors) to the vertical riser 1507 or in individual lockboxes. These lockboxes may be located on the exterior of the building 1500, particularly in cases when the hardline coaxial cable 163B is located on the exterior of the multi-occupant structure 1500.

The taps 188 are connected to the respective subscriber premises 190 by respective subscriber service drop cables 163C. These subscriber service drop cables 163C may include flexible coaxial cables (e.g., type RG 59, RG 6, or RG 11 coaxial cables) that are bundled or tied together in horizontal raceways or conduits or attached to a baseboard. Each subscriber service drop 163C is separated from the bundle and coupled to a wiring inside a corresponding subscriber premises 190.

FIG. 15 shows that there is an eight-way tap 1508a-1508e located on each floor of the apartment building 1500. In this example, however, there are only six subscriber service drop cables 163C and subscriber premises 190 per floor of the apartment building 1500. Thus, the number of tap ports exceeds the number of subscriber service drop cables 163C and the number of subscriber premises 190. The unused tap ports may be terminated with 75Ω terminators or left unterminated. This may not necessarily be the case in all examples; in other cases, the number of ports may equal the number of subscriber service drop cables 163C and/or the number of subscriber premises 190.

Thus, from the foregoing examples of multi-occupant structures, it may be readily appreciated that multiple subscriber service drops 163C associated with a given multi-occupant structure may be coupled to the hardline cable plant 180 via one or more distribution taps 188 located within the multi-occupant structure itself (e.g., in a “lockbox” within the multi-occupant structure) or via one or more ground blocks 198 affixed to an exterior wall of the multi-occupant structure. Furthermore, it is common in the context of a given multi-occupant structure for respective cable communication system components to be within about five meters of one other, for example, as in the case of multiple distribution taps within a single lockbox, multiple subscriber service drop cables connected to a single distribution tap (or to respective taps within a same lockbox), multiple subscriber service drop cables connected to corresponding ground blocks located in close proximity to one another, and/or subscriber service drop cables and/or other coaxial cables that are bundled together (e.g., with ties) or otherwise disposed proximate to one another (e.g., in a single conduit or “raceway” within the multi-occupant structure).

It should also be appreciated that although a multi-occupant structure may include multiple subscriber modems, multiple collocated subscriber drops, and/or other collocated subscriber service equipment, all occupants of the multi-occupant structure need not be subscribers to the services provided by the cable communication system 160. For instance, consider the case of an apartment building or condominium complex that has been “pre-wired” to connect to a cable communication system 160. Even though there may be a dedicated subscriber service drop 163C for each unit in the apartment building or condominium complex, not every subscriber service drop 163C may be active—one may be inactive because the corresponding unit is unoccupied, another may be inactive because the subscriber in the corresponding unit has disconnected cable service, a third may be inactive due to a faulty connection or piece of equipment, and so on. Nevertheless, the apartment building or condominium complex may still have dedicated subscriber service drop cables 163C for providing service to each unit, multiple ones of which cables may be collocated at some point.

Identifying Sources of Ingress in Collocated Cable Communication System Components

In view of the foregoing, various inventive embodiments disclosed herein relate generally to ingress detection and mitigation methods and associated apparatus in the context of relatively higher-density subscriber environments that generally involve collocation to some degree of various cable system components, and particularly subscriber-related system components (e.g., subscriber service drop cables and/or other subscriber service equipment).

In some embodiments disclosed herein, Phase 1 methodologies and concepts similar to those described in the '003 patent may be employed in a given node of a cable communication system that contains one or more multi-occupant structures so as to identify possible faults in the hardline cable plant and/or possible faults arising from subscriber service equipment associated with the one or more multi-occupant structures. However, whether or not Phase 1 methodologies and concepts are employed as disclosed in the '003 patent, various inventive embodiments according to the present disclosure more specifically relate to homing-in on, verifying, and remediating subscriber-related faults giving rise to ingress, and have particular efficacy in the context of relatively higher-density subscriber environments that include multi-occupant structures (and, in many instances, collocated subscriber service drop cables).

With the foregoing in mind, in one embodiment of an ingress mitigation method according to the present invention, during a first phase of activity (“Phase 1”) a mobile broadcast apparatus equipped with a transmitter, such as a Citizens Band (CB) radio, is directed (e.g., carried/transported by a technician on foot or situated in a motorized or non-motorized vehicle) along a path proximate to the RF hardline cable plant that serves one or more multi-occupant structures in a given node of a cable communication system. As the mobile broadcast apparatus is directed along the path, the transmitter emits one or more test signals having one or more frequencies (spectral components) within the upstream path bandwidth at a plurality of locations distributed along the path. Also as the mobile broadcast apparatus is directed along the path, geographic information corresponding to respective positions of the mobile broadcast apparatus along the path is electronically recorded (e.g., via a navigational device such as a GPS apparatus, or a “smart” phone configured with navigational functionality) so as to generate a first record of the geographic information (e.g., as a function of time).

At the same time, via an analyzer (e.g., a spectrum analyzer or a tuned receiver) at the headend of the cable communication system (or otherwise coupled to the hardline cable plant of the node), a plurality of signal amplitudes at the test signal frequency/frequencies are recorded so as to generate a second record. This plurality of signal amplitudes represent a strength of one or more received upstream test signals as a function of time, based on the test signal(s) broadcast from the mobile broadcast apparatus as the mobile broadcast apparatus traverses the path, and test signal ingress of the test signal(s) into one or more faults in the hardline cable plant and/or subscriber related equipment (e.g., distribution taps, subscriber service drops, ground block connections, subscriber premises equipment) associated with the one or more multi-occupant structures. While the mobile broadcast apparatus generally may tend to be closer to the hardline plant as the path is traversed, in higher density subscriber environments one or more multiple-occupant structures often are in sufficient proximity to the path traversed along the hardline plant such that the test signal(s) similarly may enter into one or more faults in the subscriber related equipment associated with the one or more multi-occupant structures.

In this regard, one of the goals of the Phase 1 activity in the context of the relatively higher-density subscriber environment is to identify one or more “suspect taps” associated with a multi-occupant structure that may be giving rise to ingress (e.g., based on an appreciable signal amplitude observed at the headend in response to the one or more test signals being broadcast in proximity to the suspect tap(s)). The use of various node mapping techniques (e.g., heat maps) as described in the '003 patent may significantly facilitate the identification not only of possible faults in the hardline plant, but also one or more such suspect taps. In any event, a particular focus in the first instance on identifying one or more suspect taps associated with a multi-occupant structure arises from the notion that such taps generally are coupled to multiple subscriber service drops that provide subscription service to multiple subscribers in the multi-occupant structure (and that such cables likely are collocated at some point; e.g., see FIG. 11A). Accordingly, while initially discerning faults in respective connectors and collocated cables associated with the multi-occupant structure may be challenging in some circumstances, identifying a common suspect tap to which such collocated cables are connected is an important step toward identifying and addressing particular faults associated with the multi-occupant structure.

Once a suspect tap has been preliminarily identified (e.g., through Phase 1 activity as described in the '003 patent), in some inventive embodiments according to the present disclosure the suspect tap may be more specifically verified as part of Phase 2 activity. More specifically, as an optional first step in Phase 2, a technician (or other service provider) may broadcast, in proximity to the suspect tap, a relatively low-power (e.g., 4 W or less) radio-frequency signal with at least one spectral component in the upstream path bandwidth, while measuring the power in the upstream path bandwidth received at the headend (in a manner similar to that described above in connection with Phase 1). If the headend measurement indicates that the suspect tap is unlikely to be a source of ingress, then the technician may conclude that the tap under inspection is not in fact suspect (and, in turn, the technician may proceed with Phase 2 inspection of other suspect cable communication system equipment). However, if the headend measurement indicates that the suspect tap (or one or more components coupled to the suspect tap) is likely to be admitting ingress, then the technician may proceed to investigate the suspect tap more thoroughly with additional Phase 2 activity.

In some embodiments relating to Phase 2 activity, the technician disconnects an input or upstream port of the suspect tap from the hardline cable plant (e.g., see FIG. 11C, input/upstream port 302) and connects it to a spectrum analyzer, sweep meter, or other device (e.g., a portable or handheld device employed by the technician) suitable for measuring energy in the upstream path bandwidth of the cable communication system. Because the spectrum analyzer or other measurement device is connected to the suspect tap's upstream port, it measures power in the upstream path bandwidth that would propagate towards the headend if the suspect tap were connected to the hardline cable plant. To determine whether or not the suspect tap is a source of appreciable ingress, the technician may use a radio-frequency transmitter to broadcast radiation, within about 2 meters of the suspect tap, with at least one spectral component in the upstream path bandwidth. For instance, the technician may broadcast a tone with a Citizens Band (CB) radio positioned near the suspect tap. While the radio-frequency transmitter broadcasts this signal (referred to herein as a “Phase 2 test signal”), the technician measures power and/or energy in at least a portion of the upstream path bandwidth with the spectrum analyzer, sweep meter, or other device coupled to the suspect tap, including any power or energy at a frequency corresponding to the Phase 2 test signal. The measured power, including power at the broadcast frequency corresponding to the Phase 2 test signal, may then be used to identify a presence or absence of ingress associated with the suspect tap, e.g., appreciable power measured at the broadcast frequency, and/or other frequencies in the upstream path bandwidth, indicate a possible fault giving rise to ingress.

In various embodiments, if during Phase 2 activity the power measurement by the spectrum analyzer or other measurement device at the suspect tap indicates the presence of ingress, then the technician may inspect or evaluate the connectors that couple the suspect tap to the subscriber service drop cables (e.g., see FIGS. 11A and 11B). If this inspection reveals any broken components or loose connections between the suspect tap and the subscriber service drop cables, the technician may replace or disconnect the broken components and tighten the loose connections while observing the power/energy measurement for a corresponding reduction in ingress. If replacing or disconnecting the broken components and tightening the loose connections does not mitigate ingress sufficiently as indicated by the measurement at the suspect tap, or if there are no broken components or loose connections, then the technician may proceed to determine whether or not any of the subscriber service drop cables or other components coupled to the suspect tap are admitting ingress into the cable communication system.

The technician may determine which subscriber service drop cables, if any, admit ingress into the cable communication system by disconnecting the subscriber service drop cables from the suspect tap in a sequential fashion while measuring the power in the upstream path bandwidth via the spectrum analyzer or other measurement device coupled to the input/upstream port of the suspect tap. For instance, with reference to FIG. 11A, the technician may disconnect a first subscriber service drop 163C-a from the suspect tap while measuring the power in the upstream path bandwidth (via the spectrum analyzer or measurement device coupled to the connector 1702 that in turn couples internally to the input/upstream port 302 of the suspect tap). If the power measurement changes (e.g., to show a reduction in power at the frequency of the Phase 2 test signal, and/or a reduction in at least a portion of the power profile or “spectral signature” in the upstream path bandwidth), then the technician may determine that the first subscriber service drop admits at least a portion of the ingress observed at the suspect tap (and ultimately at the headend when the suspect tap is connected to the hardline plant). The technician may then attempt to determine the location of one or more particular faults that admit the ingress (e.g., using time-domain reflectrometry, as discussed in greater detail below), and to assess the possibility of rectifying the fault.

In some embodiments, depending on the nature of the fault and the severity of the ingress associated with first subscriber service drop (e.g., level of power measured by the spectrum analyzer or other measurement device), the technician may mitigate the ingress by properly (re-)connecting first subscriber service drop to the suspect tap by installing a high-pass or bandpass filter in series with the suspect tap and the first subscriber service drop (i.e., between the first subscriber service drop and the corresponding port of the suspect tap) to attenuate power flowing from the first subscriber service drop to the suspect tap in the upstream path bandwidth. Alternatively, the technician may leave the first subscriber service drop disconnected from the suspect tap. The technician may then disconnect a second subscriber service drop from the suspect tap (e.g., see FIG. 11A, drop 163C-b) while measuring the power in the upstream path bandwidth (via the spectrum analyzer or other measurement device coupled to the input/upstream port 302 of the suspect tap), locate and assess the fault, mitigate any ingress associated with the second subscriber service drop, and then repeat the foregoing process for all of the subscriber service drops coupled to the suspect tap, until all of the ingress measured at the suspect tap has been mitigated or all of the subscriber service drops have been tested.

In an alternative embodiment relating to Phase 2 activity, the technician initially may disconnect all of the subscriber service drops from the suspect tap, observe the spectral signature in the upstream path bandwidth (via the spectrum analyzer or other measurement device coupled to the input/upstream port of the suspect tap) with all of the drops disconnected, then reconnect the subscriber service drops one at a time in a sequential fashion while observing the spectral signature in the upstream path bandwidth as each drop is reconnected, so as to note any changes in the spectral signature. Prior to reconnecting the respective drops to the suspect tap, the technician may also connect each subscriber service drop in turn directly to a spectrum analyzer, sweep meter, or other device suitable for measuring the power (energy) in the upstream path bandwidth while broadcasting (or continuing to broadcast) a Phase 2 test signal. If one or more particular drops are identified as possibly having one or more faults giving rise to ingress, as noted above the technician may mitigate the ingress associated with a particular subscriber service drop by properly (re-)connecting the subscriber service drop to the suspect tap, installing a high-pass or bandpass filter in series with the suspect tap and the subscriber service drop to attenuate power flowing from the subscriber service drop to the suspect tap in the upstream path bandwidth, or leaving the subscriber service drop disconnected from the suspect tap.

In some embodiments relating to Phase 2 activity, before, during, or after various power measurements at the suspect tap (and/or the headend), the technician may also inspect the suspect tap, any components (including subscriber service drops) connected to the suspect tap, and/or any connectors coupled to the suspect tap. The technician may conduct this inspection by sight, by touch, or by sight and touch. If the inspection reveals damage to the suspect tap, the subscriber service drop cables, or the connectors, the technician may repair, replace, or disconnect the damaged equipment. Similarly, if the inspection reveals that one or more of the subscriber service drops is improperly connected to suspect tap, the technician may properly connect the affected subscriber service drop(s) to the suspect tap or disconnect the affected subscriber service drop(s) from the suspect tap. The technician also may tighten or disconnect any suspected loose connections while monitoring the spectral signature in the upstream path bandwidth at the suspect tap (and/or the headend) for changes in the spectral signature. If power measurements indicate that tightening or disconnecting the suspected loose connections reduces ingress in the upstream path bandwidth, then the technician may proceed to the next suspect tap or suspect subscriber service drop cable.

Another inventive embodiment disclosed herein relates to an addressable faceplate that may be retrofitted onto a conventional a multi-port tap (e.g., see FIGS. 11A, 11B and 11C), or a multi-port tap that is modified to include an addressable faceplate, such that each output port to which a corresponding subscriber service drop (or other coaxial cable) is coupled may be individually controlled (e.g., addressed) to electronically couple and decouple the subscriber service drop from other circuitry/components of the multi-port tap without mechanically decoupling the subscriber service drop from the output port of the tap. Such a modified multi-port tap, or a multi-port tap retrofitted with an addressable faceplate, may be advantageously employed during Phase 2 ingress mitigation activity in connection with multi-occupant structures, as described in connection with other embodiments disclosed herein.

For example, in some embodiments relating to Phase 2 activity, a technician may temporarily replace the faceplate of conventional multi-port tap that is a suspect tap with an addressable faceplate according to one embodiment of the present invention. The addressable faceplate may then be employed to automatically switch each output port of the suspect tap between a connection to a corresponding 75Ω terminator and a connection to a corresponding subscriber service drop so as to facilitate Phase 2 activity according to various embodiments. Upon completion of the Phase 2 activity, the technician may remove the addressable faceplate or leave it installed to facilitate possible future maintenance and Phase 2 activity.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 illustrates various aspects of a conventional cable communication system.

FIG. 2 illustrates various details of a hardline cable plant and an example subscriber premises of the cable communication system shown in FIG. 1.

FIGS. 3A through 3K illustrate various components of the hardline cable plant shown in FIG. 2.

FIG. 4 illustrates various aspects of a headend of the cable communication system shown in FIG. 1.

FIG. 5 illustrates a hardline coaxial cable that connects to several subscriber premises via a tap and partially bundled subscriber service drop cables.

FIG. 6 illustrates subscriber wiring within one of the subscriber premises of FIG. 5.

FIG. 7 illustrates a duplex configuration of multiple subscriber premises that connect to a hardline cable plant via collocated ground blocks and bundled subscriber service drop cables.

FIG. 8 illustrates adjoining subscriber premises (row houses) with subscriber wiring that connects to a hardline cable plant via non-collocated ground blocks and partially bundled subscriber service drop cables.

FIG. 9 illustrates adjoining subscriber premises (row houses) with partially collocated subscriber wiring that connects to a hardline cable plant via collocated ground blocks and collocated subscriber service drop cables.

FIG. 10 illustrates a commercial complex (e.g., a strip mall) with bundled subscriber service drop cables that connect to a hardline coaxial cable via a tap, a ground block, and an 8-way splitter/terminating tap collocated with the ground block.

FIG. 11 illustrates a commercial complex (e.g., a strip mall) with bundled subscriber service drop cables that connect to a hardline coaxial cable via a multi-connection ground block, bundled subscriber service drop cables, and a tap.

FIGS. 11A, 11B, and 11C illustrate an example of an 8-way tap that may be employed in various examples of multi-occupant structures.

FIG. 12 is a plan view of one floor of a multi-dwelling unit (e.g., an apartment building or condominium complex) with individual subscriber premises (e.g., apartments or condominiums) connected to a hardline coaxial cable via a tap in a utility closet or lockbox and bundled subscriber service drop cables in a horizontal raceway.

FIG. 13 is a plan view of one floor of a multi-dwelling unit (e.g., an apartment building or condominium complex) with individual subscriber premises (e.g., apartments or condominiums) connected to a hardline coaxial cable (not shown) via a single subscriber service drop cable, a ground block, a two-way indoor amplifier, and an 8-way splitter in a utility closet or lockbox, and bundled subscriber service drop cables in a horizontal raceway.

FIG. 14 is a plan view of one floor of a multi-dwelling unit (e.g., an apartment building or condominium complex) with individual subscriber premises (e.g., apartments or condominiums) connected to an optical fiber of a cable communications system via an optical node, one or more taps splitters, and bundled subscriber service drop cables in a horizontal raceway.

FIG. 15 is an elevation view of a multi-story, multi-dwelling unit (e.g., an apartment building or condominium complex) with individual subscriber premises (e.g., apartments or condominiums) connected to an optical fiber of a cable communications system via an optical node, one or more taps, and bundled subscriber service drop cables in horizontal and vertical conduits.

FIG. 16 is a flowchart that illustrates a two-phase process for identifying and mitigating ingress associated with collocated cable communication system equipment, according to embodiments of the present invention.

FIG. 17 is a flowchart that illustrates the optional first phase (Phase 1) of the two-phase ingress identification and mitigation process illustrated in FIG. 16, according to embodiments of the present invention.

FIGS. 18A and 18B show aerial images of an urban neighborhood to provide context for a discussion of an example of Phase 1 activity, according to embodiments of the present invention.

FIGS. 19A through 19D illustrate various examples of ingress maps generated pursuant to Phase 1 activity, according to embodiments of the invention.

FIGS. 19E and 19F illustrate facility maps showing node infrastructure in the portion of the urban neighborhood shown in FIGS. 18A and 18B.

FIG. 20 is a flowchart that illustrates the second phase (Phase 2) of the two-phase ingress identification and mitigation process illustrated in FIG. 16, according to embodiments of the present invention.

FIGS. 21A-21D illustrate various examples of spectrum profiles that may be observed during the Phase 2 activity outlined in FIG. 20, according to embodiments of the present invention.

FIG. 22A is a plot of the spectrum of the upstream path bandwidth (5-42 MHz) in a hybrid fiber-coaxial (HFC) cable communication system at a point upstream of an unconnected F connector.

FIG. 22B is a plot of the spectrum of the upstream path bandwidth (5-42 MHz) in an HFC cable communication system at a point upstream of an improperly connected (e.g., insufficiently tightened) pair of F connectors.

FIG. 22C is a plot of the spectrum of the upstream path bandwidth (5-42 MHz) in an HFC cable communication system at a point upstream of a properly connected pair of F connectors.

FIGS. 23A and 23B illustrate examples of an ingress spectrum profile and corresponding time-domain reflectometry (TDR) plot, respectively for a first subscriber service drop cable under evaluation, revealing a significant presence of ingress and a cut cable that does not reach a premises.

FIGS. 23C and 23D illustrate examples of an ingress spectrum profile and corresponding time-domain reflectometry (TDR) plot, respectively for a second subscriber service drop cable under evaluation, revealing a significant presence of ingress and a cable that appears to reach and be coupled to a premises.

FIG. 24 is an exploded view of a tap with a modified tap face plate with addressable F connectors for detecting faults in subscriber service drop cables, according to embodiments of the present invention.

FIG. 25 shows a circuit diagram of the addressable tap face plate of FIG. 24, according to embodiments of the present invention.

FIG. 26 is a flow chart illustrating an alternative process for identifying and mitigating ingress associated with collocated cable communication system equipment at a multi-occupant structure or other site served by a cable communication system using the addressable tap face plate of FIG. 24, according to embodiments of the present invention.

FIG. 27 shows a display suitable for indicating the presence or absence of ingress as measured using the addressable tap face plate of FIG. 24, according to embodiments of the present invention.

### DETAILED DESCRIPTION

Following below are more detailed descriptions of various concepts related to, and embodiments of, inventive methods of identifying and mitigating ingress in and among collocated cable communication system components, and of associated ingress-mitigated cable communication systems with collocated subscriber service drop cables. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

Ingress Mitigation in Collocated Cable Communication System Equipment

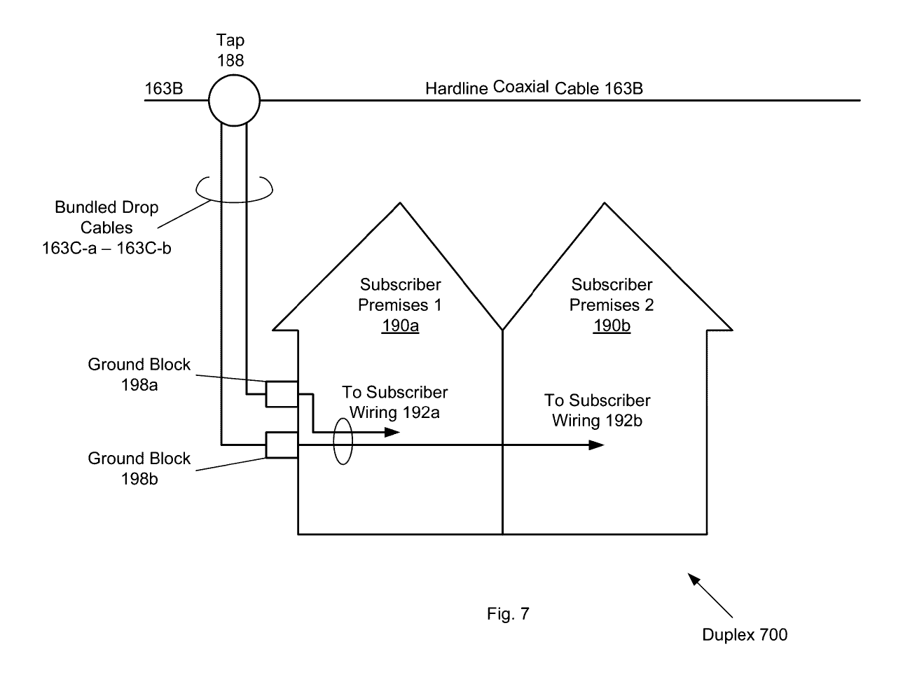

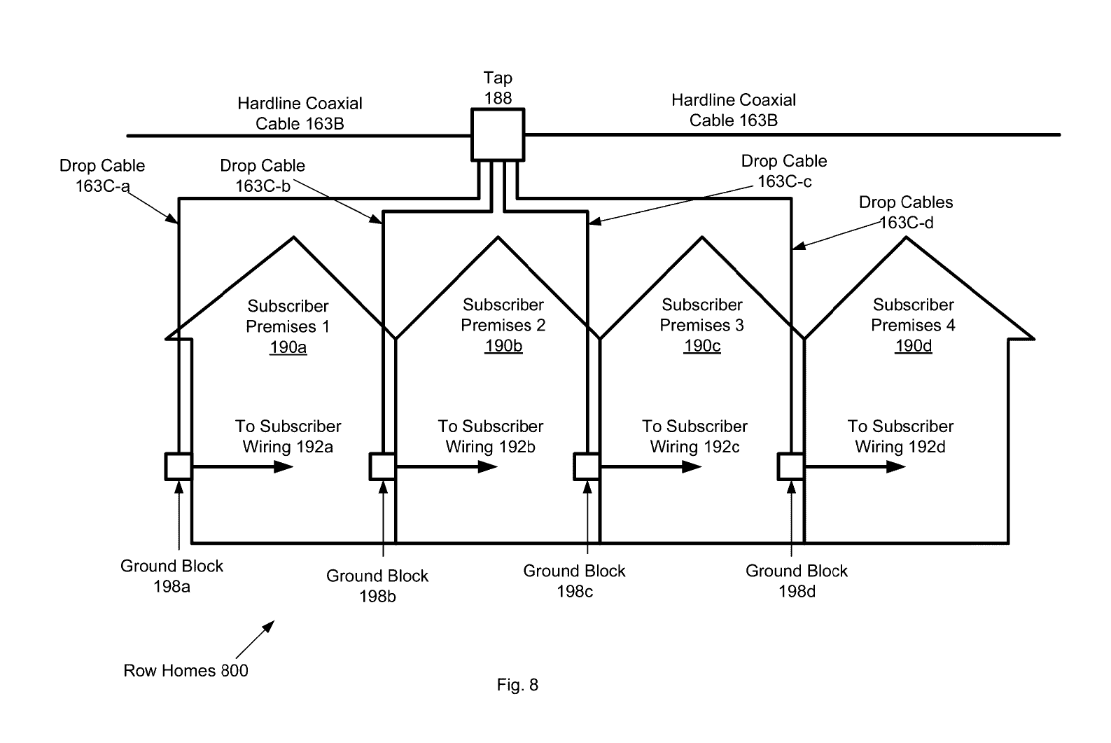

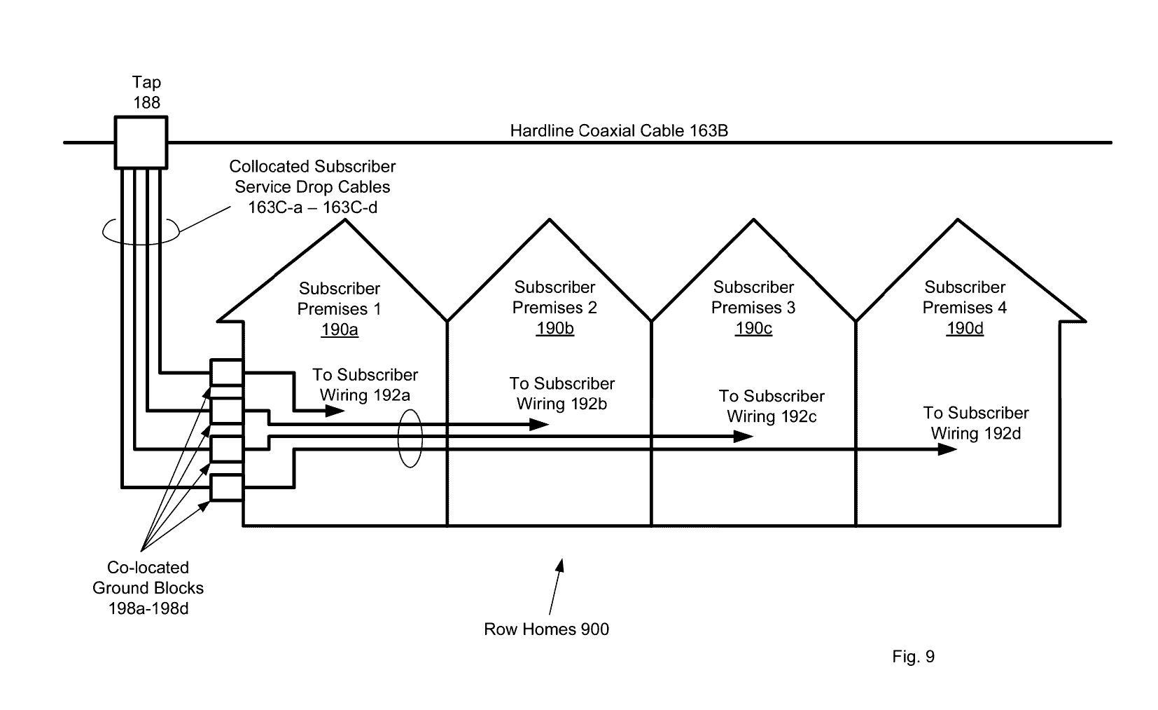

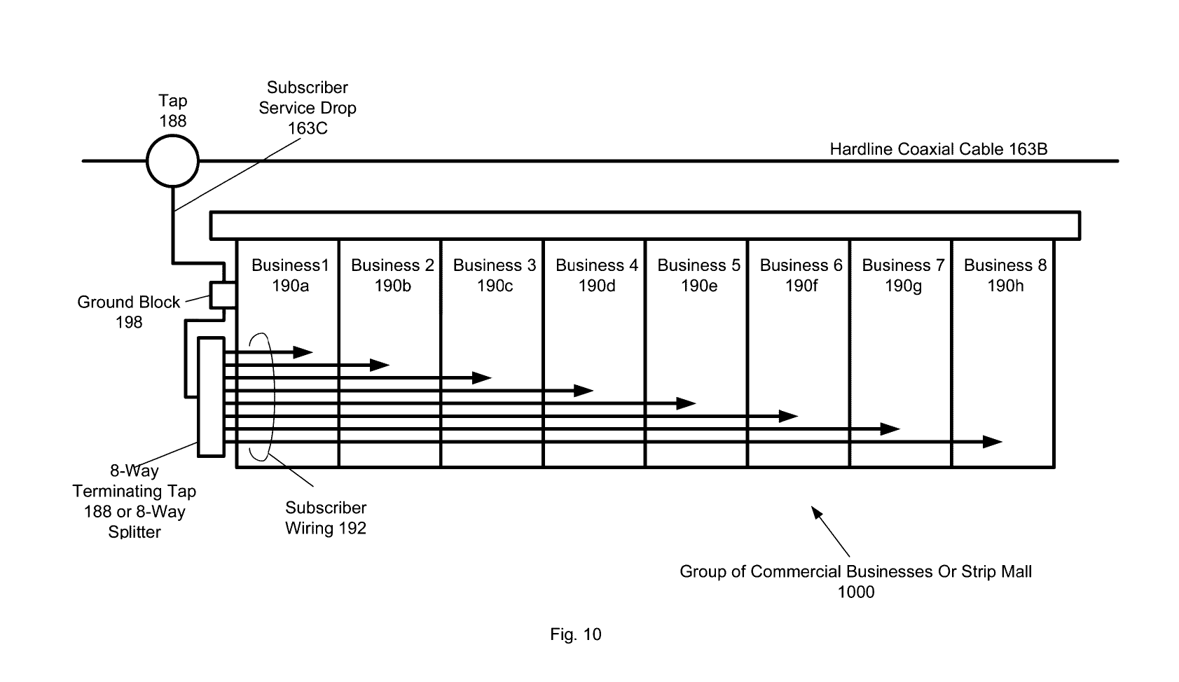

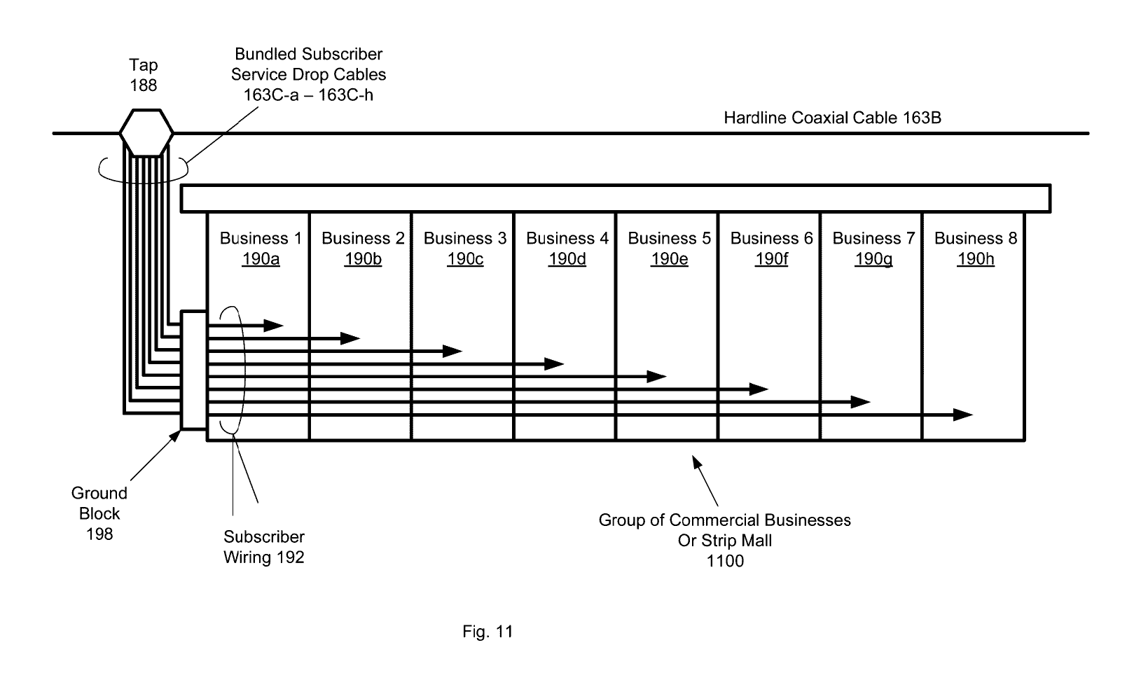

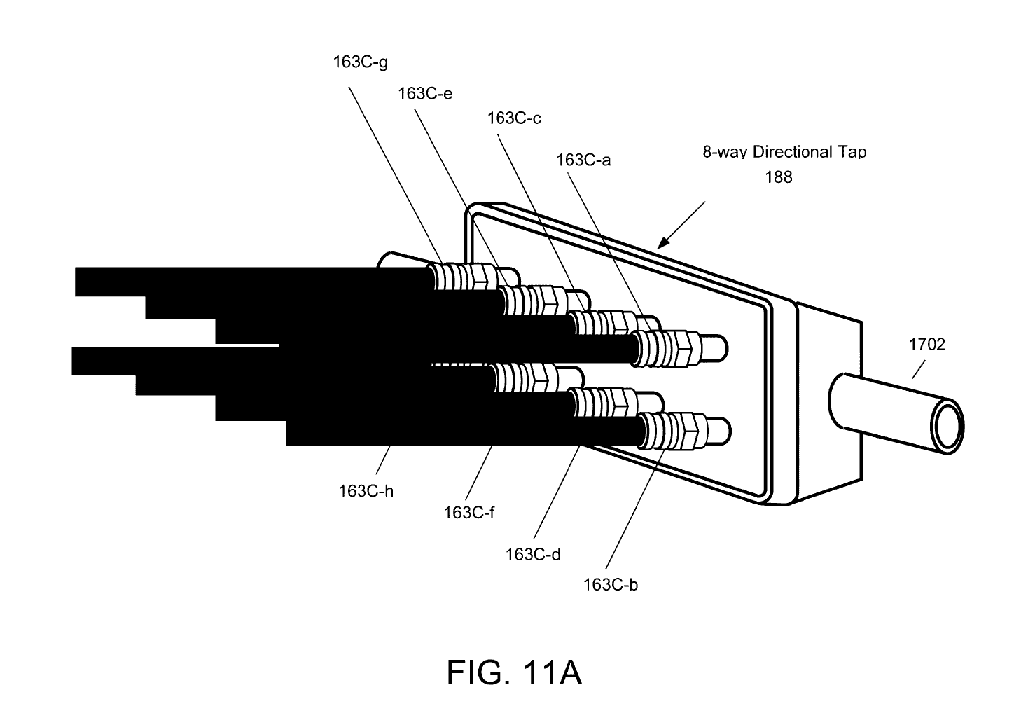

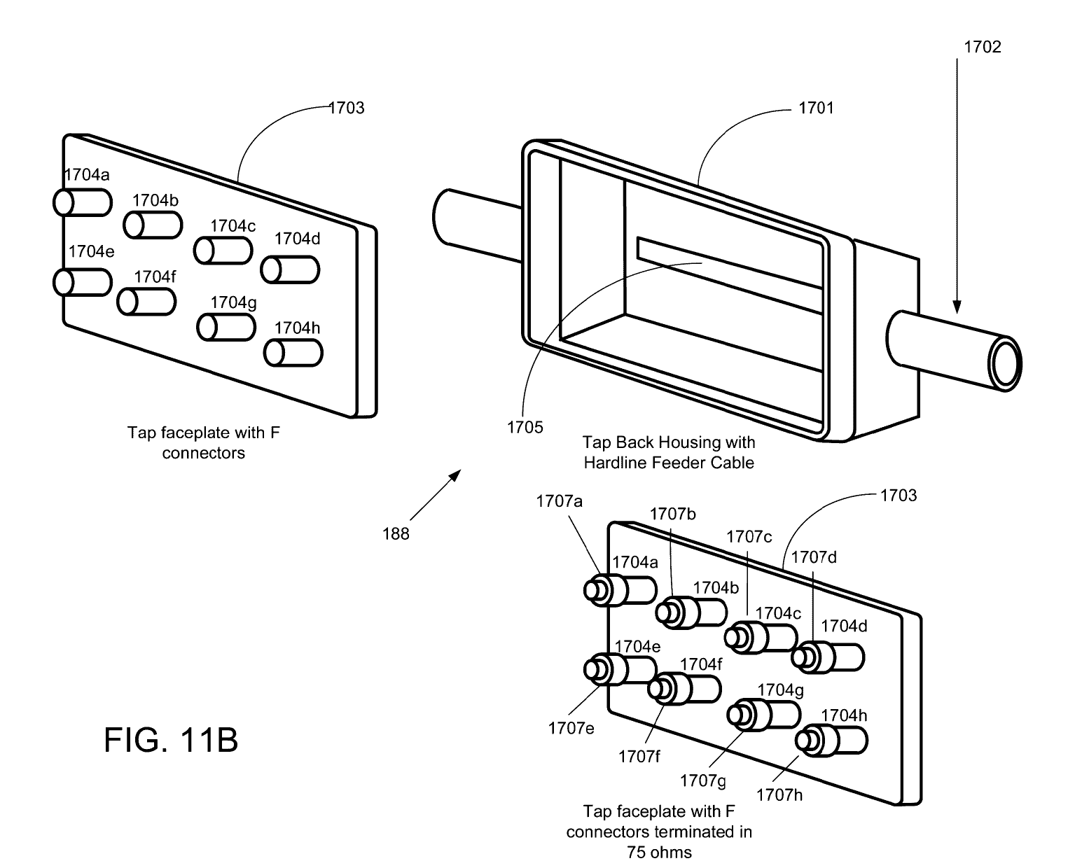

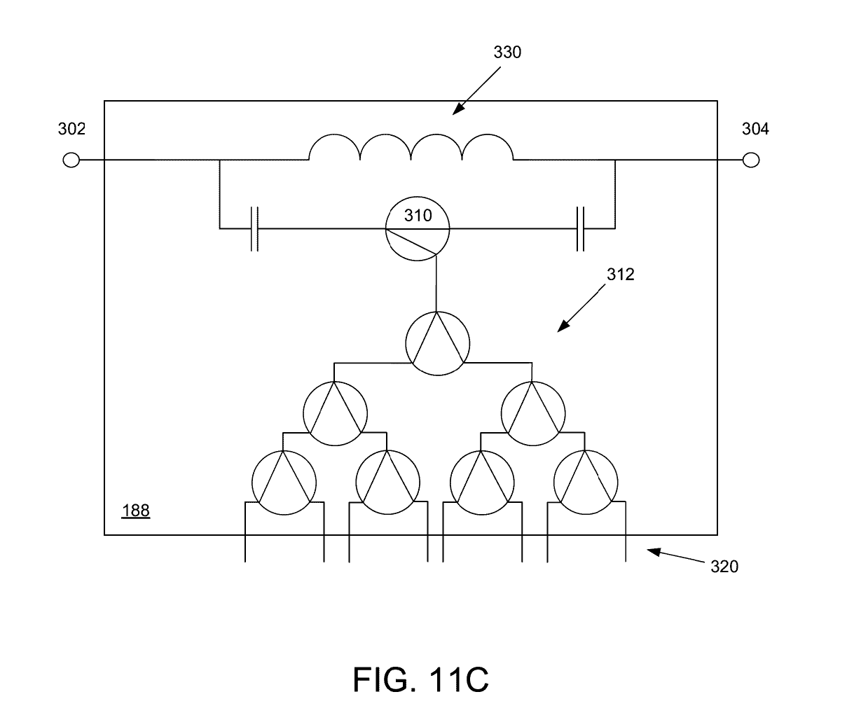

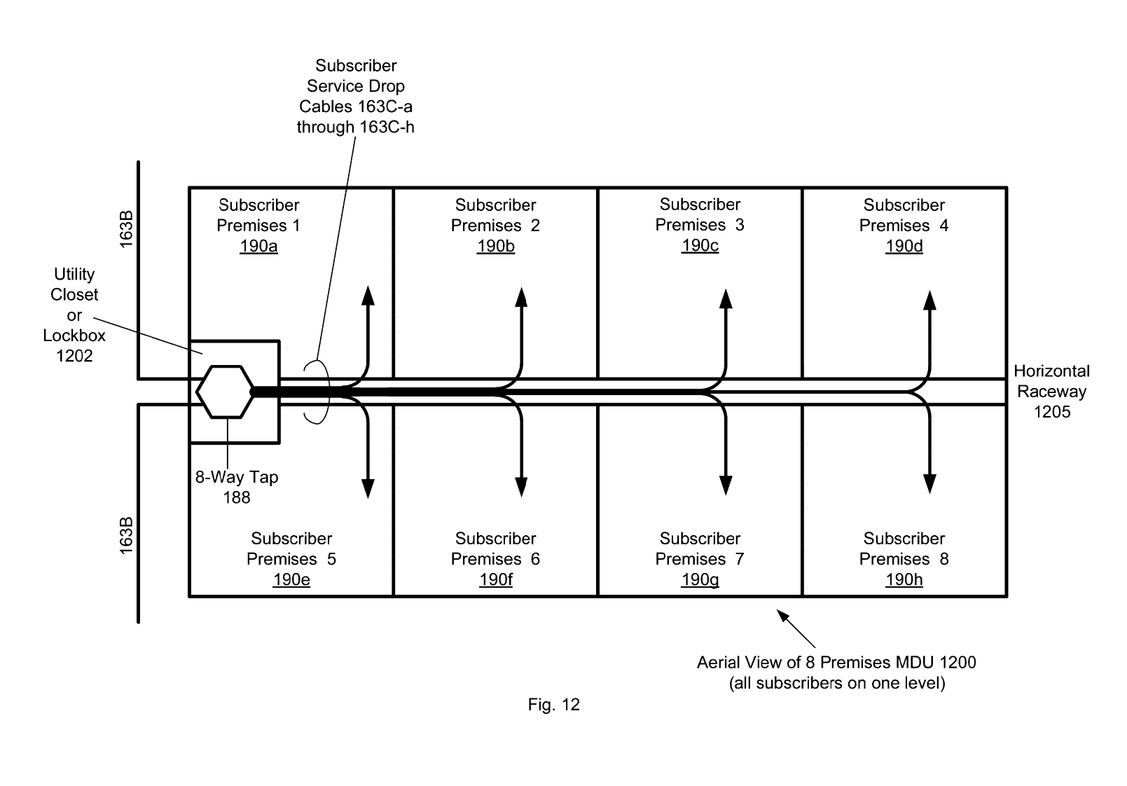

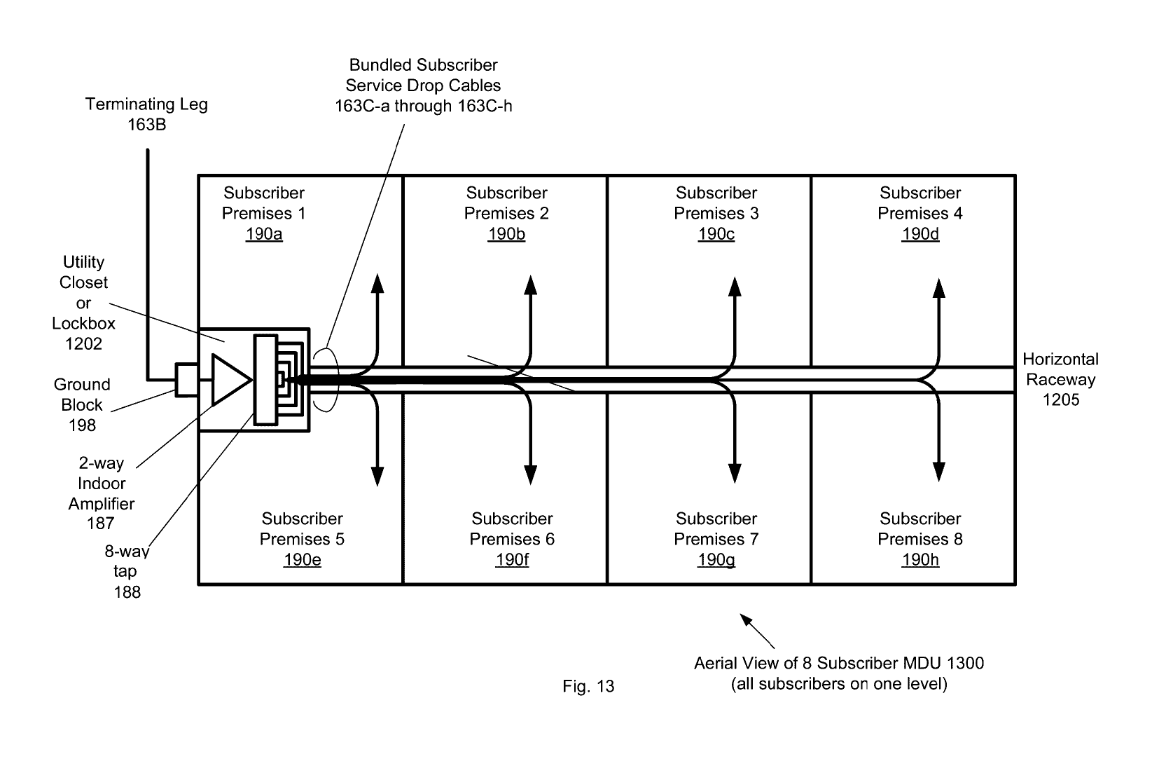

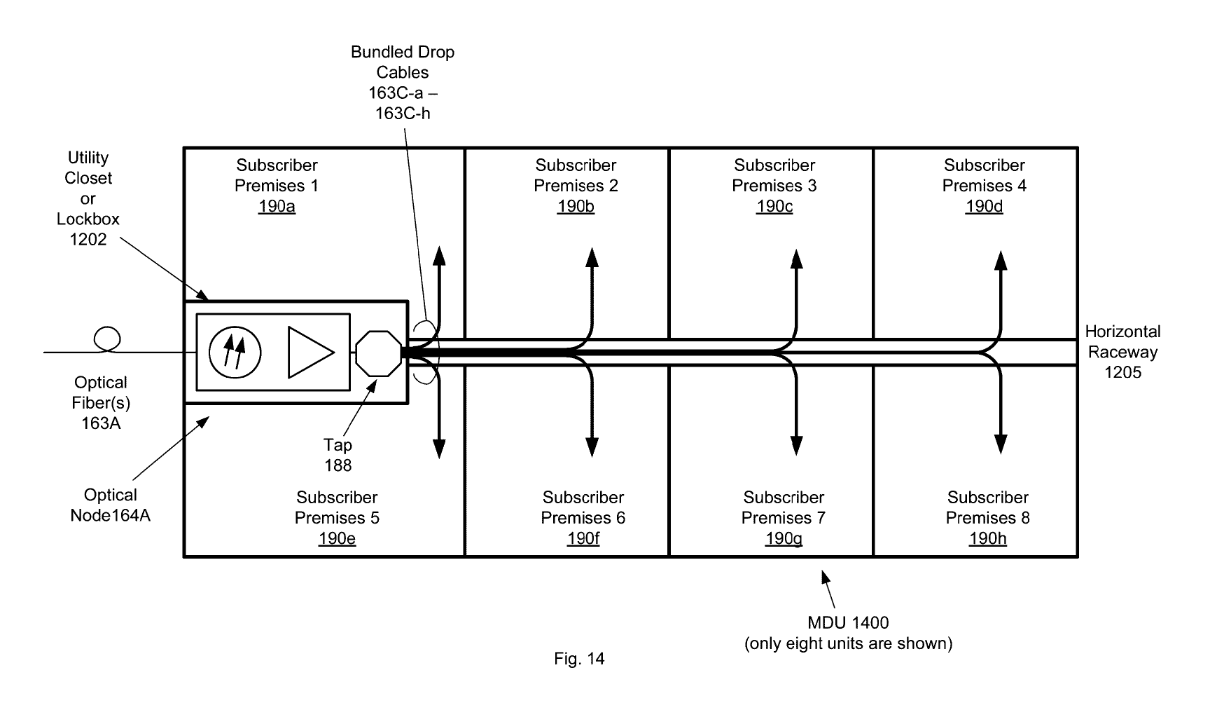

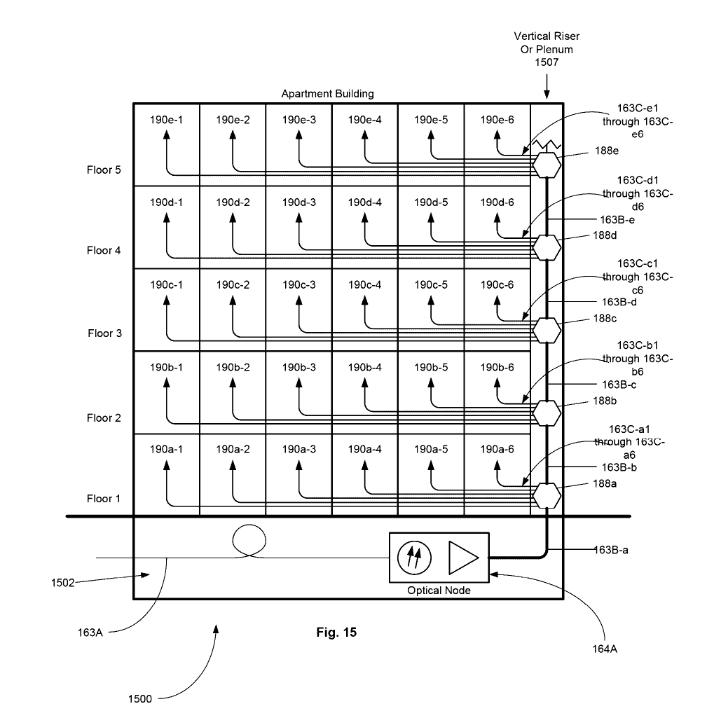

Ingress mitigation involving collocated cable communication system equipment (e.g., in a multi-occupant structure) is often challenging due at least in part to the physical proximity of multiple system components and, in particular, collocated subscriber service drop cables within or associated with a given multi-occupant structure. For example, with reference again to FIGS. 7-15, in different types of multi-occupant structures it is common for multiple coaxial cables, including subscriber service drop cables as well as subscriber wiring (internal to the subscriber premises) to be bundled together with little or no identification of the source or destination of each cable. The Inventors have recognized and appreciated, however, that in multi-occupant structures involving collocated system equipment, one or more multi-port taps coupled to the hardline plant and associated with the multi-occupant structure may serve as a focal point of inquiry in connection with ingress analysis and ultimate remediation/mitigation as warranted. In particular, as discussed in greater detail below, identification of one or more “suspect taps” in a given node of a cable communication system that provides services to one or more multi-occupant structures facilitates particular methods of identifying and remediating ingress arising from one or more faults in collocated system equipment and, particularly, collocated subscriber service drops associated with a multi-occupant structure.

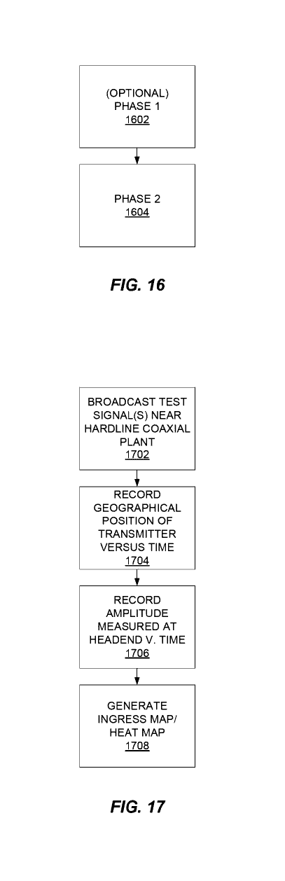

In some exemplary embodiments of inventive ingress mitigation methods according to the present invention, ingress mitigation may be approached in two “phases” of activity as shown in FIG. 16. In particular, in one embodiment, a first phase of activity (“Phase 1”) 1602 is conducted in which various information is collected from the field in a given node of a cable communication system (e.g., proximate to multi-occupant structures and other sites served by collocated cable communication system equipment) to facilitate identification of potential points of ingress and, in particular, one or more suspect taps associated with one or more multi-occupant structures in the node. Thereafter, in some embodiments a second phase of activity (“Phase 2”) 1604 involves more precise identification of suspect taps, collocated subscriber service drop cables coupled to suspect taps, and/or other collocated components associated with ingress-admitting faults, and remediation of subscriber-related faults giving rise to ingress associated with a multi-occupant structure. Phase 1 and Phase 2 may be conducted iteratively (e.g., a first round of Phase 1 activity and a first round of Phase 2 activity, followed by a second round of Phase 1 activity and a second round of Phase 2 activity, and so on) until ingress measured in the upstream path bandwidth of a given node falls below a desired threshold or has a desired spectral signature. Similarly, the individual sub-processes involved in Phases 1 and 2 may be repeated iteratively (e.g., in Phase 2, measure ingress at a particular suspect tap, tighten one or more subscriber drop terminating connectors coupled to the tap, measure the ingress at the tap again, tighten one or more additional subscriber drop terminating connectors, and so on) until the ingress associated with a particular multi-occupant structure reaches a desired value or spectral signature. Also, as indicated in FIG. 16, in other embodiments, Phase 1 may be optional, and suspect taps associated with multi-occupant structures may be alternatively identified for Phase 2 activity.

Ingress Detection and Mapping (“Phase 1”)

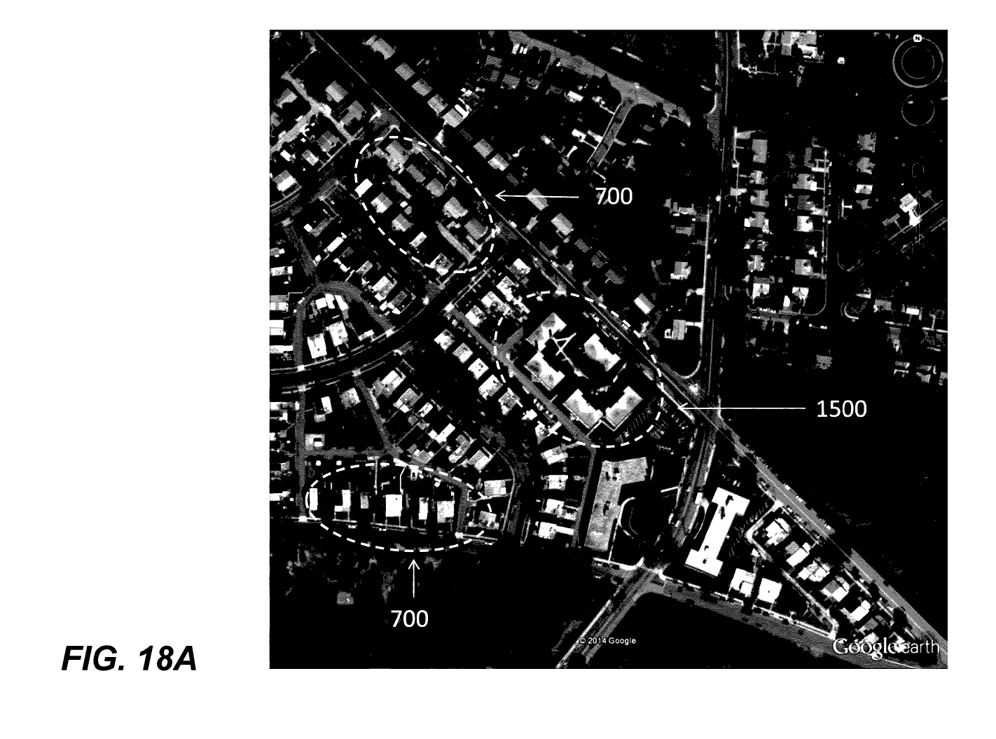

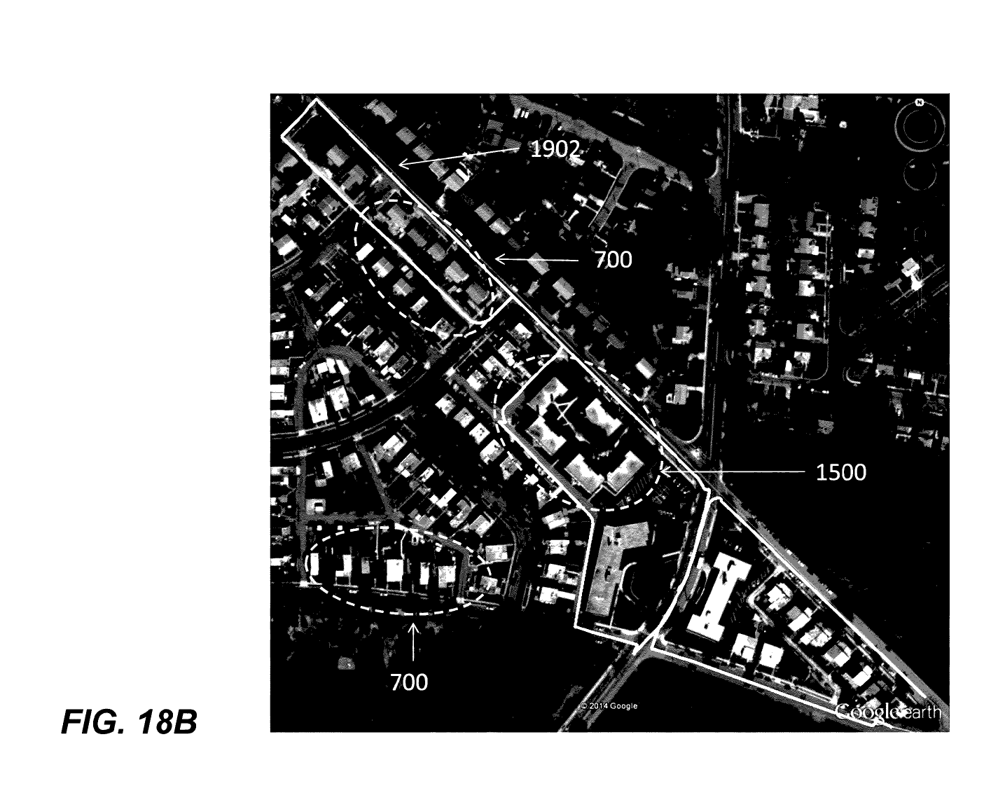

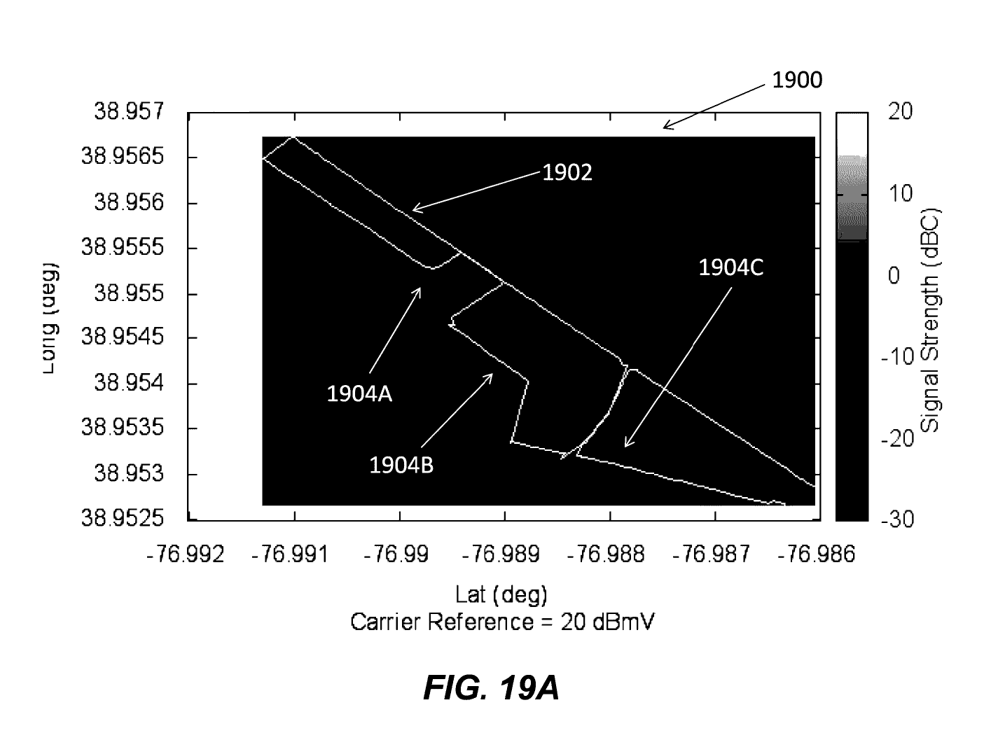

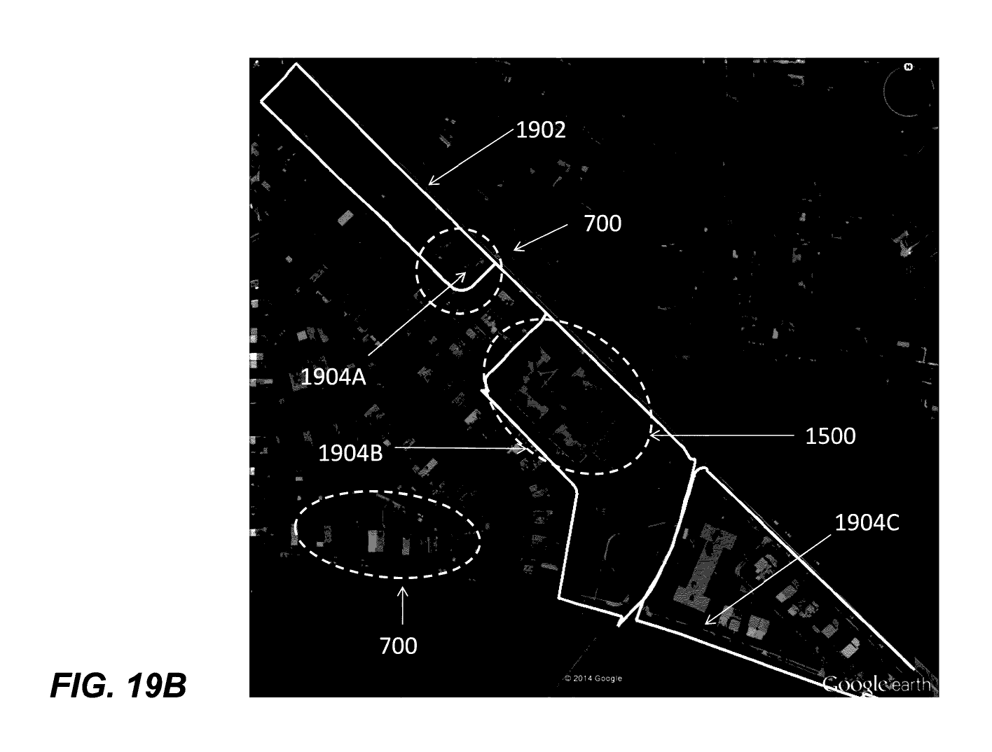

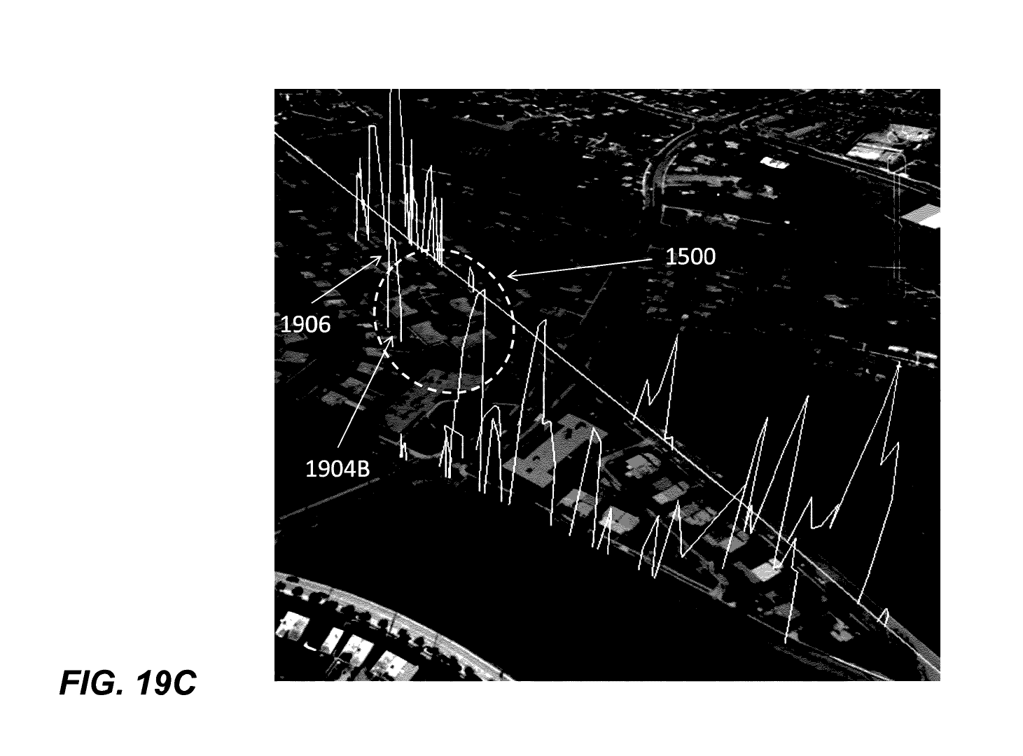

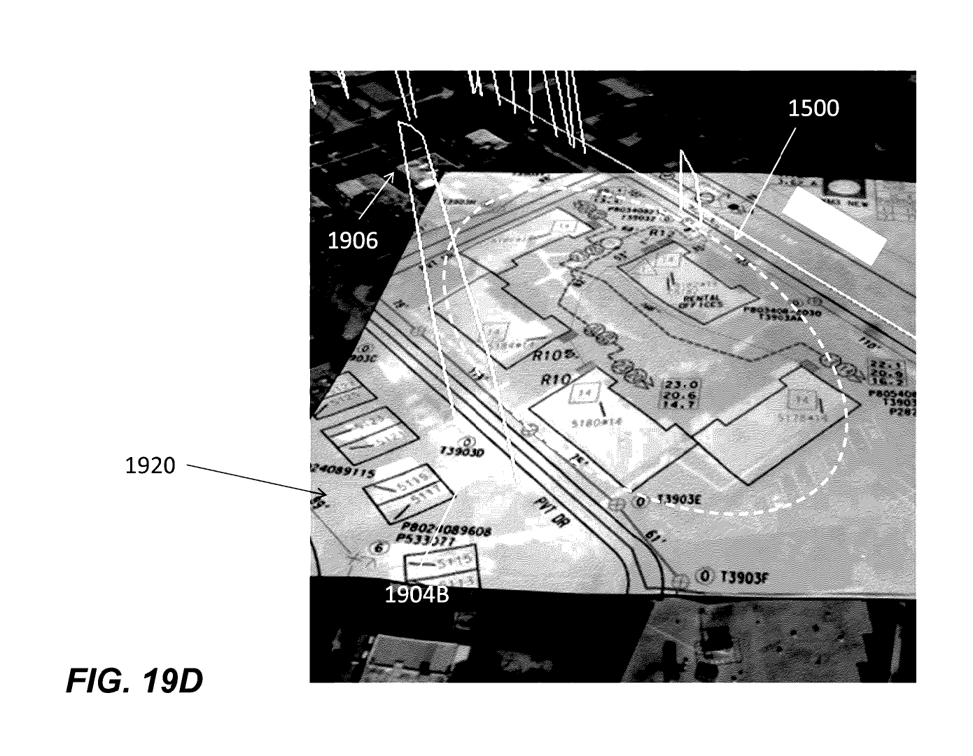

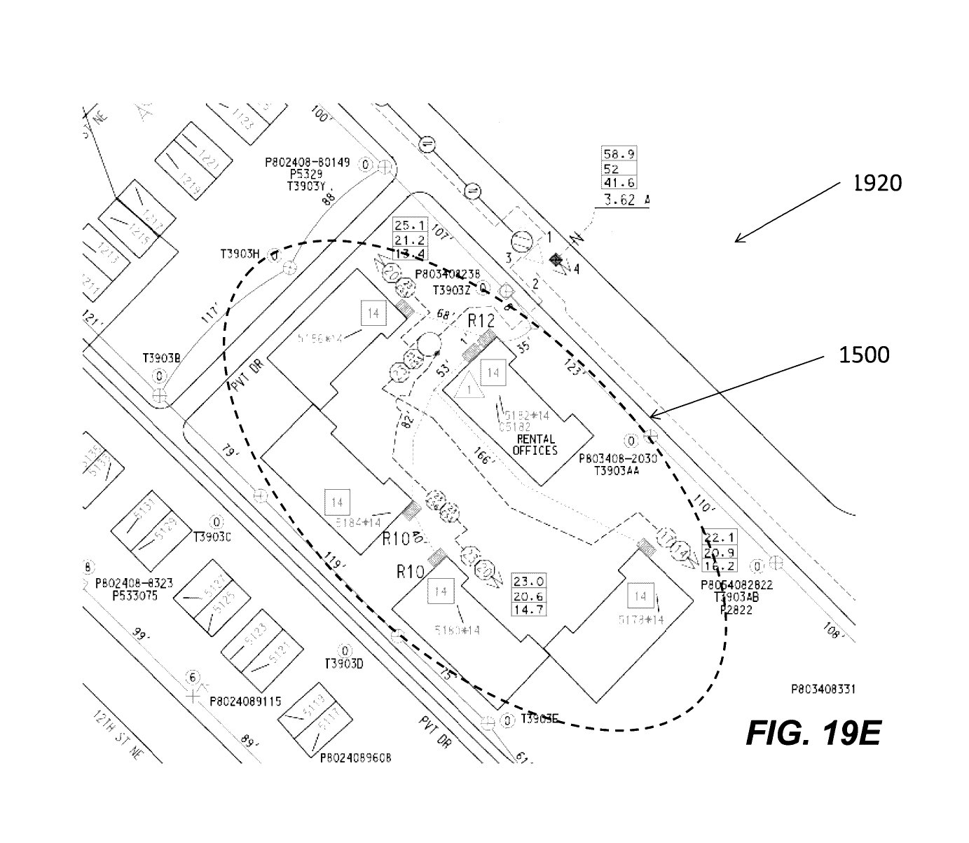

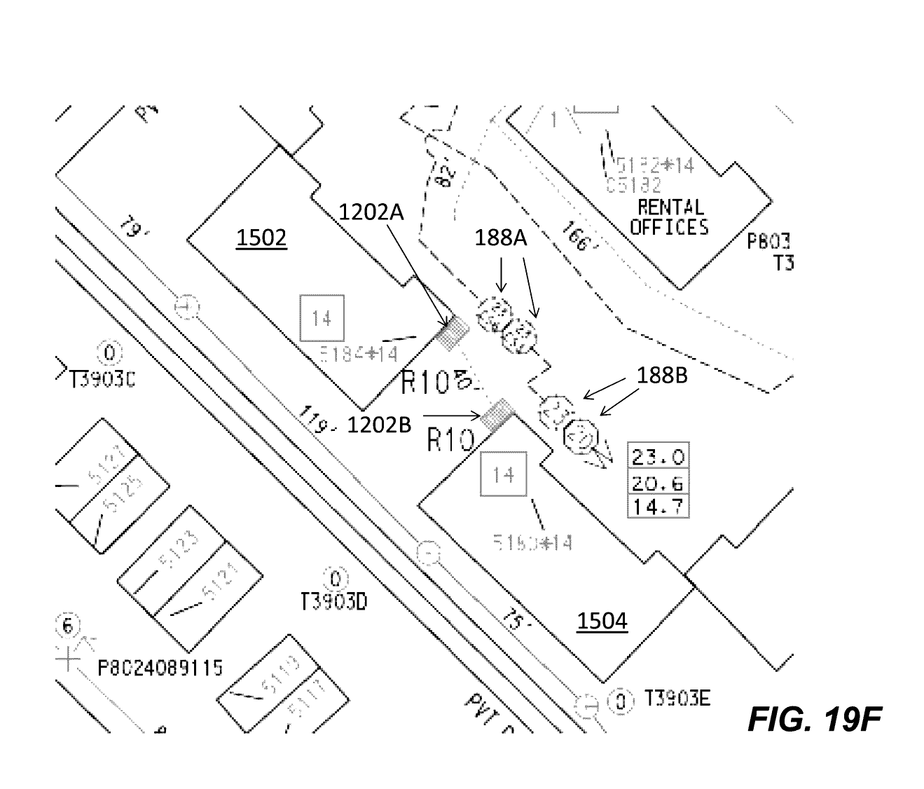

With the foregoing in mind, FIG. 17 illustrates aspects of Phase 1 activity, according to some embodiments, in which a mobile broadcast apparatus equipped with a transmitter, such as a CB radio, is carried by hand, driven, or otherwise directed along a path in an area served by at least a portion of a cable communication system (e.g., at least a portion of a given node) that includes multi-occupant structures or otherwise contains collocated physical components of the cable communication system. FIGS. 18A and B, and FIGS. 19A-19F illustrate the implementation of Phase 1 activity in a particular example of an urban neighborhood so as to facilitate an understanding of the relevant concepts germane to Phase 1 activity.

With reference now to FIG. 17, in step 1702 a mobile broadcast apparatus equipped with a transmitter is directed along a path that traverses, circumnavigates, or intersects an area comprising one or more multi-occupant structures served by the hardline cable plant in a given node of the cable communication system. To provide an illustration of such a path over which the mobile broadcast apparatus may be carried in an urban setting, FIG. 18A is an aerial image of a relatively higher-density subscriber environment (e.g., an urban neighborhood) that includes multiple multi-occupant structures (e.g., duplexes 700, multi-story multi-occupant structures 1500) constituting a portion of a node of a cable communication system. FIG. 18B is a reproduction of FIG. 18A that further illustrates a path 1902 (a representation of which is overlaid on the aerial image as a solid white line that essentially follows the patterns of various streets in the neighborhood), over which the mobile broadcast apparatus equipped with the transmitter is directed during Phase 1 activity. As it is directed along the path, the transmitter of the mobile broadcast apparatus emits a radio-frequency signal, also referred to herein as a “test signal,” with at least one spectral component in the upstream path bandwidth. The mobile broadcast apparatus may emit this test signal continuously or intermittently as it is carried, driven, or otherwise directed along the path 1902 (e.g., along a sidewalk or street). In various embodiments, the test signal may be an unmodulated, continuous-wave signal (a tone), or it may be modulated in amplitude, frequency, and/or phase.

In step 1704 of FIG. 17, as the mobile broadcast apparatus is directed along a path as described above in connection with step 1702 (e.g., the path 1902 shown in FIG. 18B), geographic information corresponding to respective positions of the mobile broadcast apparatus is recorded so as to generate a first record of the geographic information (e.g., as a function of time). This geographic information may be generated electronically via a navigational device, such as a Global Positioning System (GPS) apparatus or a “smart” phone configured with navigational functionality or to derive positional information from local WiFi infrastructure. The geographic information may also be recorded, possibly using the same GPS apparatus or smart phone that generated the geographic information, as a non-transient electronic record in a nonvolatile memory.

In step 1706 of FIG. 17, an analyzer (e.g., a spectrum analyzer, a multi-meter, or a tuned receiver) at the headend of the cable communication system (or otherwise coupled to the hardline cable plant that serves subscriber premises along or near the path) measures a plurality of signal amplitudes at the test signal frequency/frequencies. These signal amplitudes represent a strength of one or more the received upstream test signals as a function of time, based on the test signal(s) broadcast from the mobile broadcast apparatus as the mobile broadcast apparatus travels along the path 1902, and ingress of the test signal(s) into one or more faults in the hardline cable plant and/or one or more multi-occupant structures (or other subscriber premises) coupled to the hardline cable plant and within broadcast range of the mobile broadcast apparatus as it is directed along the path. In one example, with reference again to FIG. 18B, a technician may carry the mobile broadcast apparatus along the path 1902 and past various structures in the neighborhood (such as duplexes 700 and multi-story multi-occupant structures 1500), during which the mobile broadcast apparatus broadcasts a test signal as an unmodulated tone at a frequency of about 27 MHz and a power level of about 2 to 4 W. Portions of this unmodulated tone may enter the cable communication system via faults in the hardline cable plant and/or faults associated with one or more of the multi-occupant structures, and are detected and measured at the headend by the analyzer. The analyzer stores non-transient indications of the measured signal amplitudes as a second record in a nonvolatile memory, which may be integral with or coupled to the analyzer.

In exemplary implementations, the generation of the first record of geographic information in step 1704 does not necessarily depend on the nature of the test signal(s) broadcast in step 1702 and the generation of the second record of the plurality of signal amplitudes in step 1706. That is, the generation of the first record of geographic information corresponding to respective positions of the mobile broadcast apparatus along the path does not rely on the integrity (e.g., strength, broadcast position, potential intermittency, etc.) of the transmitted test signal(s), nor does it rely on reliable reception of the test signal(s) by a spectrum analyzer at the headend of the cable communication system (or coupled elsewhere to the cable communication system).

In step 1708 of FIG. 17, an “ingress map” may be generated based on the first record of geographic information relating to the mobile broadcast apparatus positions and the second record of signal amplitudes representing the strength of received upstream test signals as a function of time. In one exemplary implementation, such an ingress map may include a first graphical representation of one or more geographical aspects of the portion of the node traversed by the path over which the mobile broadcast apparatus is directed, and a second graphical representation, overlaid on the first graphical representation, of the plurality of signal amplitudes so as to illustrate the relative entry points of the test signal (representing faults) and strengths of test signal ingress of the test signal(s) into the hardline cable plant and/or system equipment associated with one or more multi-occupant structures. To this end, the amplitudes measured at the headend and recorded as a function of time are correlated in time to the corresponding record of the mobile broadcast apparatus's position as a function of time so as to provide the second graphical representation.

In various examples, the first graphical representation of an ingress map according to various embodiments may show row houses, multi-family houses, apartment buildings, condominium complexes, office buildings, shopping malls, and other multi-occupant structures. The first graphical representation may also include indications (e.g., on different layers) that show the number of units (subscriber premises) in a particular multi-occupant structure as well as indications of the type of service (e.g., residential internet, telephone, cable television, etc.) received at each subscriber premises. In addition, the second graphical representation of an ingress map according to various embodiments may in some manner provide a representation of an amount/degree of ingress associated with each building depicted in the first graphical representation.

In one example of an ingress map, the first graphical representation may include the path itself over which the mobile broadcast apparatus is directed, and the second graphical representation of the plurality of signal amplitudes may include a “heat map” overlaid on the graphical representation of the path (e.g., in which different signal amplitudes are represented by different shades, contours, or colors) to provide an intuitive visualization of the test signal ingress over the portion of the node traversed by the path. FIG. 19A provides an example of such an ingress map 1900, in which a multi-colored heat map representing the plurality of signal amplitudes is overlaid on the path 1902 shown in the example neighborhood of FIG. 18B. In FIG. 19A, the horizontal and vertical axes of the map represent respective latitude and longitude coordinates, and the path 1902 is plotted on the map based on the first record of geographic information collected in step 1704 of FIG. 17. A color scale along the right side of the ingress map shown in FIG. 19A provides a correspondence between signal strength (from the second record of the plurality of signal strengths collected in step 1706 of FIG. 17) and color (e.g., bright yellow=20 dBC, orange=0 dBC, purple=−10 dBC), based on an indicated test signal broadcast carrier strength of 20 dBmV in this example. Again, as noted above, the amplitudes measured at the headend and recorded as a function of time are correlated to a corresponding record of the mobile broadcast apparatus's position as a function of time to produce the ingress map 1900. As may be observed from the ingress map 1900 shown in FIG. 19A, a number of “hot spots” 1904A, 1904B, and 1904C (shown in reddish-orange coloring corresponding to relatively higher signal amplitudes of the test signal as measured by the analyzer at the headend) indicate probable points of faults in the node infrastructure that permit ingress in the node.

According to various embodiments, a number of permutations of ingress maps based in part on one or more of the heat map shown in FIG. 19A, the aerial image of the neighborhood shown in FIGS. 18A and 18B, one or more node infrastructure maps, and other information collected during Phase 1 activity, may be generated to facilitate identification of faults in the node. For example, FIG. 19B shows the heat map of FIG. 19A overlaid on the neighborhood aerial image of FIG. 18B, so as to illustrate the path 1902 and the various hot spots 1904A, 1904B and 1904C in relation to the building infrastructure of the urban neighborhood. From FIG. 19A, it may be observed that the hot spot 1904A appears to be generally associated with a small cluster of duplexes 700, and the hot spot 1904B appears to be associated with the multi-story multi-occupant structures 1500.

FIG. 19C illustrates a three-dimensional perspective view of the heat map overlaid on the neighborhood aerial image, and including a further overlay of a plot of the actual signal strength measured by the analyzer at the headend (which corresponds to the test signal entering faults in the node infrastructure). From FIG. 19C, it may be observed that the hot spot 1904B corresponding to the multi-occupant structures 1500 is associated with a pronounced peak 1906 in the strength of the signal measured by the analyzer at the headend. FIG. 19D illustrates a zoomed-in portion of the perspective view of FIG. 19C in the vicinity of the multi-occupant structures 1500, including a further overlay of a facilities map 1920 for the node infrastructure so as to illustrate specific node infrastructure in the vicinity of the hot spot 1904B corresponding to the signal peak 1906. FIG. 19E shows a portion of the facilities map 1920 itself to provide a clearer view of the infrastructure in the general area of the multi-occupant structures 1500 (various features of the facilities map 1920 are according to the standards given in American National Standard/Society of Cable Telecommunications Engineers (ANSI/SCTE) 87-1 2008, which is hereby incorporated by reference in its entirety). FIG. 19F shows a zoomed-in portion of the facilities map 1920 that focuses particularly on buildings 1502 and 1504 of the multi-occupant structures 1500. Each of buildings 1502 and 1504 are indicated as having 14 subscribers; building 1502 has a lockbox 1202A that contains two eight-port taps 188A (which would provide connections for up to 16 subscribers in the building, but only 14 of these connections are being used for subscribers), and building 1504 has a lockbox 1202B that contains another two eight-port taps 188B (again, of which only 14 connections are being used for subscribers in that building).

With reference again to FIG. 19D, the Phase 1 activity to generate an ingress map, when taken together with the facilities map 1920, suggests that a possible source of one or more faults associated with the hot spot 1904B (and corresponding to peak 1906) may be one or more of the taps in the lockboxes 1202A and 1202B of buildings 1502 and 1504 of the multi-occupant structures 1500 (i.e., one or more of the taps in the groups 188A and 188B may be a “suspect tap”). Thus, it may be appreciated that ingress maps according to various embodiments, generated via Phase 1 activity, may provide useful indications as to possible sources of ingress in a relatively higher-density subscriber environment that includes multi-occupant structures. In some circumstances, the appearance of the peak 1906 near the buildings 1502 and 1504 may prompt further Phase 1 investigation, on a finer scale, of the individual buildings to determine which buildings, if any, may be associated with ingress, and to more particularly identify one or more suspect taps in one or more of the buildings in the general area of the multi-occupant structures 1500 shown in FIGS. 19D and 19E.

Additional Phase 1 activity may also be conducted after Phase 2 activity, e.g., to verify the effectiveness of any ingress mitigation performed during Phase 2. This further Phase 1 investigation may be conducted on foot to provide a geographic scale and/or a temporal scale fine enough to resolve which components in the hardline cable plant and/or components in multi-occupant structures are most likely to contribute to ingress measured at the headend. The data generated by any additional Phase 1 activity can be used to augment, supplement, or replace the information acquired during the initial Phase 1 activity. For example, the data generated by the additional Phase 1 activity can be rendered as an insert, inset, or detailed region of an ingress map or heat map.

For more information on “Phase 1” activity, see, e.g., U.S. Pat. No. 8,543,003, entitled “INGRESS-MITIGATED CABLE COMMUNICATION SYSTEMS AND METHODS HAVING INCREASED UPSTREAM CAPACITY FOR SUPPORTING VOICE AND/OR DATA SERVICES” and issued on Sep. 24, 2013, which is hereby incorporated herein by reference in its entirety.

Local Ingress Identification and Remediation (“Phase 2”)

As discussed above, Phase 1 generally provides helpful and useful information about collocated cable communication system equipment that contributes to ingress, and in many instances provides a preliminary indication of possible faults that admit ingress. In some situations, however, Phase 1 activity and the ingress map(s) associated with same may not necessarily reveal in all cases precisely which piece or pieces of equipment (e.g., suspect taps), or which connections between pieces of equipment, specifically admit ingress. In some embodiments, to better determine which piece/pieces of equipment and/or which connections admit ingress, one or more technicians may conduct a systematic further evaluation of the equipment at the multi-occupant structures (and/or other possible) ingress sites with collocated cable communication system equipment) that are initially identified in Phase 1. Alternatively, if Phase 1 has not been conducted, the technician(s) may conduct a systematic evaluation of the equipment at every site or at particular sites (e.g., suspect sites) with collocated cable communication system equipment. In any event, the systematic and specific evaluation of collocated cable communication system equipment to identify faults giving rise to ingress comprises what is referred to herein as “Phase 2” activity.

In one example, an ingress map or heat map, such as those shown in FIGS. 19A through 19D, may be used to identify and locate a multi-occupant structure or other site of collocated cable communication system equipment that is likely to be contributing to measurable ingress (as discussed above in the previous section). Based on this identification and location, the multi-occupant structure may be designated for Phase 2 activity. Alternatively, a multi-occupant structure or other site of collocated cable communication system components (e.g., in the case of a node that serves a single structure or subscriber premises) may be otherwise designated for Phase 2 activity.

Due to the proximity of at least some physical components of the cable communication system in a multi-occupant structure, and specifically the collocation of tap(s) and subscriber service drop cable(s), in some embodiments the “Phase 2” process may involve disconnecting one or more suspect taps or splitters thought to be associated with ingress from the hardline cable plant for a given node, and analyzing signals at the disconnected upstream port of the tap (to look for signal artifacts representative of ingress, as discussed further below). In some embodiments, Phase 2 may also involve disconnecting subscriber service drop cables thought to be associated with ingress from a particular suspect tap or splitter (e.g., one at a time in a sequential fashion), and analyzing signals at the upstream male F-connector of a disconnected drop to look for signal artifacts representative of ingress.

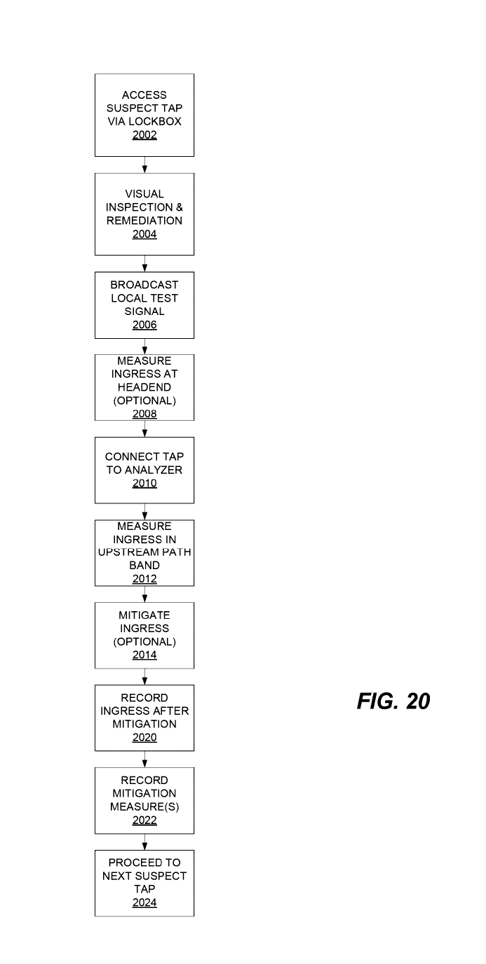

FIG. 20 is flowchart that illustrates a process for conducting Phase 2 activity at a designated multi-occupant structure or other site of collocated cable communication system equipment designated for Phase 2 activity, according to one inventive embodiment. Once the technician has arrived at the Phase 2 activity site (e.g., a multi-occupant structure), he or she locates and accesses the suspect tap or other suspect collocated cable communications equipment (step 2002). In some systems, this suspect equipment may include one or more taps or splitters inside a lockbox or other secure housing, which may be located inside the multi-occupant structure (e.g., in a basement or utility closet) or outside the multi-occupant structure (e.g., on or near one of the multi-occupant structure's exterior walls) (e.g., refer again to the lockboxes 1202A and 1202B of the respective multi-occupant structures 1502 and 1504 shown in FIG. 19F). In some embodiments, as discussed above, one or more suspect taps or other suspect collocated cable communications equipment may have been previously identified pursuant to Phase 1 activity and ingress maps, as discussed above.

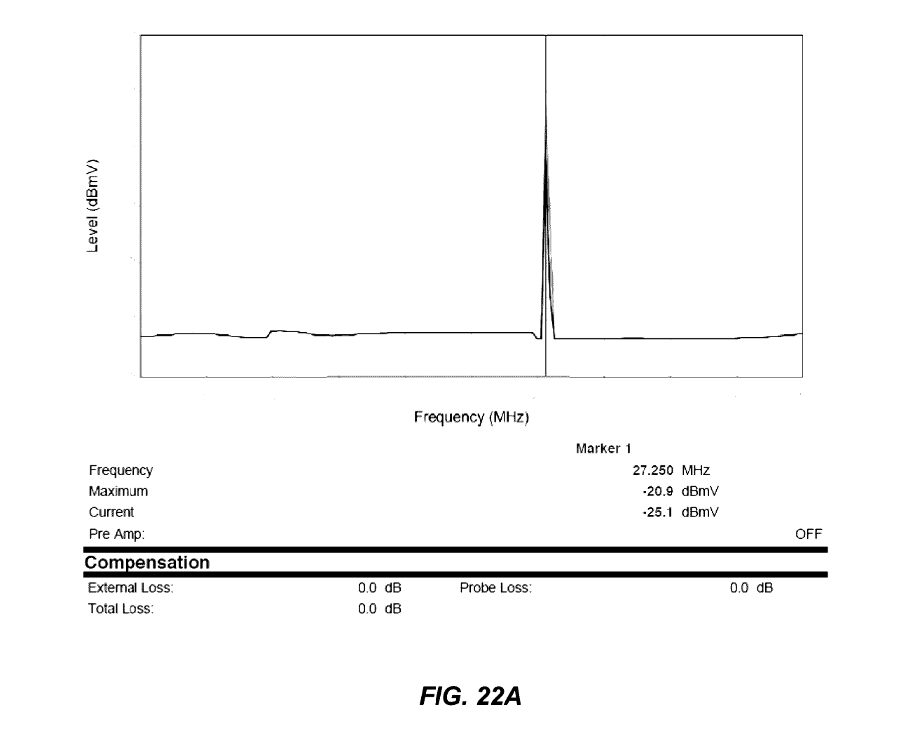

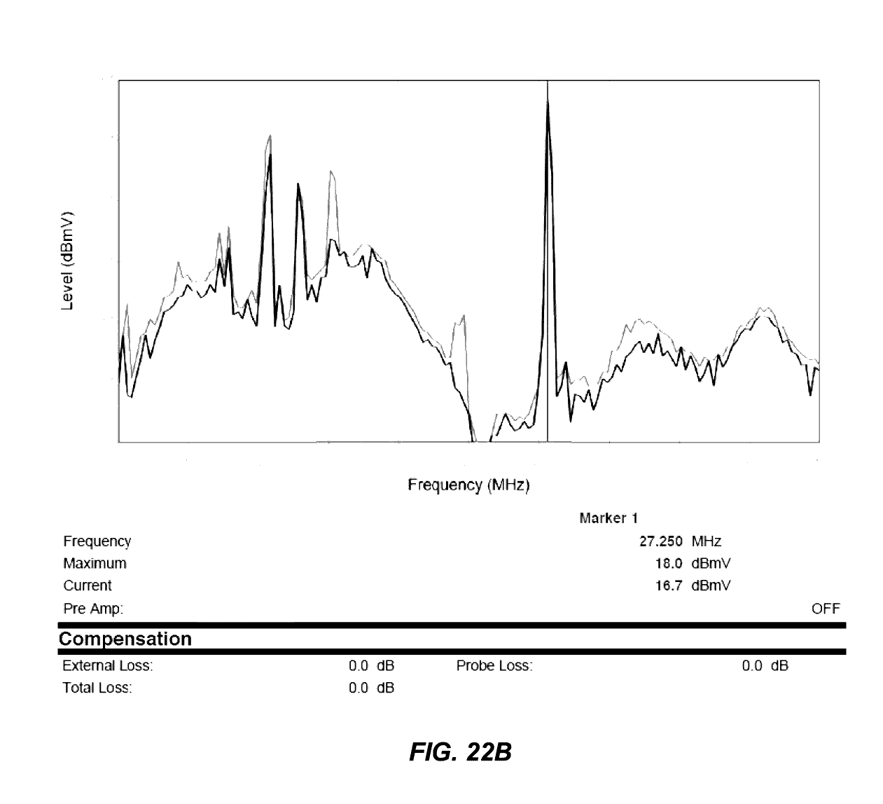

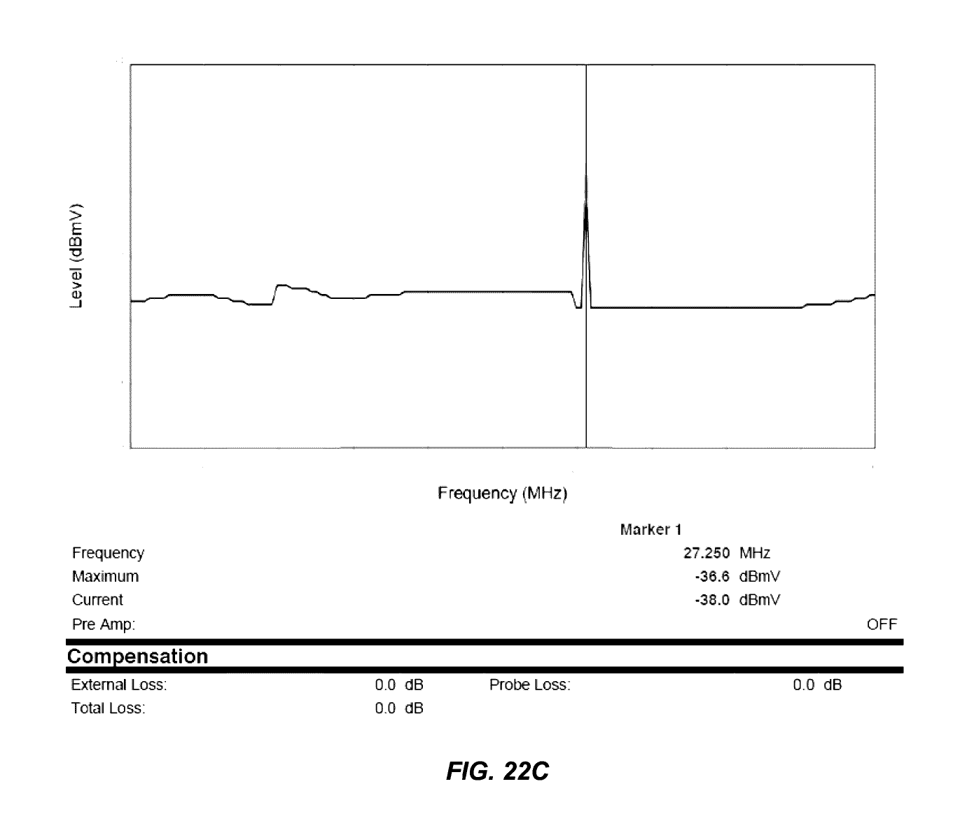

After gaining access to the cable communication system equipment in the lockbox (step 2002), the technician may (optionally) perform a visual and/or manual inspection of the cable communication system equipment (step 2004). For instance, the technician may inspect the equipment in the lockbox for corrosion, loose connections, broken components (taps, splitters, subscriber service drop cables, splices, etc.) and other faults that may lead to detectable ingress at the headend. The technician may also tighten one or more of the connections (e.g., with a torque wrench) between the RF hardline cable plant and the tap and between the tap and the respective subscriber service drop cables. In addition, the technician may look for signs of unauthorized access. If desired, the technician may record information (notes) about the state of the lockbox and the equipment inside the lockbox and the nature of any repairs or modifications (if any). Optionally, the technician may also terminate any unconnected tap ports with respective 75Ω terminators. However, it is not necessary to terminate unconnected tap ports because they generally admit little to no ingress, as explained below in connection with FIGS. 22A-22C.

As part of the Phase 2 activity, the technician may set a mobile transmitter, such as a citizens band (CB) radio, to broadcast a test signal with at least one spectral component in the upstream path bandwidth (step 2006). Handheld CB radios are especially useful for this purpose, because they are portable, inexpensive, and readily available. In the United States, which has an upstream path bandwidth of 5-42 MHz, for example, the technician may set the mobile transmitter to emit an unmodulated, continuous-wave tone at a frequency of 27 MHz, which is in the upstream path bandwidth, and a power of about 100 mW to about 4 W (e.g., about 1 W to about 2 W). The technician may then hold or otherwise place the mobile transmitter within about 1 meter to about 2 meters of the components within the lockbox.

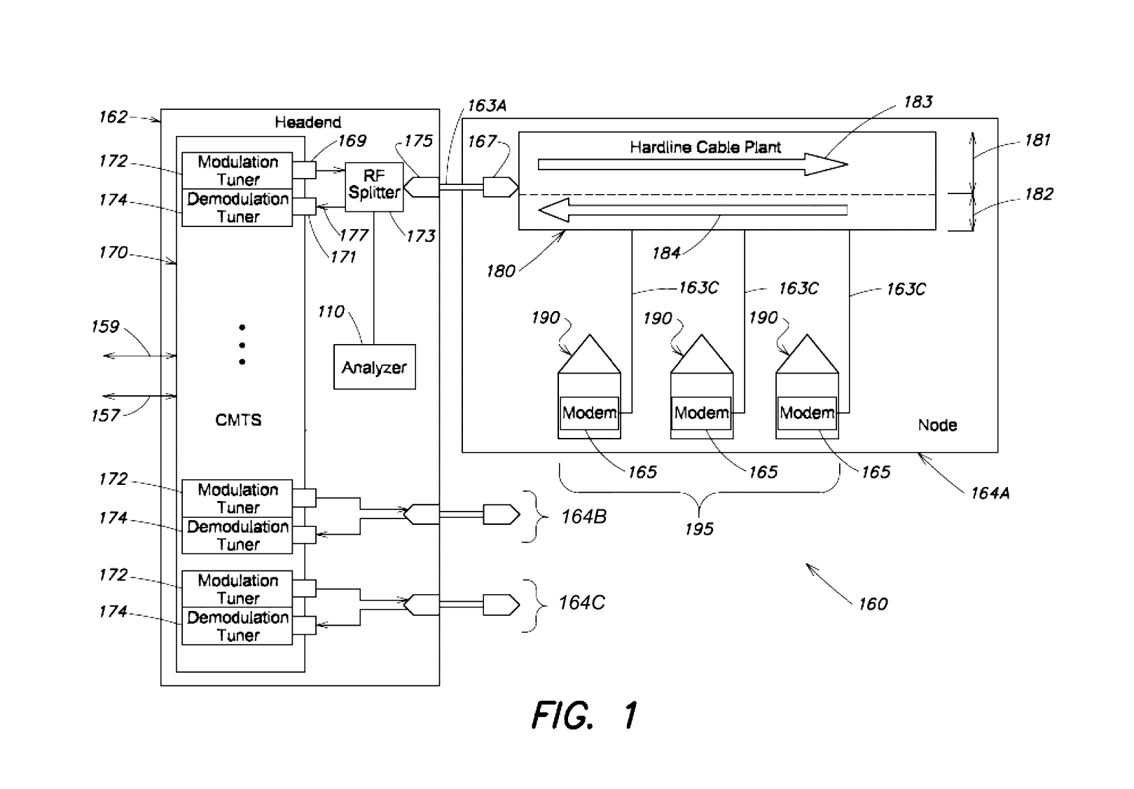

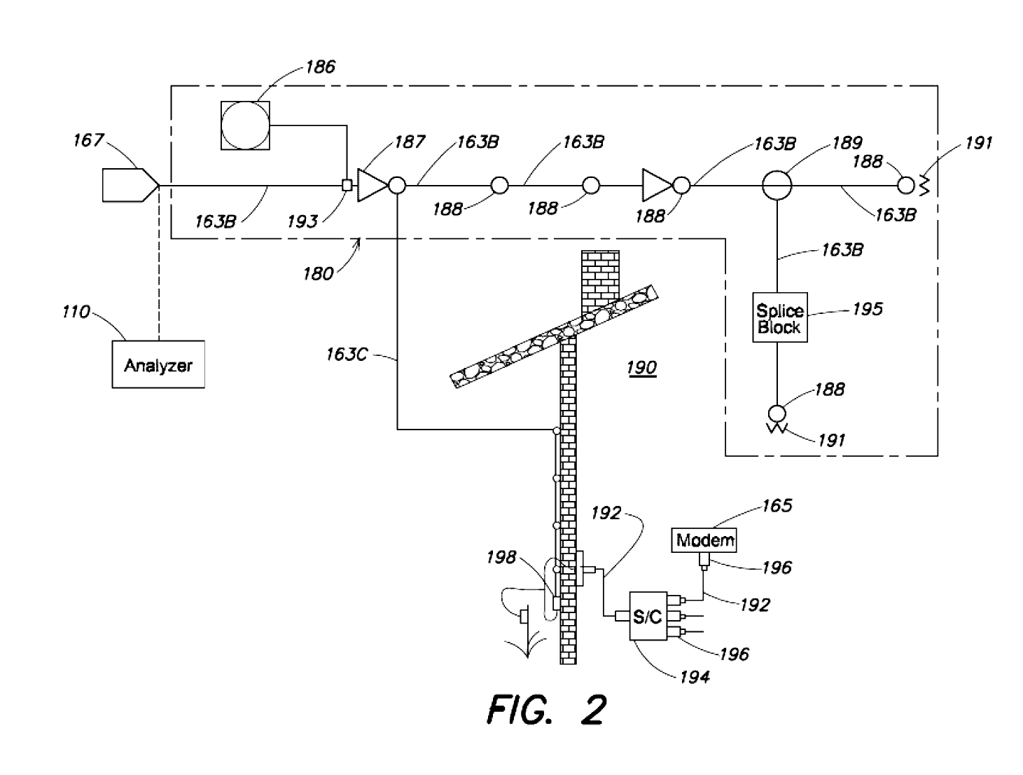

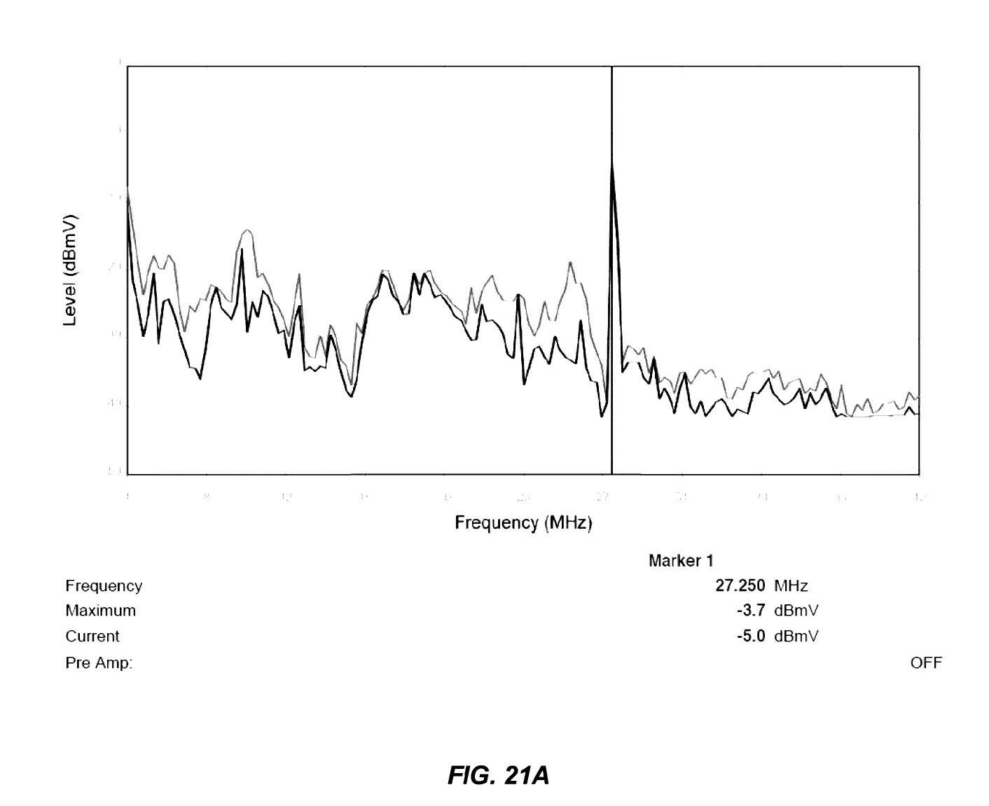

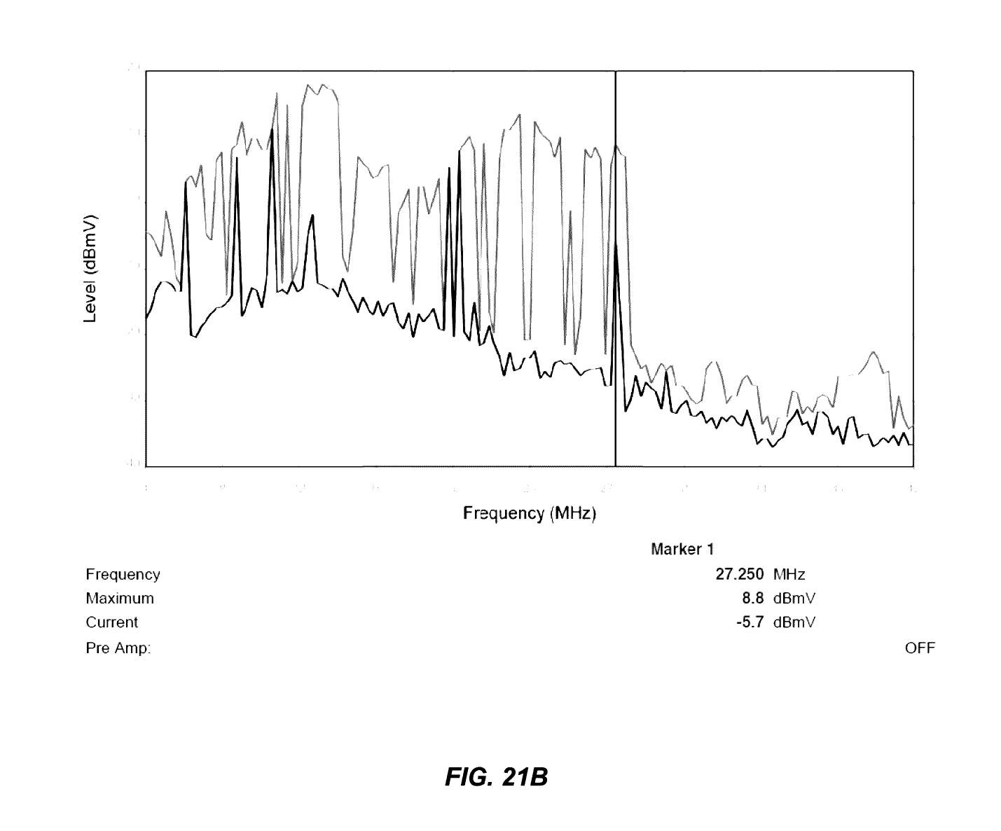

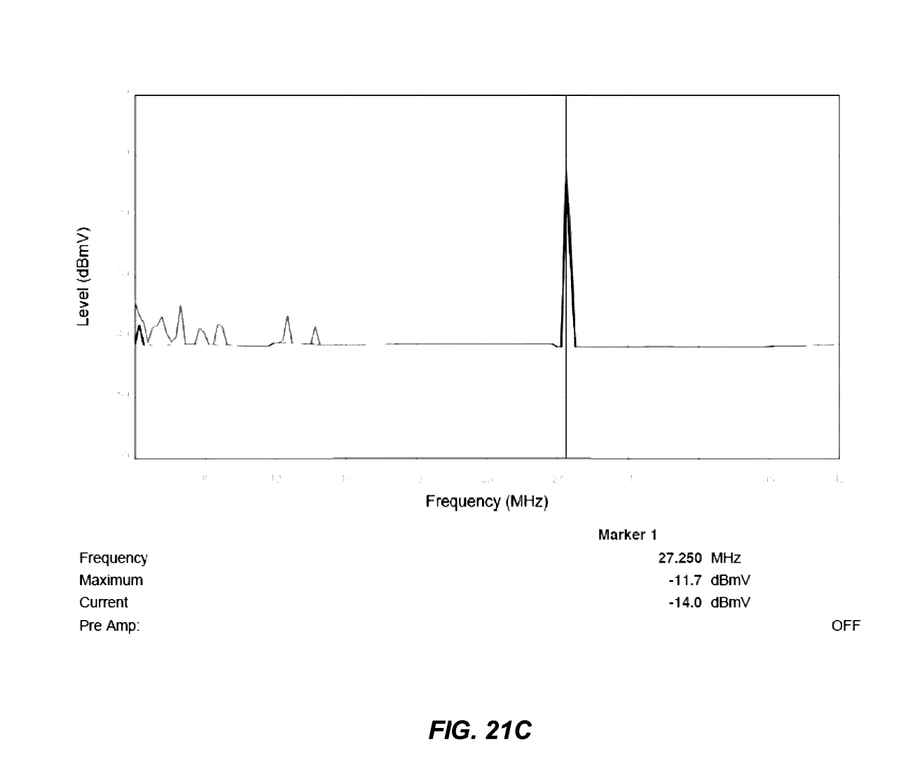

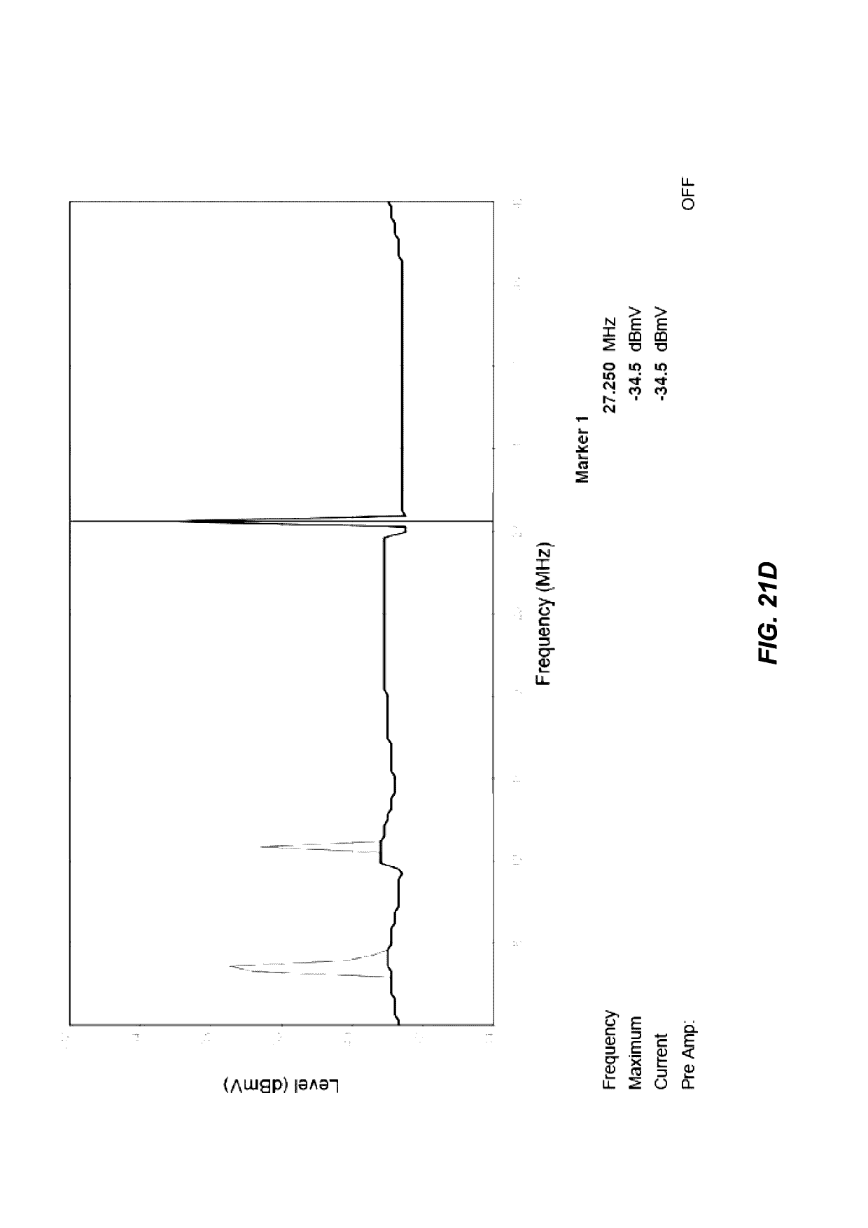

In some implementations of Phase 2 activity, the field technician may work in tandem with personnel at the headend who are monitoring the amplitude spectrum of at least a portion of the upstream path bandwidth with a spectrum analyzer (e.g., analyzer 110 in FIG. 1) or other suitable device for both a peak at the test signal frequency and for a spectral distribution of energy characteristic of ingress. In these implementations, the field technician would alert the personnel at the headend to the broadcast of a local test signal in proximity to the components within the lockbox so that the personnel at the headed may concurrently monitor the amplitude spectrum for indications of ingress (step 2008 of FIG. 20). As shown in FIGS. 21A-21D (described below), ingress often appears in the upstream path bandwidth as a low-frequency pedestal that tapers from high amplitude to the noise floor. The exact shape and height of this pedestal may fluctuate over time, and spurious peaks may appear (and disappear) in the upstream path bandwidth as well. This measurement at headend may be recorded electronically or otherwise for use in identifying ingress (and/or showing the reduction in ingress in the headend due to the Phase 2 activity in subsequent iterations). If the measurement at the headend does not indicate the presence of any significant ingress, the field technician may create or update a record indicating that the tap in question is (relatively) free of ingress and proceed to the next suspect component in the cable communication system. Otherwise, the technician may proceed to investigate the suspect tap further as explained below.

Ingress Measurements at a Suspect Tap

To determine whether or not a suspect tap and/or any subscriber service drop cables connected to the suspect tap contribute to ingress, in step 2010 of FIG. 20 the technician electrically disconnects the suspect tap from the hardline cable plant, and effectively connects the substantive electronic components of the suspect tap, together with the subscriber service drop cables attached to the tap, to an analyzer (e.g., a spectrum analyzer or sweep meter) that is configured to measure power or energy in the upstream path bandwidth. In an example implementation, this may be accomplished via the use of a supplemental tap test housing employed by the technician and a “PIN-to-F” adaptor (having a ⅝ inch male PIN-connector on one end, and a standard female F-connector on the other end), which is used to couple the upstream port of the test housing (e.g., constituted by ⅝ inch female PIN-connector for hardline coaxial cable) to the analyzer (e.g., having a standard female F-connector) via a length of coaxial cable terminated on each end with standard male F-connectors. Using the supplemental tap test housing and pinned F adaptor/cable, the technician removes the face plate of the suspect tap, with the subscriber service drop cables still attached to the face plate, and then couples the removed face plate of the suspect tap to the supplemental tap test housing. In this manner, upstream and downstream service to other taps that may be present in the node are not significantly interrupted (via operation of the bypass bar in the housing of the suspect tap with the removed face plate), while the face plate including the subscriber service drop cables of the suspect tap are coupled to the analyzer (via the test housing, pinned-F adaptor and coaxial cable).

With the face plate of the suspect tap coupled to the supplemental tap test housing and thus to the analyzer, in step 2012 of FIG. 20 the technician then may broadcast a test signal (e.g., a continuous-wave tone) with at least one spectral component within the upstream path bandwidth from a transmitter within about two meters of the face plate/test housing (as discussed above, the technician may use a handheld CB radio transmitter for this purpose or other similar piece of equipment). The technician then observes the analyzer, which measures the power in the upstream path bandwidth in the presence of the transmitted test signal in close proximity (e.g., within about two meters) of the face plate/test housing. The appearance of measurable power in the upstream path bandwidth, including power at the test signal frequency, may be used to corroborate the presence of an ingress-admitting fault associated with the suspect tap.

If the foregoing measurement via the analyzer shows ingress associated with the suspect tap face plate/test housing, then the technician may attempt to determine which of the subscriber service drop cables connected to the suspect tap's face plate, if any, contribute to ingress. The technician may make this determination by disconnecting the subscriber service drop cables from the suspect tap face plate, e.g., one at a time, in a particular sequence, and/or all at once, while monitoring the analyzer for changes in spectral signature in the upstream path bandwidth. For example, the technician may physically disconnect all of the subscriber service drop cables from the suspect tap, then reconnect them to the tap, one cable at a time, while monitoring the power in the upstream path bandwidth via the analyzer. Any increase in the ingress in the upstream path bandwidth associated with reconnection of a particular subscriber service drop cable may lead the technician to mark that subscriber service drop cable as a likely source of ingress, e.g., with a tag or other physical marking on the subscriber service drop cable itself and/or in a paper-based or electronic record-keeping system.

Alternatively, or in addition, the technician may directly measure the power (and/or the spectrum) in at least a portion of the upstream path bandwidth received at the upstream end (i.e., the end formerly connected to the suspect tap's face plate) of the disconnected subscriber service drop while broadcasting (or continuing to broadcast) a test signal in the upstream path bandwidth. That is, the technician may couple the upstream end (e.g., female F-connector) of a given subscriber service drop directly to the analyzer. If the measurement indicates ingress present at the upstream end of the disconnected subscriber service drop, the technician may then identify the disconnected subscriber service drop as a probable source of ingress with a tag or physical marking on the subscriber service drop cable itself and/or in a paper-based or electronic record-keeping system. The technician may optionally take some action to further identify and remediate the faults associated with the disconnected subscriber service drop or simply refrain from re-connecting the disconnected subscriber service drop to the suspect tap's face plate to prevent the ingress from reaching the headend. The technician may repeat this process for each subscriber service drop cable coupled to the suspect tap.

FIGS. 21A-21D are plots of power spectral density in the upstream path bandwidth as measured by an analyzer coupled to the supplemental tap test housing/pinned-F adaptor discussed above (or alternatively directly to a subscriber service drop cable if a particular cable is being measured individually) so as to illustrate various examples of spectrum profiles that may be observed during step 2012 of FIG. 20 (some of which examples are indicative or representative of ingress associated with a suspect tap). The analyzer used to generate these example plots was a JDSU DSAM-6300 Network Maintenance Sweep Meter set to perform an “Ingress Scan” measurement. In these examples, the technician also broadcast a test signal as an unmodulated tone at a frequency of 27.250 MHz and a power level of 2 Watts from a stationary CB radio positioned within about 1-2 meters of the suspect tap's faceplate/tap test housing assembly (or an individual subscriber service drop cable coupled directly to the analyzer if a drop cable is being measured individually). Accordingly, each of the plots in FIGS. 21A through 21D include a position marker at 27.250 MHz to indicate a corresponding peak in the spectrum profile indicative of the test signal (each plot includes two traces, namely, “peak hold” in gray, and “free run” in black).

The plot shown in FIG. 21A depicts low-frequency noise (in a frequency range below about 27 MHz) that is about 10-20 dB above the noise floor (which is between about −35 dBmV and −40 dBMv at around 30-42 MHz). The plot also includes a particular peak (indicated by Marker 1, the vertical line at 27.250 MHz) at about −3.7 dBmV, representing the test signal broadcast from the CB radio. Taken together, the low-frequency noise and the relatively high peak corresponding to the test signal indicate one or more faults admitting ingress.

The plot shown in FIG. 21B represents an example of a spectrum profile that the Inventors have recognized and appreciated (e.g., via significant experimentation and empirical observation) as significantly indicative of one or more loose F connections (at one or more of the suspect tap's face plate, or associated with a given subscriber premises). The plot shows a significant presence of low-frequency noise that is about 20-60 dB above the noise floor, indicating severe ingress, and the test signal peak (again indicated by Marker 1) is significantly present at about −5.7 dBmV.

The plot shown in FIG. 21C represents another example of a spectrum profile, in which there is little to no appreciable low-frequency noise, but nonetheless a noticeable test signal peak (again indicated by Marker 1) at about −11.7 dBmV. Although the ingress in the lower portion of the upstream path bandwidth is relatively low, the relatively high absolute value of the test signal peak and the possibility that low-frequency ingress can fluctuate (i.e., increase or decrease as a function of time) suggest that further investigation and possible ingress remediation may be warranted in connection with the suspect tap at issue (or particular subscriber service drop cable if being measured individually).

The plot shown in FIG. 21D represents yet another example of a spectrum profile, in which there is little to no appreciable low-frequency noise and the test signal peak (again indicated by Marker 1) is very low at about −34.5 dBmV. The lack of low-frequency ingress and the small test signal peak indicate that the suspect tap/drop cable under investigation is probably not admitting appreciable ingress into the cable communication system, so no mitigation is necessary.

If a given measurement in the context of the test scenario described above (i.e., a test signal broadcast within about 2 meters of equipment under investigation) reveals little to no ingress and a minimal broadcast peak (e.g., a peak at the broadcast frequency that is only a few decibels (e.g., <10 dB) above the noise floor), then the technician may conclude that the particular suspect tap/drop or other equipment under test is functioning properly. If on the other hand a given measurement reveals significant ingress and a large broadcast peak (e.g., a peak that is about 20-30 dB above noise floor), then the technician may continue searching for sources of particular faults in or associated with the equipment under test. The technician may also search for ingress sources when the measurement reveals marginal to significant ingress and/or a moderate to strong peak at the test signal frequency. In any case, the technician may record the spectrum trace, peak amplitude, noise floor, integrated power, and/or other indications of the upstream path bandwidth measurement at the suspect tap/drop for use in reporting ingress identification and/or ingress mitigation (step 2020 of FIG. 20).

Referring again to FIG. 20, if the upstream path bandwidth measurement at the suspect tap/drop indicates the presence of ingress, in step 2014 the technician may optionally mitigate the ingress by identifying and remediating one or more faults that admit ingress into the cable communication system via the suspect tap. For instance, the technician may check the suspect tap for loose connections between the tap ports and the subscriber service drop cables, broken F connectors on one or both of the tap and the subscriber service drop cables, broken coaxial cables, broken splices, etc. In addition, the technician may tighten any loose connections, disconnect or replace any broken or suspect equipment associated with the suspect tap, and/or install filters to attenuate signals in the upstream path bandwidth. If these remediation measures reduce the ingress and/or test signal amplitude measured at the suspect tap in the upstream path bandwidth, the technician may record indications of the remediation measures (step 2022; e.g., “Tighten connector” or “Replace tap”) as well as one or more indications of the upstream path bandwidth measurement after remediation (step 2020), then proceed to the next suspect tap (or other suspect system component) (step 2024).

Unconnected, Unterminated, and Improperly Connected F Connectors

The Inventors have recognized that, somewhat surprisingly, unterminated F connectors do not contribute significantly, if at all, to ingress. Although it is conventionally presumed in the art that unterminated F connectors are significant sources of ingress in the upstream path bandwidth, actual measurements conducted during experimentation and development of the inventive methods and apparatus disclosed herein reveal that unterminated F connectors are notably poor antennas at frequencies in the upstream path bandwidth (e.g., between about 5 MHz and about 42 MHz). For example, FIG. 22A shows that an unterminated, unconnected F connector on a tap about 1-2 m from a CB radio radiating about 1 W at 27 MHz couples very little of the radiated power into the cable communication system. Accordingly, in some embodiments of Phase 2 activity, a technician need not necessarily terminate unterminated (unused) F connectors of a suspect tap or other system equipment.

Furthermore, in some circumstances it may be more prudent to specifically not terminate unterminated F connectors of a tap or other system equipment because the potential drawbacks to improper termination outweigh the advantages of properly terminating unconnected F connectors (or not terminating them at all). In particular, it is possible to break the F connector (e.g., by over-tightening), and the broken F connector could admit ingress at one or more frequencies in the upstream path bandwidth. Corrosion caused by mismatched materials in the F connector and the terminator could also lead to significant ingress in the node. Other advantages to leaving unconnected F connectors unterminated include fewer components (no terminators), faster service times (no time spent installing terminators), and associated reduction in cost. Instead of terminating an unconnected F connector, the technician might place a security device (e.g., a lock) on the unconnected F connector to prevent theft of service and other unauthorized access (e.g., an unconnected F connector may be typically associated with a tap in a lockbox, so that unauthorized access is mitigated in any event).

Measurements also reveal that loosely or improperly connected F connectors contribute significantly to the measurable ingress in a node. For example, FIG. 22B shows that a loose connection between a female F connector on a tap and a male F connector at one end of a subscriber service drop about 1-2 m from a CB radio radiating about 1 W at 27 MHz couples a significant amount of the radiated power into the cable communication system. Conversely, a proper (tight) connection subjected to the identical broadcast admits little to no radiated power into the node of the cable communication system as shown in FIG. 22C.

Unfortunately, loose or improper F connections of the sort that result in spectrum profiles similar to that shown in FIG. 22B (as well as FIG. 21B) tend to be commonplace in many conventional cable communication systems for a number of reasons, including the relatively low skill level among fulfillment technicians who install subscriber service drop cables, the improper use (or lack of use) of appropriate tools (e.g., wrenches) during installation, and the general goal in the industry for fast installations (which may in some instances lead to a sacrifice in quality). In fact, it is not uncommon to find subscriber service drop cables coupled to tap ports via careless hand-tightening, with only a one- to two-thread connection between the male and female F connectors. Loose connections also tend to be more difficult to detect visually, especially when collocated with other connections and/or other components. Moreover, it may be difficult to assess whether a single loose connection, if any, is primarily responsible for the detected ingress or whether several collocated loose connections contribute to the ingress measured at the headend.

If the technician finds and tightens all of the loose connections and the ingress measured at the suspect tap (or the headend) significantly decreases, then the technician may conclude that ingress mitigation has been appropriately attended to regarding the suspect tap and that no further investigation of the suspect tap and any associated subscriber service drop cables is required. At this point, the technician may secure the lockbox and proceed to the next suspect component, which may be at another test site (step 2024). If, on the other hand, tightening the loose connections does not (sufficiently) reduce the ingress measured at the suspect tap, or if there are no discernibly loose connections, then the technician may proceed to check the subscriber service drop cables for ingress. In one example, the technician disconnects the upstream end of a first subscriber service drop from the tap and then connects the upstream end of the first subscriber service drop to a multi-meter, spectrum analyzer, or other device capable of measuring power or power distribution over at least a portion of the upstream path bandwidth. Again, the technician broadcasts (or continues broadcasting) a test signal (e.g., a 27 MHz tone at a power of about 100 mW to about 4 W) from an antenna disposed within about 2 meters of the upstream end of the disconnected subscriber service drop. In this case, the technician measures the power at the test frequency and/or looks for the characteristic signature of ingress in the upstream path bandwidth.

As before, if the technician does not detect the characteristic signature of ingress or any appreciable power at the test frequency (e.g., a peak no more than about 10 dB above the noise floor) using the spectrum analyzer or multi-meter coupled to the upstream end of the subscriber service drop under test, the technician may conclude that the subscriber service drop under test is not a significant source of ingress and reconnect it (properly) to the tap. The technician may then proceed to test the next subscriber service drop or, if the other subscriber service drop cables have already been tested, move on to the next piece of equipment within the lockbox or to another lockbox altogether.

If the technician measures significant ingress and/or a peak at the test signal frequency, however, he or she may conclude that the subscriber service drop under test is an appreciable source of ingress. At this point, the technician may simply mark the subscriber service drop as a (suspected) source of ingress, either using an electronic record-keeping tool, with an appropriate mark or tag, or both. The technician may also refrain from reconnecting the suspect subscriber service drop to the tap to prevent the suspect subscriber service drop from introducing ingress into the node of the cable communication system.

Time-Domain Reflectometer Measurements of Subscriber Service Drop Cables

For those subscriber service drop cables identified as possibly having one or more faults (e.g., breaks, bad splices, loose connections, etc.) giving rise to ingress, in some embodiments the technician may use a time-domain reflectometer (TDR) or a frequency-domain reflectometer (FDR) to identify and locate such faults. In connection with TDR, the technician may disconnect the upstream end of the suspect subscriber service drop from the tap and connect it to the TDR, which transmits a brief pulse at a particular carrier frequency within the upstream path bandwidth (e.g., a pulse of a few cycles at the carrier frequency) along the suspect subscriber service drop cable. As the pulse propagates along the subscriber service drop cable, it may encounter connectors, splices, other components, and ultimately the downstream end of the coaxial cable, each of which may reflect at least a portion of the pulse energy back towards the pulse source. Breaks in the cable, kinks in the cable, loose connections, and other variations in impedance along the subscriber service drop may also reflect at least a portion of the pulse energy back towards the pulse source. The TDR senses the amplitudes of the reflected pulse(s) and measures the time delay between the pulse emission and the arrival of the reflected pulse(s) to provide an indication of the distance between the upstream end of the subscriber service drop cable coupled to the TDR and the location(s) of any faults in the subscriber service drop. An FDR provides similar measurements using a broadband pulse instead of a brief, narrowband pulse.

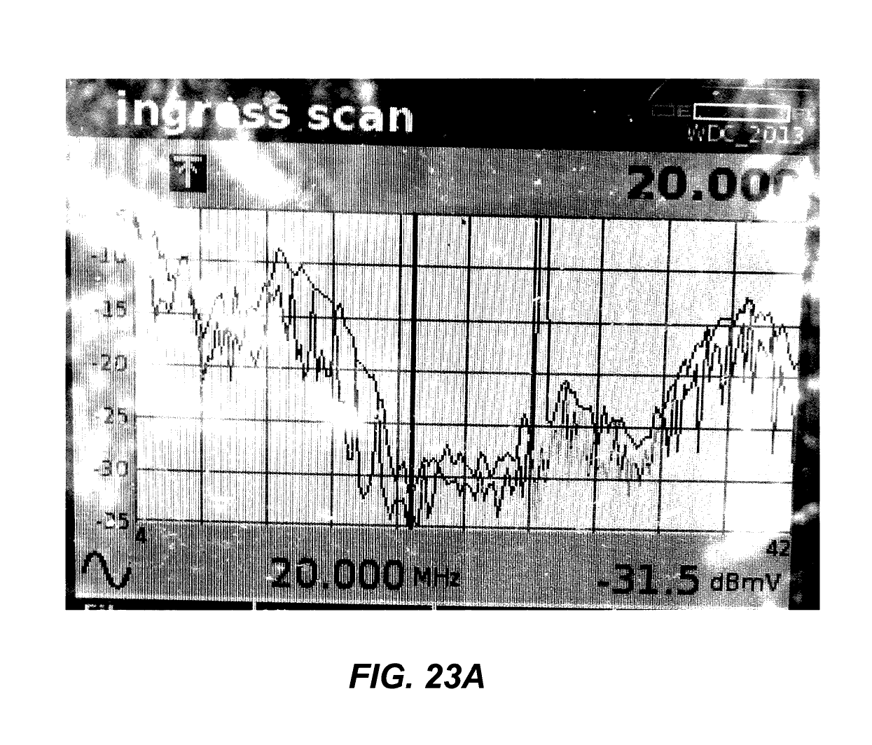

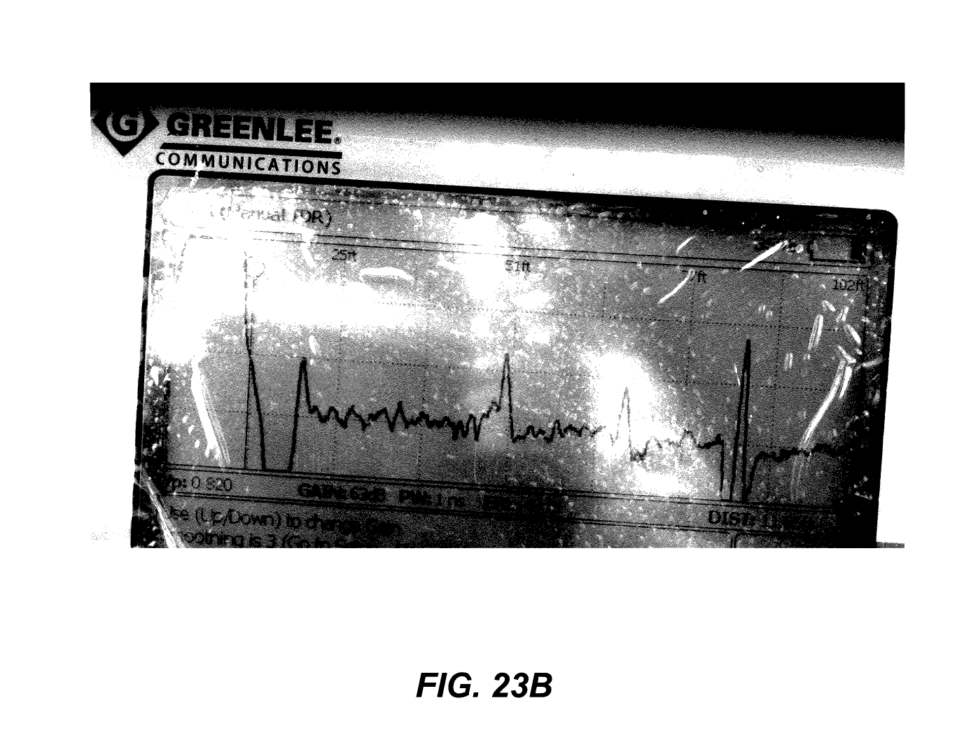

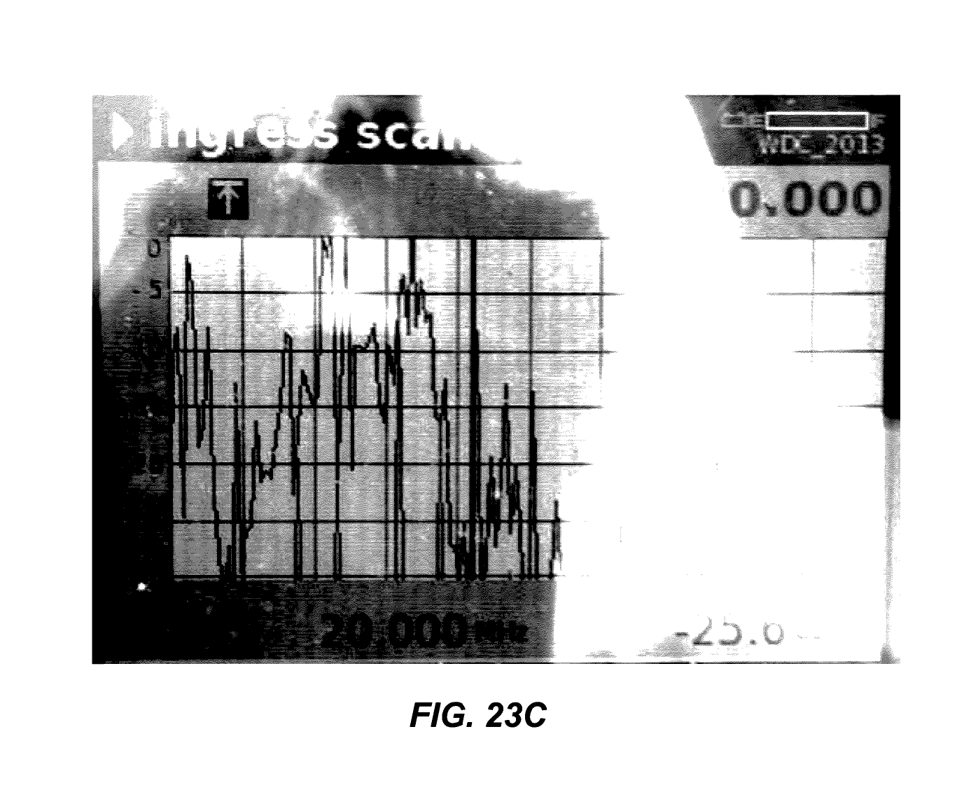

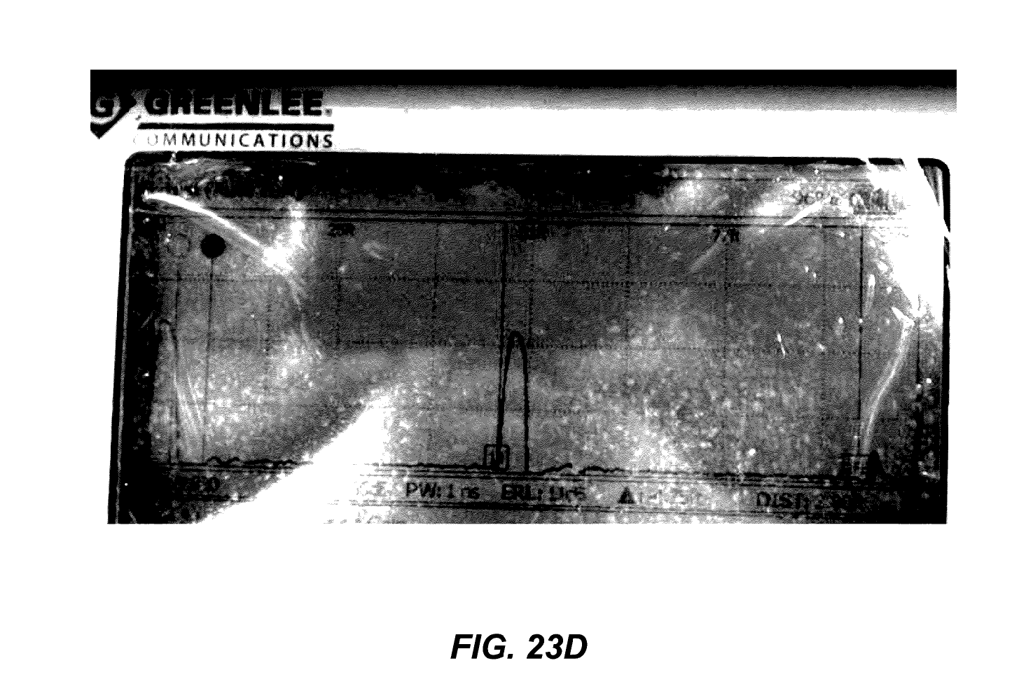

FIGS. 23A and 23B illustrate an example of an ingress spectrum profile for a first subscriber service drop cable under evaluation (when coupled directly to an analyzer), and a corresponding TDR plot for the first subscriber service drop cable, respectively. From FIG. 23A, it may be readily appreciated that the drop cable under evaluation demonstrates the presence of significant ingress. The TDR plot of FIG. 23B illustrates that the cable appears to have a significant “open circuit” (i.e., cut through) at 11.65 feet from the measurement end—a marker on the left of the display indicates the measurement end, and immediately to the right of the marker a downward spike in the plot indicates the open circuit condition. Thus, the TDR plot in this example suggests that the drop cable likely does not reach a premises, and for some reason may have been cut off by a previous technician and left (e.g., dangling inside a raceway). In this instance, the present technician may presume that it would be appropriate to simply leave this drop cable disconnected from the tap under inspection as part of the overall ingress mitigation effort.

FIGS. 23C and 23D illustrate an example of an ingress spectrum profile for a second subscriber service drop cable (when coupled directly to an analyzer), and a corresponding TDR plot for the second subscriber service drop cable, respectively. Like the previous example discussed above in connection with FIGS. 23A and 23B, the spectrum profile of FIG. 23C demonstrates the presence of significant ingress in this second cable. The TDR plot of FIG. 23D, however, is notably different than the TDR plot of FIG. 23B, and illustrates that the cable appears to be terminated just under 50 feet from the measurement end (which conceivably could be at/in a premises in a given multi-occupant structure environment). Accordingly, the TDR may not necessarily directly indicate any anomaly in the cable (i.e., prematurely cut, as in the prior example), but nonetheless the ingress spectrum profile in FIG. 23C associated with this drop cable suggests that one or more faults may exist that are associated with the cable under evaluation (e.g., inside the premises to which the drop cable is coupled).

Thus, it may be appreciated from the foregoing examples that if the TDR measures any faults in the subscriber service drop cable, the technician may use these measurements along with his or her knowledge of the subscriber service drop cable to reduce ingress associated with the faults. For example, if the TDR shows a fault about 10 meters from the upstream end of the subscriber service drop cable, but the subscriber service drop cable runs through a raceway or conduit that extends for more than 10 meters before reaching the first subscriber premises, then the technician may conclude that the subscriber service drop cable is broken and/or has a fault that lies within the raceway or conduit. In addition, the technician may also tag or otherwise mark the disconnected subscriber service drop cable, cut the disconnected subscriber service drop cable as close to the lockbox as possible to prevent it from being reconnected to the tap in the future, or reconnect it to the tap via a filter that attenuates signals in the upstream path bandwidth to prevent ingress from propagating upstream past the tap. The technician may also update a paper-based or electronic record to indicate a presence of the fault, a description of the fault, and/or a description of any measures taken to mitigate the fault.

In other cases, the TDR measurement may indicate that the subscriber service drop cable is not connected to any subscriber premises or downstream component. For instance, the TDR measurement may reveal that the downstream end of the subscriber service drop cable is not connected to anything or that the subscriber service drop cable is broken at a point between its upstream and downstream ends. In such cases, the subscriber service drop cable can be disconnected from the tap to mitigate ingress without disrupting service. As above, the technician may tag or mark the subscriber service drop cable and/or cut the subscriber service drop cable to prevent it from being reconnected to the tap. The technician may also update a paper-based or electronic record to indicate the subscriber service drop cable's status and/or a description of any corresponding mitigation measures.

If the TDR measurements show that the subscriber service drop is connected to a subscriber premises (or, more precisely, does not show that the subscriber service drop is unconnected), but the downstream end of the subscriber service drop is not easily identifiable, then the technician may pursue one or more of the following options.

First, the technician may simply leave the subscriber service drop disconnected from the tap. This disconnection should prompt any affected subscribers to contact their cable provider, which should aid in identification and remediation (e.g., repair and/or replacement) of the ingress-causing faults associated with the subscriber service drop. If no subscribers contact the cable provider, then the cable provider may proceed under the assumption that the disconnected subscriber service drop was not in fact being used to provide service. On the other hand, if the cable provider is contacted by an affected subscriber and access to the affected premises is permitted, once inside the premises the technician may inspect various equipment in the premises for faults; for example, the technician may inspect all F-connectors present to ensure they are properly tightened. The technician may alternatively perform a Phase 2 analysis internal to the premises, i.e., the technician may reconnect the corresponding subscriber service drop cable to the suspect tap, broadcast a “local” test signal in proximity (e.g., within 1-2 meters) of various equipment in the premises, and observe on an analyzer (e.g., either at the headend or coupled to an assembly of a suspect tap's face plate/supplemental test tap housing) the spectrum profile in the upstream path bandwidth to assess possible faults in the subscriber premises equipment that may admit ingress.

Second, the technician may reconnect the subscriber service drop to the tap via a high-pass filter or attenuator that attenuates signals in the upstream path bandwidth but does not necessarily appreciably affect signals in the downstream path band. This permits subscribers who receive service via the reconnected subscriber service drop to access downstream services (e.g., they can still watch television) but not necessarily upstream services (e.g., they may not be able to access the internet via their cable modems). Again, the affected subscribers may contact their cable provider, which should aid in identification and remediation (e.g., repair and/or replacement) of the ingress-causing faults associated with the reconnected subscriber service drop.

Third, the technician may attempt to identify the ingress-admitting fault(s) by inspecting the subscriber service drop more thoroughly. For example, the technician may trace the subscriber service drop through raceways and conduits to the subscriber premises, checking connections along the way using spectrum analysis or power measurements to look for downstream ingress and/or TDR to look for reflections within the coaxial cable. He or she may also check for change(s) in the services that are monitored at the headend, such as telephone and internet services, for the subscriber premises within the multi-occupant structure. These changes may enable the technician to identify the affected subscriber premises, which in turn allows further tracking, repair, and/or replacement of any (suspect) subscriber service drop(s) as discussed above (e.g., upon disconnection from a suspect tap of a given subscriber service drop cable, a report from the CMTS monitoring equipment at the headend may indicate that a particular modem at a particular address has gone off-line, which may facilitate identification of the subscriber premises associated with the given drop cable).

Once a given subscriber service drop has been tested and, if necessary, remediated, the technician tests the next subscriber service drop connected to the tap, then the next one, and so on until the ingress has been remediated and/or all of the subscriber service drop cables have been tested. At this point, the technician may inspect and test other components within the lockbox, including other taps and subscriber service drop cables, as well as RF hardline cable plant components in or near the lockbox. The technician may perform these optional inspections and/or tests as a matter of course, in response to directions from other personnel, and/or based on one or more Phase 1 measurements. After finishing these optional inspections and/or tests, the technician may secure the components within the lockbox before proceeding to another multi-occupant structure or site with collocated cable communication system equipment.

Addressable Faceplates for “Phase 2” Ingress Identification and Location

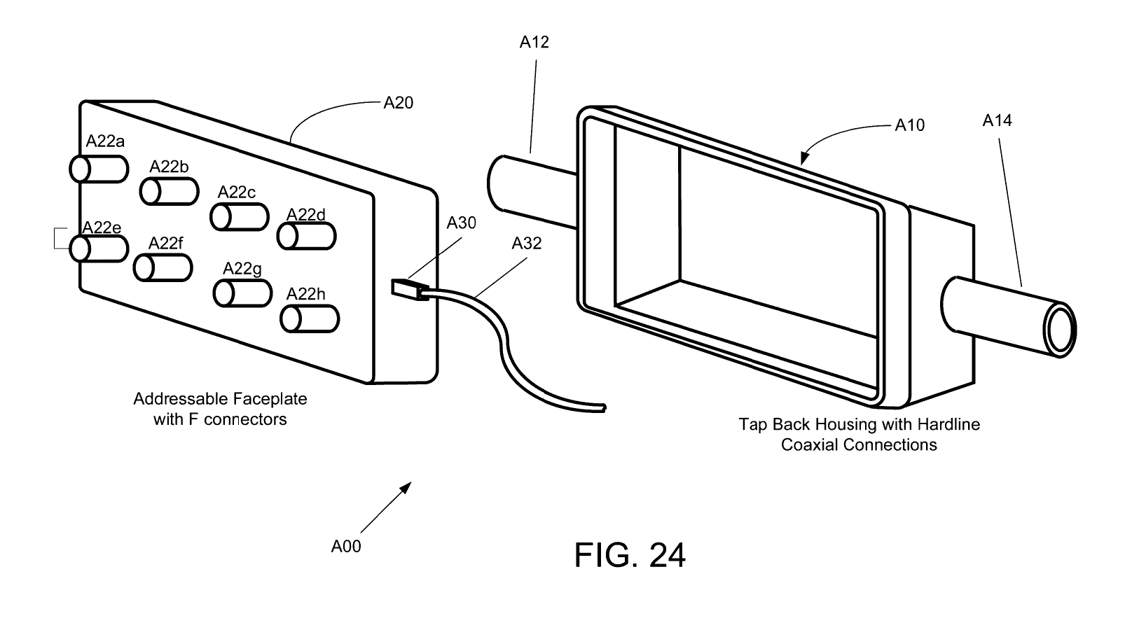

FIGS. 24-27 illustrate a tap with an addressable faceplate and a process of using the tap with the addressable face plate for identifying sources of ingress as part of Phase 2 activity, according to other inventive embodiments. For example, in some embodiments, a technician may temporarily replace the conventional faceplate of a suspect tap with the addressable faceplate discussed in connection with FIGS. 24-27 without disrupting service to subscribers served by other taps coupled to the suspect tap. Once the technician has properly installed the addressable faceplate, he or she can use the addressable faceplate to automatically switch each tap port of the suspect tap between a connection to a corresponding 75Ω terminator and a connection to a corresponding subscriber service drop cable for Phase 2 testing. After testing, the technician may remove the addressable faceplate or leave it installed to facilitate possible future maintenance and Phase 2 activity. The addressable faceplate can also be installed during installation or routine maintenance of the RF hardline cable plant.

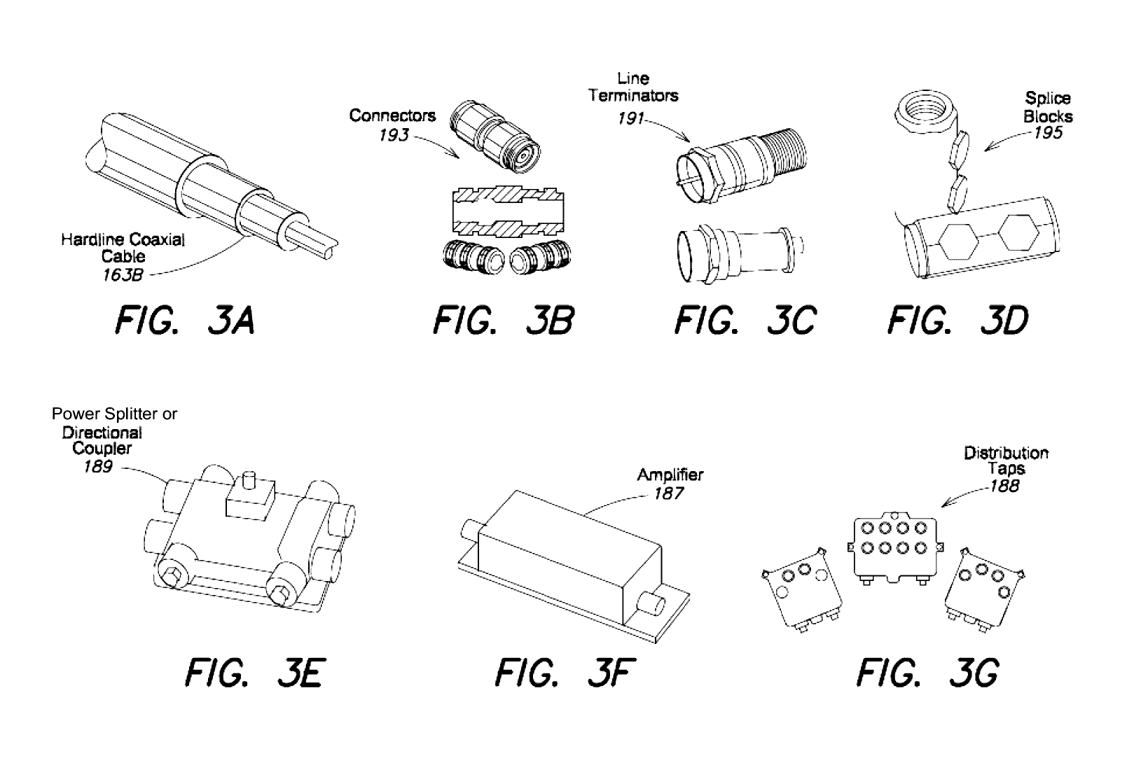

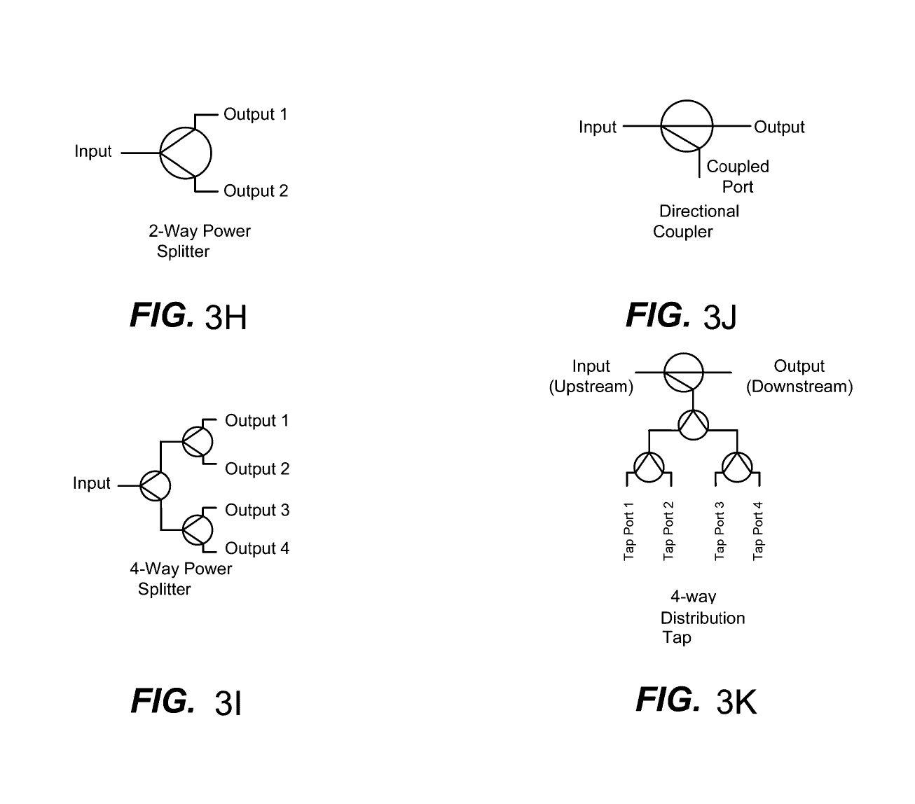

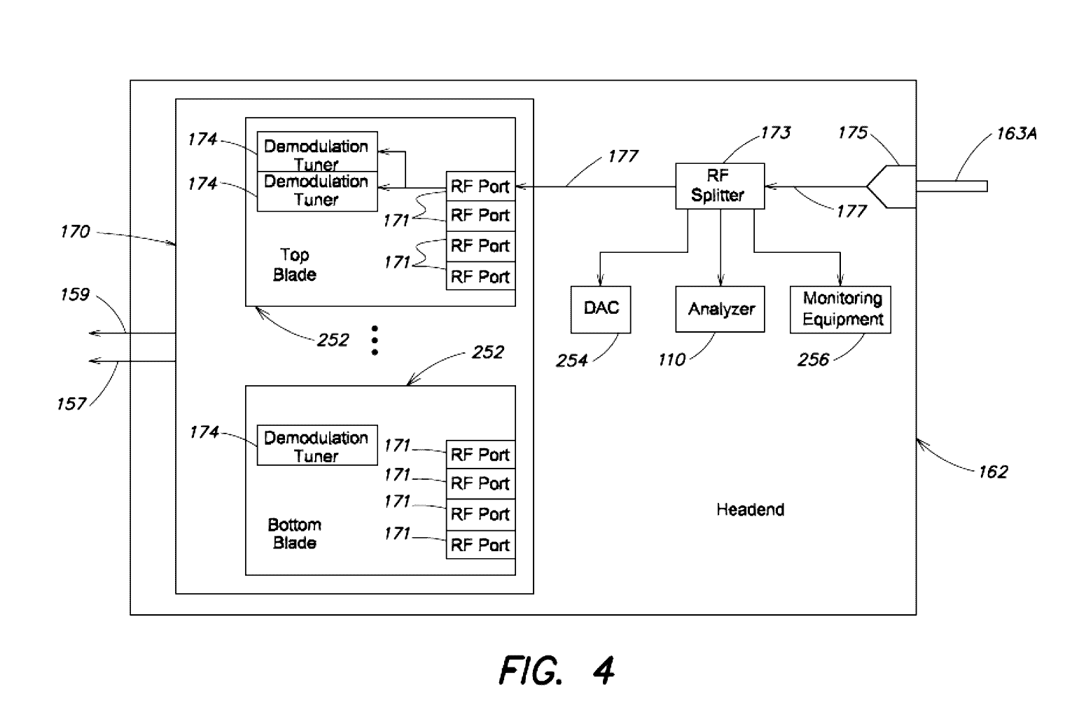

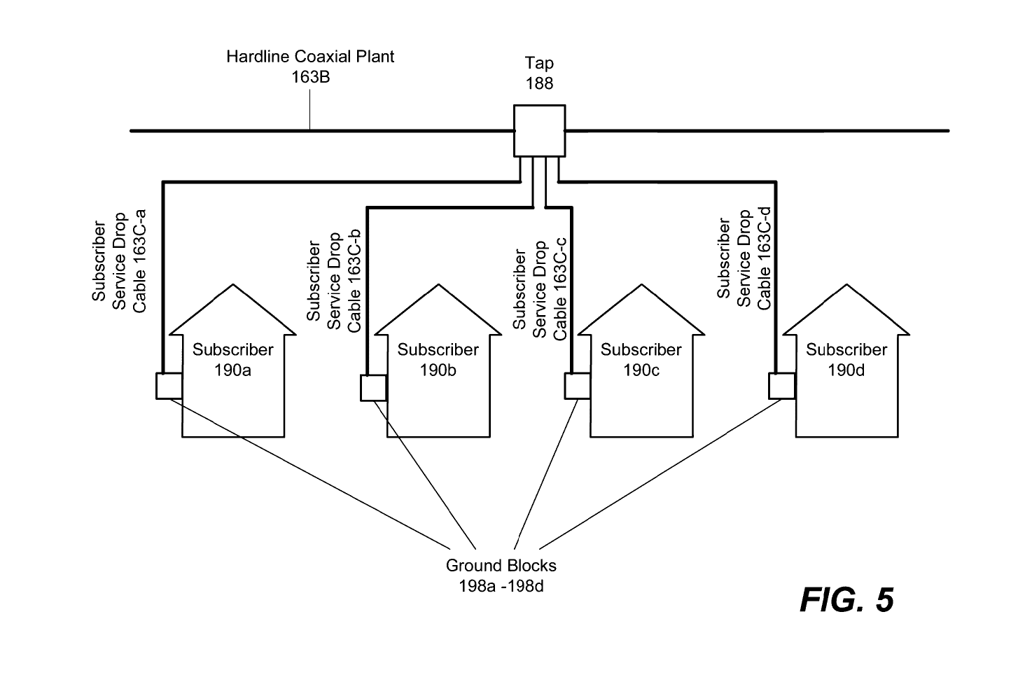

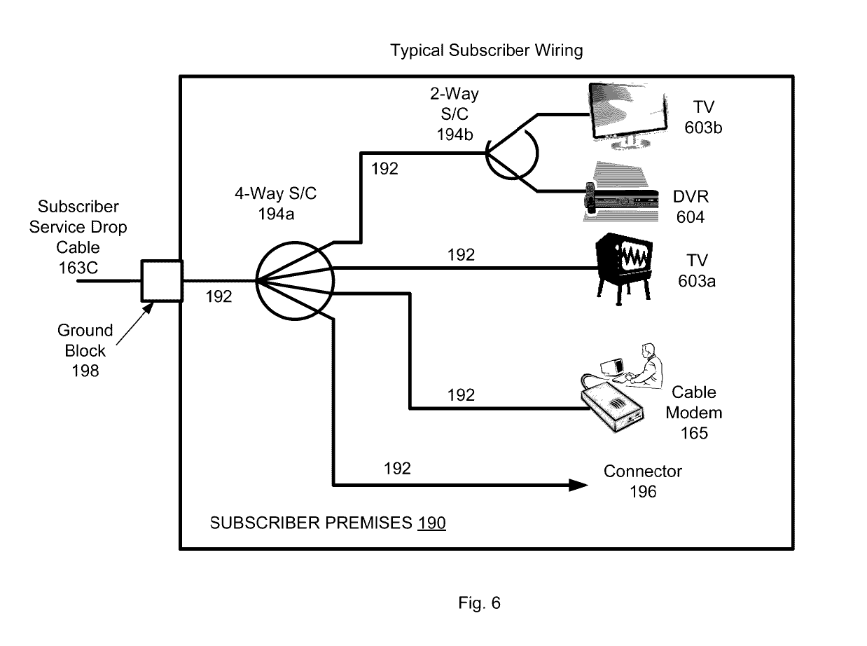

FIG. 24 shows a view of a partially disassembled tap A00 with an addressable faceplate A20 according to embodiments of the present invention. In this example, the addressable faceplate A20 has eight female F connectors, or tap ports A22a-A22h (collectively, tap ports A22), each of which is suitable for connection to a male F connector at the end of a corresponding subscriber service drop cable (not shown). In other examples, the addressable face plate may have two or four female F connectors. The addressable faceplate A20 also includes a control input/output interface, such as a wireless interface (e.g., a Bluetooth interface) or a wired interface (e.g., a universal serial bus (USB) port A30 connected to a USB cable A32 as shown in FIG. 24), which can be used to control switches inside the tap A00. In addition, the addressable tap A00 includes a tap housing A10, which may be similar or identical to a tap housing from a conventional tap, that mates with the addressable faceplate A20 and has an input port A12 and a coaxial output A14 suitable for connection to coaxial cables in an RF hardline cable plant as in a conventional tap (e.g., tap 188 shown in FIG. 3G). The output port A14 can also be connected to a 75Ω terminator if the tap A00 is the last tap (a “terminating tap”) in a particular leg of the RF hardline cable plant.

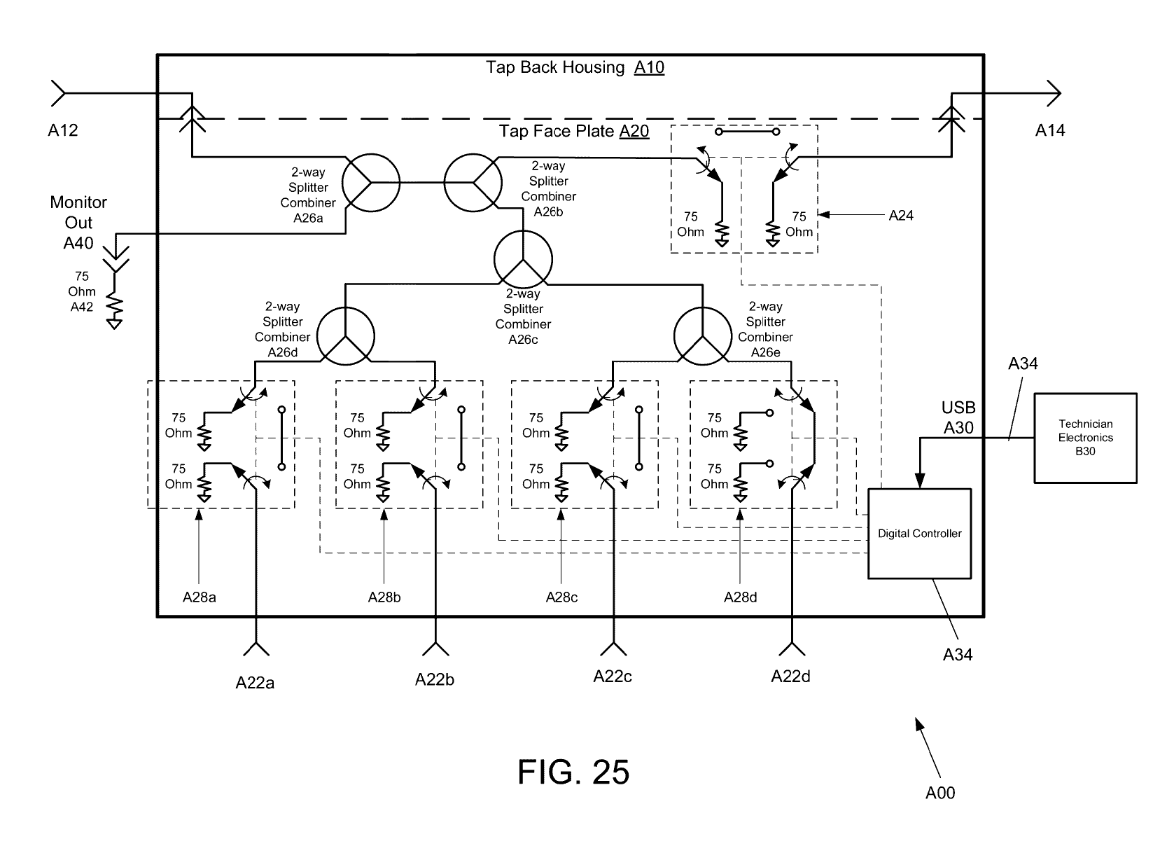

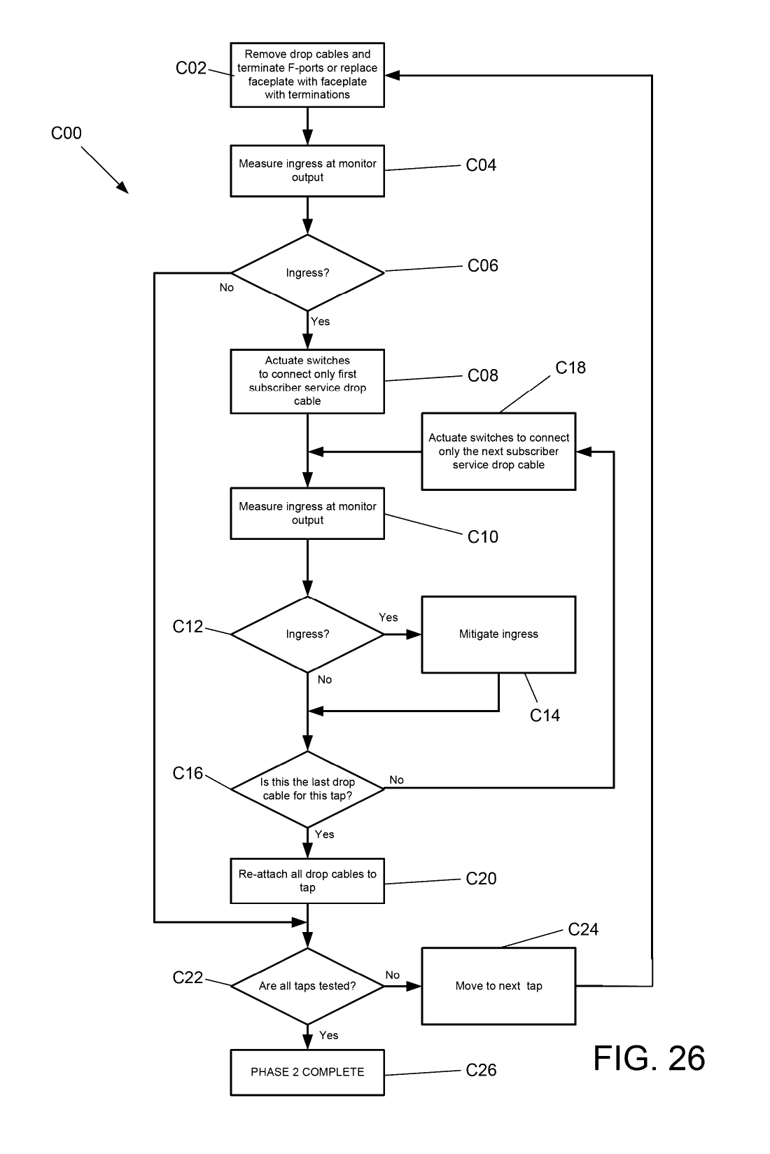

FIG. 25 shows a block diagram of the tap A00 (only four tap ports A22a-d are shown for purposes of illustration) according to embodiments of the present invention. The tap A00 comprises a first two-way splitter/combiner A26a whose input is coupled to the input port A12, whose first output is coupled to a monitor output A40, and whose second output is coupled to the input of a second two-way splitter/combiner A26b. The first output of the second two-way splitter/combiner A26b is coupled to the output port A14 via a switch A24, and the second output of the second two-way splitter/combiner A26b is coupled to the input of a third two-way splitter/combiner A26c, which in turn has outputs connected to a fourth two-way splitter/combiner A26d and a fifth two-way splitter/combiner A26e.

The outputs of the fourth two-way splitter/combiner A26d and the fifth two-way splitter/combiner A26e are connected to respective double-pole double-throw (DPDT) switches A28a-A28d (collectively, switches A28), which are configured to switch the outputs of the fourth two-way splitter/combiner A26d and the fifth two-way splitter/combiner A26e between respective 75Ω terminators internal to the switches A28 and respective tap ports A22a-A22d. Examples of suitable DPDT switches A28 include, but are not limited to, switches that include RF reed relays. Each switch A28 permits the connection or disconnection of the taps that are further downstream and may be used during the ingress testing process to isolate or segregate selected subscriber service drop cables. For example, FIG. 25 shows that switch A28d is closed to connect the tap port A22d to the input port A12 via the first splitter/combiner A26a, the second splitter/combiner A26b, the third splitter/combiner A26c, and the fifth splitter/combiner A26e. FIG. 25 also shows that the other switches A28a-A28c have been actuated to terminate the other tap ports.

The tap A00 also includes a digital controller A34 that is in electrical communication with and is configured to control the switches A24 and A28 as indicated by the dashed lines in FIG. 25. This digital controller A34 may be a simple logic circuit, a field programmable gate array, a microprocessor, or any other suitable controller or processor, including an analog controller or control circuit. In operation, the digital controller A34 is coupled to electronics B30, such as a laptop, tablet, smartphone, or specialized equipment, used by the technician to conduct the Phase 2 activity, e.g., via the USB port A30 and USB cable A32 shown in FIG. 25. In other embodiments, the digital controller A34 may be coupled to the technician's electronics B30 via a wireless interface (antenna), such as a Bluetooth interface or an RF data receiver designed to receive a RF control signal carried over the network in a manner similar to a conventional addressable tap.

FIG. 26 shows a flowchart that illustrates a process COO for conducting Phase 2 activity with the addressable faceplate A00 shown in FIGS. A and B. In the process C00, once a technician has identified a particular tap as a probable source of ingress (a “suspect tap”), e.g., through Phase 1 activity and/or by measuring ingress in the upstream path bandwidth at the tap's upstream port as described with respect to FIG. 20, he or she may replace the suspect tap's conventional faceplate with an addressable faceplate, disconnect the subscriber service drop cables from the conventional faceplate, and connect the subscriber service drop cables to the addressable faceplate (step C02). The technician may also connect an analyzer (e.g., a spectrum analyzer or sweep meter) to the addressable faceplate's monitor output (e.g., monitor output A40 in FIG. 25) and control electronics B30 to the addressable faceplate's input/output interface (e.g., USB port A30 in FIGS. A and B).

Once the addressable faceplate is properly installed and the subscriber service drop cables, analyzer, and control electronics are properly connected to the addressable faceplate, the technician may broadcast a test signal (e.g., a 27 MHz tone at a power of 2 Watts or less) from a point within about two meters of the tap. While broadcasting this test signal, the technician may actuate the switches in the addressable faceplate to connect the subscriber service drop cables to the tap ports and monitor the upstream path bandwidth with the analyzer coupled to the monitor output for ingress (step C04), e.g., as described above with respect to FIGS. 20 and 21A-21D. If the analyzer measurement indicates that no appreciable ingress is present in the upstream path bandwidth (step C06), he or she may mark the tap as free of ingress on an electronic record and/or with a tag attached to the tap itself and proceed to the next tap or cable communication system component designated for Phase 2 activity or end Phase 2 if the designated cable communication system components have been tested for ingress (steps C22, C24, and C26).

If, on the other hand, the analyzer measurement indicated that appreciable ingress is present in the upstream path bandwidth at the suspect tap (step C06), then the technician may actuate the switches in the addressable faceplate to connect a first tap port in the tap to a corresponding first subscriber service drop cable and to connect the other tap ports to the respective 75Ω terminators internal to the addressable faceplate (step C08). Once the switches have been actuated, the technician may measure ingress in the upstream path bandwidth at the monitor output while broadcasting the test signal (step C10) as above. If the measurement indicates the presence of appreciable ingress (step C12), then the technician may mitigate the ingress (step C14) as described above, including but not limited to tightening any loose connections associated with the connected subscriber service drop cable, replacing or repairing the connected subscriber service drop cable, disconnecting the connected subscriber service drop cable, and installing a filter between the connected subscriber service drop cable and the tap. After completing the measurement and any mitigation, the technician may proceed to determine whether or not any other subscriber service drop cables associated with the tap (step C16) are admitting appreciable amounts of ingress by appropriately actuating the switches in the addressable faceplate (step C18) to connect the other subscriber service drop cables in turn, measure ingress in the upstream path bandwidth (step C10), and taking any appropriate mitigation measures (step C14).

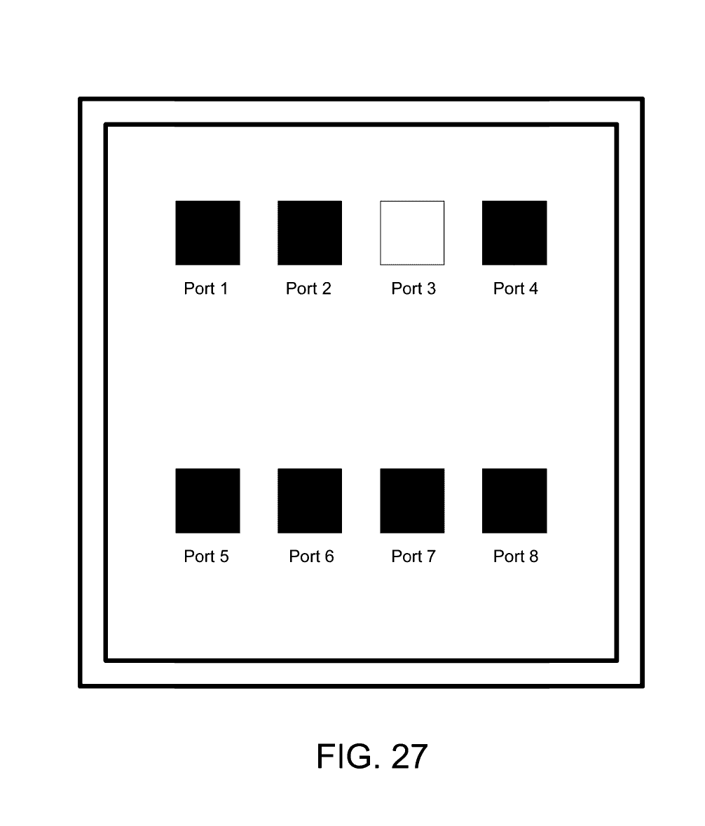

Depending on the embodiment, the process COO illustrated in FIG. 26 can be carried out with varying levels of involvement by the technician. For example, software or firmware running on the technician's control electronics, which are coupled to the addressable faceplate, may automatically cause a transmitter to broadcast the test signal while automatically actuating the switches in a predetermined sequence and detecting ingress in the upstream path bandwidth. The control electronics may include a display, touchscreen, and/or other user interface that provides a visual or audio indication of the absence and/or presence of ingress associated with each subscriber service drop cable. In one example, the display may appear as in FIG. 27, which shows a colored indicator for each port, with different colors representing different degrees of ingress (e.g., green may indicate little to no ingress, yellow may indicate marginal ingress, and red may indicate significant ingress). If the control electronics detect ingress associated with a particular subscriber service drop cable, the user interface may guide the technician through a predetermined series of mitigation steps (e.g., check connections, install filter, and so on). The control electronics may also store representations of the ingress measurements and mitigation steps, if any, in a local memory for subsequent analysis and/or transmission to other personnel.

In other embodiments, an addressable faceplate may be controlled remotely, e.g., via a remote control signal an appropriately modulated RF carrier frequency. Such a remote control signal may be transmitted wirelessly or via the hardline cable plant itself, in which case the remote control signal is at an RF carrier frequency that propagates without significant loss by the hardline cable plant. In certain cases, the remote control signal may be used to provide electronically actuated disconnection, termination, and reconnection of the tap ports for Phase 2 activity and/or for connecting and disconnecting subscriber premises to the cable communication system without a site visit by a technician.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, an intelligent network (IN) or the Internet. Such networks may be based on any suitable technology and may operate according to any suitable protocol and may include wireless networks, wired networks or fiber optic networks.

Any computer discussed herein may comprise a memory, one or more processing units (also referred to herein simply as “processors”), one or more communication interfaces, one or more display units, and one or more user input devices (user interfaces). The memory may comprise any computer-readable media, and may store computer instructions (also referred to herein as “processor-executable instructions”) for implementing the various functionalities described herein. The processing unit(s) may be used to execute the instructions. The communication interface(s) may be coupled to a wired or wireless network, bus, or other communication means and may therefore allow the computer to transmit communications to and/or receive communications from other devices. The display unit(s) may be provided, for example, to allow a user to view various information in connection with execution of the instructions. The user input device(s) may be provided, for example, to allow the user to make manual adjustments, make selections, enter data or various other information, and/or interact in any of a variety of manners with the processor during execution of the instructions.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Various embodiments described herein are to be understood in both open and closed terms. In particular, additional features that are not expressly recited for an embodiment may fall within the scope of a corresponding claim, or can be expressly disclaimed (e.g., excluded by negative claim language), depending on the specific language recited in a given claim.

Unless otherwise stated, any first range explicitly specified also may include or refer to one or more smaller inclusive second ranges, each second range having a variety of possible endpoints that fall within the first range. For example, if a first range of 3 dB<X<10 dB is specified, this also specifies, at least by inference, 4 dB<X<9 dB, 4.2 dB<X<8.7 dB, and the like.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method for identifying a presence or an absence of ingress in a cable communication system, the cable communication system comprising a headend coupled to a first node, the first node comprising a radio-frequency (RF) hardline cable plant including a hardline coaxial cable coupled to a first tap via an upstream port of the first tap, the first tap also coupled to a plurality of collocated subscriber service drop cables, the plurality of collocated subscriber service drop cables conveying at least first upstream information from at least one first subscriber premises of the first node to the headend over an upstream path bandwidth, the method comprising:
A) disconnecting the hardline coaxial cable of the RF hardline cable plant from the upstream port of the first tap;
B) connecting a measurement device to the upstream port of the first tap;
C) broadcasting a test signal within about two meters of the first tap, the test signal having at least one spectral component in the upstream path bandwidth;
D) measuring, with the measurement device connected to the upstream port of the first tap in B), a spectrum of at least a portion of the upstream path bandwidth, the portion of the upstream path bandwidth comprising a frequency of the at least one spectral component of the test signal broadcasted in C); and
E) identifying the presence or the absence of ingress associated with the first tap based at least in part on the spectrum measured in D).

2. The method of claim 1, wherein the first tap and the plurality of collocated subscriber service drop cables are disposed at a site of a multi-occupant structure.

3. The method of claim 2, wherein the first tap is disposed within a lockbox located at the site of the multi-occupant structure.

4. The method of claim 2, wherein the multi-occupant structure comprises at least one of an apartment building, a condominium complex, an office building, a shopping mall, an academic complex, a dormitory, a government facility, a military base, an airport, and a mixed-use facility.

5. The method of claim 2, wherein:
the multi-occupant structure comprises a first story and second story, and
the first tap provides upstream communication service to subscribers on the first story and, via at least one second tap, to subscribers on the second story.

6. The method of claim 2, wherein the first tap is connected to a second tap via a portion of the RF hardline cable plant disposed in at least one horizontal conduit.

7. The method of claim 2, wherein at least one collocated subscriber service drop cable in the plurality of collocated subscriber service drop cables comprises at least one flexible coaxial cable connecting the first tap to a corresponding subscriber premises in the multi-occupant structure.

8. The method of claim 1, wherein the upstream path bandwidth comprises frequencies in a range from about 5 MHz to about 42 MHz.

9. The method of claim 1, wherein the at least one spectral component is at a frequency of about 27 MHz.

10. The method of claim 1, wherein C) further comprises:
broadcasting the test signal at a power of about 100 mW to about 4 W.

11. The method of claim 1, wherein C) further comprises:
broadcasting the test signal at a power of about 1 W to about 2 W and at a frequency of about 27 MHz.

12. The method of claim 1, wherein D) further comprises detecting at least one of:
a decrease in power spectral density and/or energy spectral density over the at least a portion of the upstream path bandwidth;
a decrease in amplitude of at least one peak in the at least a portion of the upstream path bandwidth; and
a variation in the spectrum of the at least a portion of the upstream path bandwidth.

13. The method of claim 1, wherein E) comprises identifying the presence of ingress caused by at least one fault comprising at least one of:
a loose connection between the first tap and at least one collocated subscriber service drop cable in the plurality of collocated subscriber service drop cables,
a broken coaxial connector, and
a broken coaxial cable.

14. The method of claim 13, wherein E) further comprises identifying the at least one fault based at least in part on a visual inspection and/or a tactile inspection of the first tap and the at least one collocated subscriber service drop.

15. The method of claim 13, further comprising:
F) electronically receiving first information indicative of the presence or absence of ingress detected in E);
G) storing a first electronic record of the first information received in F); and
H) displaying a first representation of a location of the at least one fault based at least in part on the first electronic record stored in G).

16. The method of claim 15, wherein the first information includes a representation of the spectrum measured in D).

17. The method of claim 15, wherein H) further comprises:
displaying a representation of the spectrum measured in D).

18. The method of claim 1, further comprising, in response to an identification of the presence of ingress associated with the first tap in E):
I) disconnecting a first subscriber service drop cable in the plurality of subscriber service drop cables from the first tap;
J) measuring, with the measurement device connected to the upstream port of the first tap, the spectrum of the at least a portion of the upstream path bandwidth broadcast; and
K) identifying a presence or an absence of ingress associated with the first collocated subscriber service drop cable based at least in part on the spectrum measured in J).

19. The method of claim 18, wherein I) comprises:
disconnecting a male F connector at one end of the first collocated subscriber service drop from a female F connector of the first tap.

20. The method of claim 18, wherein I) comprises:
actuating at least one switch to disconnect the first collocated subscriber service drop cable from the at least one tap.

21. The method of claim 20, wherein I) further comprises:
actuating the at least one switch using a controller operably coupled to the at least one switch.

22. The method of claim 20, wherein I) comprises, before actuating the at least one switch:
connecting the at least one switch to the first tap; and
disconnecting the at least one switch from the first tap after actuating the at least one switch.

23. The method of claim 20, further comprising:
indicating, with an indicator operably coupled to the at least one switch, a presence or absence of ingress associated with the first collocated subscriber service drop cable.

24. The method of claim 18, further comprising, in response to an identification of the presence of ingress associated with the first collocated subscriber service drop cable in K):
L) preventing at least some of the ingress associated with the first collocated subscriber service drop cable from reaching the headend.

25. The method of claim 24, wherein L) comprises at least one of:
L1) leaving the first collocated subscriber service drop cable disconnected from the first tap;
L2) tightening a connection between the first tap and the first collocated subscriber service drop cable;
L3) attenuating at least one spectral component propagating to the headend via the first collocated subscriber service drop in the upstream path bandwidth;
L4) filtering at least one spectral component propagating to the headend via the first collocated subscriber service drop in the upstream path bandwidth;
L5) repairing a broken coaxial connector, a broken tap, and/or a broken coaxial cable associated with the first tap and/or the first collocated subscriber service drop cable; and
L6) replacing the broken coaxial connector, the broken tap, and/or the broken coaxial cable associated with the first tap and/or the first collocated subscriber service drop cable.

26. The method of claim 25, wherein L1) further comprises:
identifying at least one subscriber premises affected by disconnection of the first collocated subscriber service drop cable from the first tap based at least in part on information from at least one subscriber.

27. The method of claim 25, wherein L1) further comprises:
securing the first port of the first tap to prevent unauthorized access to the cable communication system.

28. The method of claim 25, wherein L1) further comprises:
cutting the first collocated subscriber service drop cable so as to prevent reconnection of the first collocated subscriber service drop cable to the first tap.

29. The method of claim 25, wherein L1) further comprises:
terminating, with a 75Ω terminator, the first port of the first tap;

30. The method of claim 24, wherein H) further comprises repairing, replacing, and/or adjusting at least one fault associated with the first collocated subscriber service drop cable such that a highest value for an average noise power associated with the ingress identified in D) in at least a first portion of the upstream path bandwidth below approximately 20 MHz, as measured over at least a 24-hour period at the headend, is less than 10 decibels (dB) above a noise floor associated with the first portion of the upstream path bandwidth below approximately 20 MHz as measured over at least the 24-hour period at the headend.

31. The method of claim 24, wherein:
the upstream path bandwidth includes at least one first modulated carrier wave having a first carrier frequency of less than or equal to 19.6 MHz, the at least one first modulated carrier wave being modulated with at least some of the first upstream information and defining a first upstream physical communication channel in the upstream path bandwidth, the first upstream physical communication channel having a first upstream average channel power; and
L) further comprises repairing, replacing, and/or adjusting at least one fault associated with the first collocated subscriber service drop cable such that a highest value of an average noise power associated with the ingress identified in E) in at least a portion of the upstream path bandwidth below approximately 20 MHz, as measured over at least a 24-hour period at the headend, is at least 22 decibels (dB) below the first upstream average channel power.

32. The method of claim 31, wherein in L), the highest value for the average noise power in the upstream path bandwidth below approximately 20 MHz, as measured over at least the 24-hour period at the headend, is at least 38 decibels (dB) below the first upstream average channel power.

33. The method of claim 24, wherein:
the upstream path bandwidth includes at least one first modulated carrier wave having a first carrier frequency of approximately 19.6 MHz or lower, the at least one first modulated carrier wave being modulated with at least some of the first upstream information and defining a first upstream physical communication channel in the upstream path bandwidth, the first physical communication channel having a first upstream average channel power; and
L) further comprises repairing, replacing, and/or adjusting at least one fault associated with the first collocated subscriber service drop cable so as to achieve a carrier-to-noise-plus-interference ratio (CNIR) of the first upstream physical communication channel of at least 25 dB.

34. The method of claim 33, wherein in L), the CNIR of the first upstream physical communication channel is at least 37 dB.

35. The method of claim 24, wherein:
the upstream path bandwidth includes at least one first modulated carrier wave having a first carrier frequency of approximately 19.6 MHz or lower, the at least one first modulated carrier wave being modulated with at least some of the first upstream information and defining a first upstream physical communication channel in the upstream path bandwidth; and
L) further comprises repairing, replacing, and/or adjusting at least one fault associated with the first collocated subscriber service drop cable so as to achieve an unequalized modulation error ratio (MER) of the first upstream physical communication channel of at least 20 decibels (dB).

36. The method of claim 35, wherein in D), the unequalized MER of the first upstream physical communication channel is at least 30 dB.

37. The method of claim 18, further comprising:
P) disconnecting a second subscriber service drop cable in the plurality of subscriber service drop cables from the first tap;
Q) measuring, with the measurement device connected to the input port of the first tap, the spectrum of the at least a portion of the upstream path bandwidth broadcast; and
R) identifying a presence or an absence of ingress associated with the first collocated subscriber service drop cable based at least in part on the spectrum measured in Q).

38. The method of claim 1, further comprising, before A):
making a Phase 1 heat map;
identifying the first tap based in part from the Phase 1 heat map.

39. A method for identifying ingress in a cable communication system, the cable communication system comprising a headend coupled to a first node, the first node comprising a radio-frequency (RF) hardline cable plant coupled an input port of a first tap and a plurality of collocated subscriber service drop cables coupled to respective output ports in a plurality of output ports of the first tap, the plurality of collocated subscriber service drop cables conveying at least first upstream information to the headend over an upstream path bandwidth, the method comprising:
A) disconnecting the input port of the first tap from the RF hardline cable plant;
B) connecting a measurement device to the input port of the first tap disconnected in A);
C) broadcasting a test signal within about two meters of the first tap, the test signal having at least one spectral component in the upstream path bandwidth;
D) measuring, with the measurement device connected to the input port of the first tap in B), a spectrum of at least a portion of the upstream path bandwidth while broadcasting the test signal in C), the at least a portion of the upstream path bandwidth comprising a frequency of the at least one spectral component of the test signal; and
E) in response to the spectrum measured in D), disconnecting at least one collocated subscriber service drop cable in the plurality of subscriber service drop cables from at least one corresponding output port in the plurality of output ports of the first tap;
F) in response to disconnecting the at least one collocated subscriber service drop cable in E), measuring a change in the spectrum of at least a portion of the upstream path bandwidth while broadcasting the test signal in C);
G) identifying ingress associated with the at least one collocated subscriber service drop cable based at least in part on the change in the spectrum measured in F);
H) in response to the ingress identified in G, undertaking at least one mitigation measure to reduce the ingress associated with the at least one collocated subscriber service drop cable, the at least one mitigation measure comprising at least one of:
H1) leaving the first collocated subscriber service drop cable disconnected from the first tap;
H2) tightening a connection between the first tap and the first collocated subscriber service drop cable;
H3) attenuating at least one spectral component propagating to the headend via the first collocated subscriber service drop in the upstream path bandwidth;
H4) filtering at least one spectral component propagating to the headend via the first collocated subscriber service drop in the upstream path bandwidth;
H5) repairing a broken coaxial connector, a broken tap, and/or a broken coaxial cable associated with the first tap and/or the first collocated subscriber service drop cable; and
H6) replacing the broken coaxial connector, the broken tap, and/or the broken coaxial cable associated with the first tap and/or the first collocated subscriber service drop cable; and
I) recording an electronic representation of the at least one mitigation measure undertaken in H).

40. A method for a presence or absence of ingress in a cable communication system, the cable communication system comprising a headend coupled to a first neighborhood node, the first neighborhood node comprising a radio-frequency (RF) hardline cable plant coupled to a plurality of collocated subscriber service drop cables via a first tap, the plurality of collocated subscriber service drop cables conveying at least first upstream information from at least one first subscriber premises of the first neighborhood node to the headend over an upstream path bandwidth, the method comprising:
A) broadcasting radiation, within about two meters of the lockbox, having at least one spectral component in the upstream path bandwidth;
B) measuring energy, at the headend, in at least a portion of the upstream path bandwidth; and
C) identifying the presence or absence of ingress associated with the first tap based at least in part on the energy measured in B).

41. The method of claim 40, further comprising, in response to an identification of the presence of ingress in C):
D) disconnecting an upstream end of a first subscriber service drop in the plurality of subscriber service drop cables from the first tap;
E) broadcasting radiation, within about 2 meters of the upstream end of the first collocated subscriber service drop, having at least one spectral component in the upstream path bandwidth;
F) measuring energy, at a frequency of the at least one spectral component in the upstream path bandwidth, at the upstream end of the first collocated subscriber service drop; and
G) identifying a presence or absence of ingress associated with the first collocated subscriber service drop based at least in part on the energy measured in F).

42. A method for identifying a presence or an absence of ingress in a cable communication system, the cable communication system comprising a headend coupled to a first node, the first node comprising a radio-frequency (RF) hardline cable plant including a hardline coaxial cable and a first tap, the first tap comprising a housing including an upstream port to couple to the hardline coaxial cable, the first tap also including a face plate having a plurality of connectors respectively coupled to a plurality of collocated subscriber service drop cables, the plurality of collocated subscriber service drop cables conveying at least first upstream information from a plurality of subscriber premises of the first node to the headend over an upstream path bandwidth, the method comprising:
A) broadcasting a test signal within about two meters of the faceplate of the first tap, the test signal having at least one spectral component in the upstream path bandwidth;
B) measuring, with an analyzer, a spectrum profile in at least a portion of the upstream path bandwidth representative of the power spectral density present on the plurality of collocated subscriber service drop cables coupled to the faceplate of the first tap, the portion of the upstream path bandwidth comprising a frequency of the at least one spectral component of the test signal broadcasted in A); and
C) identifying the presence or the absence of ingress associated with the first tap based at least in part on the spectrum measured in B).

43. A method for facilitating detection of ingress in a first node of a cable communication system, the cable communication system comprising:
a headend or hub comprising:
a headend optical/radio frequency (RF) converter; and
a cable modem system coupled to the headend optical/RF converter; and
the first node having an infrastructure comprising:
a first fiber optic cable coupled to the headend optical/RF converter;
a first node optical/RF converter coupled to the first fiber optic cable;
a first RF hardline coaxial cable plant, coupled to the first node optical/RF converter and traversing the first node, to convey to the headend or hub at least first upstream information from a plurality of first subscriber premises over an upstream path bandwidth including a range of frequencies from approximately 5 MHz to at least approximately 42 MHz, the first RF hardline coaxial cable plant including at least one first tap; and
a plurality of collocated first subscriber service drops, coupled to the first tap and to at least some of the plurality of first subscriber premises, to provide the first upstream information from the at least some of the plurality of first subscriber premises to the first RF hardline coaxial cable plant,
the method comprising:
A) directing a mobile broadcast apparatus including a transmitter along a first path proximate to the first RF hardline coaxial cable plant so as to traverse at least a portion of the first subscriber neighborhood that includes the at least one first tap;
B) during A), broadcasting from the transmitter a test signal at a plurality of locations distributed along at least a substantial portion of the first path, the test signal having at least one test signal frequency falling within the upstream path bandwidth;
C) during A), electronically recording first geographic information corresponding to respective positions of the mobile broadcast apparatus along at least the substantial portion of the first path so as to generate a first record of the first geographic information;
D) during A) and throughout traversing at least the substantial portion of the first path, recording, via an analyzer, a plurality of signal amplitudes at the test signal frequency so as to generate a second record, the plurality of signal amplitudes representing a strength of a received upstream test signal as a function of time, based on B) and test signal ingress of the test signal into at least one fault in at least one of 1) the first RF hardline coaxial cable plant and 2) the plurality of collocated first subscriber service drops; and
E) based on the first record generated in C) and the second record generated in D), electronically generating a first node ingress map comprising:
a first graphical representation of the first path over which the mobile broadcast apparatus is directed; and
a second graphical representation, overlaid on the first graphical representation, of the plurality of signal amplitudes, at least along the substantial portion of the first path, so as to illustrate the test signal ingress of the test signal into the at least one of 1) the first RF hardline coaxial cable plant and 2) the plurality of collocated first subscriber service drops.
